(19) United States
(12) Patent Application Publication
(10) Pub. No.: US 2005/0193425 A1
(43) Pub. Date: Sep. 1, 2005

(54) Delivery and presentation of content-relevant information associated with frames of audio-visual programs

(76) Inventors: Sanghoon Sull, Seoul (KR); Jung Rim Kim, Seoul (KR); Seong Soo Chun, Songnam City (KR); Ja-Cheon Yoon, Seoul (KR)

Correspondence Address: D.A. STAUFFER PATENT SERVICES LLC, 1006 MONTFORD ROAD, CLEVLAND HTS., OH, 44121-2016, US

(21) Appl. No.: 11/069,750

(22) Filed: Mar. 1, 2005

Related U.S. Application Data
(63) Continuation-in-part of application No. 10/361,794, filed on Feb. 10, 2003.
(63) Continuation-in-part of application No. 10/365,576, filed on Feb. 12, 2003.
(63) Continuation-in-part of application No. 10/369,333, filed on Feb. 19, 2003.
(63) Continuation-in-part of application No. 10/368,304, filed on Feb. 18, 2003.
(63) Continuation-in-part of application No. 09/911,293, filed on Jul. 23, 2001.
(60) Provisional application No. 60/549,624, filed on Mar. 3, 2004.
(60) Provisional application No. 60/549,605, filed on Mar. 2, 2004.
(60) Provisional application No. 60/610,074, filed on Sep. 15, 2004.
(60) Provisional application No. 60/359,564, filed on Feb. 25, 2002.
(60) Provisional application No. 60/359,566, filed on Feb. 25, 2002.
(60) Provisional application No. 60/434,173, filed on Dec. 17, 2002.
(60) Provisional application No. 60/359,567, filed on Feb. 25, 2002.
(60) Provisional application No. 60/221,394, filed on Jul. 24, 2000.
(60) Provisional application No. 60/221,843, filed on Jul. 28, 2000.
(60) Provisional application No. 60/222,373, filed on Jul. 31, 2000.
(60) Provisional application No. 60/271,908, filed on Feb. 27, 2001.
(60) Provisional application No. 60/291,728, filed on May 17, 2001.

(51) Int. Cl. H04N 7/173; G06F 13/00; H04N 5/445; G06F 3/00; H04N 7/10; G06F 17/00; G06F 15/00; H04N 7/16; H04N 7/025

(52) U.S. Cl. 725/135; 725/61; 715/500.1; 715/501.1; 725/105

(57) ABSTRACT

A method for delivery and presentation of content-relevant information associated with frames in an AV program enables TV viewers to retrieve information on the contents (for example, objects, items, concepts and the like) associated with a frame or a set of frames (video segments) when they watch TV or video programs. The information relevant to frame(s) is delivered to a STB or DVR by third-party service providers through back channels such as the Internet if the information of how to accurately access the frames pointed by STB users are delivered to the service providers, and the content-relevant information may be presented in the form of a GUI for the TV viewer.

### CROSS-REFERENCES TO RELATED APPLICATIONS

All of the below-referenced applications for which priority claims are being made, or for which this application is a continuation-in-part of, are incorporated in their entirety by reference herein.

This application claims priority of U.S. Provisional Application No. 60/549,624 filed Mar. 3, 2004.

This application claims priority of U.S. Provisional Application No. 60/549,605 filed Mar. 3, 2004.

This application claims priority of U.S. Provisional Application No. 60/610,074 filed Sep. 15, 2004.

This is a continuation-in-part of U.S. patent application Ser. No. 10/361,794 filed Feb. 10, 2003 (published as U.S. 2004/0126021 on Jul. 1, 2004), which claims priority of U.S. Provisional Application No. U.S. Ser. No. 60/359,564 filed Feb. 25, 2002.

This is a continuation-in-part of U.S. patent application Ser. No. 10/365,576 filed Feb. 12, 2003 (Published as U.S. 2004/0128317 on Jul. 1, 2004), which claims priority of U.S. Provisional Application No. 60/359,566 filed Feb. 25, 2002 and of U.S. Provisional Application No. 60/434,173 filed Dec. 17, 2002.

This is a continuation-in-part of U.S. patent application Ser. No. 10/369,333 filed Feb. 19, 2003 (Published as U.S. 2003/0177503 on Sep. 18, 2003).

This is a continuation-in-part of U.S. patent application Ser. No. 10/368,304 filed Feb. 18, 2003 (Published as U.S. 2004/0125124 on Jul. 1, 2004), which claims priority of U.S. Provisional Application No. 60/359,567 filed Feb. 25, 2002.

This is a continuation-in-part of U.S. patent application Ser. No. 09/911,293 filed Jul. 23, 2001 (published as U.S. 2002/0069218 A1 on Jun. 6, 2002), which claims priority of:
U.S. Provisional Application No. 60/221,394 filed Jul. 24, 2000;
U.S. Provisional Application No. 60/221,843 filed Jul. 28, 2000;
U.S. Provisional Application No. 60/222,373 filed Jul. 31, 2000;
U.S. Provisional Application No. 60/271,908 filed Feb. 27, 2001; and
U.S. Provisional Application No. 60/291,728 filed May 17, 2001.

This is related to commonly-owned, copending U.S. patent application Ser. No. 11/______ filed on even date herewith by Sanghoon SULL, Hyeokman KIM, Seong Soo CHUN, Jung Rim KIM, Ja-Cheon YOON and entitled GENERATING, TRANSPORTING, PROCESSING, STORING AND PRESENTING SEGMENTATION INFORMATION FOR AUDIO-VISUAL PROGRAMS.

This is related to commonly-owned, copending U.S. patent application Ser. No. 11/______ filed on even date herewith by Sanghoon SULL, Seong Soo CHUN, M. D. ROSTOKER, Hyeokman KIM and entitled PROCESSING AND PRESENTATION OF INFOMERCIALS FOR AUDIO-VISUAL PROGRAMS.

### TECHNICAL FIELD

This disclosure relates to the delivery, retrieval and presentation of content relevant information associated with frames in an AV program, and, more particularly to systems and techniques for delivering and presenting information relevant to the content of frames selected by viewers or information providers to enable AV program viewers to retrieve information on the contents associated with a frame.

### BACKGROUND

Advances in technology continue to create a wide variety of contents and services in audio, visual, and/or audiovisual (hereinafter referred generally and collectively as “audio-visual” or audiovisual”) programs/contents including related data(s) (hereinafter referred as a “program” or “content”) delivered to users through various media including broadcast terrestrial, cable and satellite as well as Internet.

Digital vs. Analog Television

In December 1996 the Federal Communications Commission (FCC) approved the U.S. standard for a new era of digital television (DTV) to replace the analog television (TV) system currently used by consumers. The need for a DTV system arose due to the demands for a higher picture quality and enhanced services required by television viewers. DTV has been widely adopted in various countries, such as Korea, Japan and throughout Europe.

The DTV system has several advantages over conventional analog TV system to fulfill the needs of TV viewers. The standard definition television (SDTV) or high definition television (HDTV) system allows for much clearer picture viewing, compared to a conventional analog TV system. HDTV viewers may receive high-quality pictures at a resolution of 1920×1080 pixels displayed in a wide screen format with a 16 by 9 aspect (width to height) ratio (as found in movie theatres) compared to analog's traditional analog 4 by 3 aspect ratio. Although the conventional TV aspect ratio is 4 by 3, wide screen programs can still be viewed on conventional TV screens in letter box format leaving a blank screen area at the top and bottom of the screen, or more commonly, by cropping part of each scene, usually at both sides of the image to show only the center 4 by 3 area. Furthermore, the DTV system allows multicasting of multiple TV programs and may also contain ancillary data, such as subtitles, optional, varied or different audio options (such as optional languages), broader formats (such as letterbox) and additional scenes. For example, audiences may have the benefits of better associated audio, such as current 5.1-channel compact disc (CD)-quality surround sound for viewers to enjoy a more complete “home” theater experience.

The U.S. FCC has allocated 6 MHz (megaHertz) bandwidth for each terrestrial digital broadcasting channel which is the same bandwidth as used for an analog National Television System Committee (NTSC) channel. By using video compression, such as MPEG-2, one or more high picture quality programs can be transmitted within the same bandwidth. A DTV broadcaster thus may choose between various standards (for example, HDTV or SDTV) for transmission of programs. For example, Advanced Television Systems Committee (ATSC) has 18 different formats at various resolutions, aspect ratios, frame rates examples and descriptions of which may be found at “ATSC Standard A/53C with Amendment No. 1: ATSC Digital Television Standard”, Rev. C, 21 May 2004 (see World Wide Web at atsc.org). Pictures in digital television system is scanned in either progressive or interlaced modes. In progressive mode, a frame picture is scanned in a raster-scan order, whereas, in interlaced mode, a frame picture consists of two temporally-alternating field pictures each of which is scanned in a raster-scan order. A more detailed explanation on interlaced and progressive modes may be found at “Digital Video: An Introduction to MPEG-2 (Digital Multimedia Standards Series)” by Barry G., Atul Puri, Arun N. Netravali. Although SDTV will not match HDTV in quality, it will offer a higher quality picture than current or recent analog TV.

Digital broadcasting also offers entirely new options and forms of programming. Broadcasters will be able to provide additional video, image and/or audio (along with other possible data transmission) to enhance the viewing experience of TV viewers. For example, one or more electronic program guides (EPGs) which may be transmitted with a video (usually a combined video plus audio with possible additional data) signal can guide users to channels of interest. The most common digital broadcasts and replays (for example, by video compact disc (VCD) or digital video disc (DVD)) involve compression of the video image for storage and/or broadcast with decompression for program presentation. Among the most common compression standards (which may also be used for associated data, such as audio) are JPEG and various MPEG standards.

JPEG

1. Introduction

JPEG (Joint Photographic Experts Group) is a standard for still image compression. The JPEG committee has developed standards for the lossy, lossless, and nearly lossless compression of still images, and the compression of continuous-tone, still-frame, monochrome, and color images. The JPEG standard provides three main compression techniques from which applications can select elements satisfying their requirements. The three main compression techniques are (i) Baseline system, (ii) Extended system and (iii) Lossless mode technique. The Baseline system is a simple and efficient Discrete Cosine Transform (DCT)-based algorithm with Huffman coding restricted to 8 bits/pixel inputs in sequential mode. The Extended system enhances the baseline system to satisfy broader application with 12 bits/pixel inputs in hierarchical and progressive mode and the Lossless mode is based on predictive coding, DPCM (Differential Pulse Coded Modulation), independent of DCT with either Huffman or arithmetic coding.

2. JPEG Compression

An example of JPEG encoder block diagram may be found at Compressed Image File Formats: JPEG, PNG, GIF, XBM, BMP (ACM Press) by John Miano, more complete technical description may be found ISO/IEC International Standard 10918-1 (see World Wide Web at jpeg.org/jpeg/). An original picture, such as a video frame image is partitioned into 8×8 pixel blocks, each of which is independently transformed using DCT. DCT is a transform function from spatial domain to frequency domain. The DCT transform is used in various lossy compression techniques such as MPEG-1, MPEG-2, MPEG-4 and JPEG. The DCT transform is used to analyze the frequency component in an image and discard frequencies which human eyes do not usually perceive. A more complete explanation of DCT may be found at “Discrete-Time Signal Processing” (Prentice Hall, 2^{nd} edition, February 1999) by Alan V. Oppenheim, Ronald W. Schafer, John R. Buck. All the transform coefficients are uniformly quantized with a user-defined quantization table (also called a q-table or normalization matrix). The quality and compression ratio of an encoded image can be varied by changing elements in the quantization table. Commonly, the DC coefficient in the top-left of a 2-D DCT array is proportional to the average brightness of the spatial block and is variable-length coded from the difference between the quantized DC coefficient of the current block and that of the previous block. The AC coefficients are rearranged to a 1-D vector through zigzag scan and encoded with run-length encoding. Finally, the compressed image is entropy coded, such as by using Huffman coding. The Huffman coding is a variable-length coding based on the frequency of a character. The most frequent characters are coded with fewer bits and rare characters are coded with many bits. A more detailed explanation of Huffman coding may be found at “Introduction to Data Compression” (Morgan Kaufmann, Second Edition, February, 2000) by Khalid Sayood.

A JPEG decoder operates in reverse order. Thus, after the compressed data is entropy decoded and the 2-dimensional quantized DCT coefficients are obtained, each coefficient is de-quantized using the quantization table. JPEG compression is commonly found in current digital still camera systems and many Karaoke “sing-along” systems.

Wavelet

Wavelets are transform functions that divide data into various frequency components. They are useful in many different fields, including multi-resolution analysis in computer vision, sub-band coding techniques in audio and video compression and wavelet series in applied mathematics. They are applied to both continuous and discrete signals. Wavelet compression is an alternative or adjunct to DCT type transformation compression and is considered or adopted for various MPEG standards, such as MPEG-4. A more complete description may be found at “Wavelet transforms: Introduction to Theory and Application” by Raghuveer M. Rao.

MPEG

The MPEG (Moving Pictures Experts Group) committee started with the goal of standardizing video and audio for compact discs (CDs). A meeting between the International Standards Organization (ISO) and the International Electrotechnical Commission (IEC) finalized a 1994 standard titled MPEG-2, which is now adopted as a video coding standard for digital television broadcasting. MPEG may be more completely described and discussed on the World Wide Web at mpeg.org along with example standards. MPEG-2 is further described at “Digital Video: An Introduction to MPEG-2 (Digital Multimedia Standards Series)” by Barry G. Haskell, Atul Puri, Arun N. Netravali and the MPEG-4 described at “The MPEG-4 Book” by Touradj Ebrahimi, Fernando Pereira.

MPEG Compression

The goal of MPEG standards compression is to take analog or digital video signals (and possibly related data such as audio signals or text) and convert them to packets of digital data that are more bandwidth efficient. By generating packets of digital data it is possible to generate signals that do not degrade, provide high quality pictures, and to achieve high signal to noise ratios.

MPEG standards are effectively derived from the Joint Pictures Expert Group (JPEG) standard for still images. The MPEG-2 video compression standard achieves high data compression ratios by producing information for a full frame video image only occasionally. These full-frame images, or “intra-coded” frames (pictures) are referred to as “I-frames”. Each I-frame contains a complete description of a single video frame (image or picture) independent of any other frame, and takes advantage of the nature of the human eye and removes redundant information in the high frequency which humans traditionally cannot see. These “I-frame” images act as “anchor frames” (sometimes referred to as “key frames” or “reference frames”) that serve as reference images within an MPEG-2 stream. Between the I-frames, delta-coding, motion compensation, and a variety of interpolative/predictive techniques are used to produce intervening frames. “Inter-coded” B-frames (bidirectionally-coded frames) and P-frames (predictive-coded frames) are examples of such “in-between” frames encoded between the I-frames, storing only information about differences between the intervening frames they represent with respect to the I-frames (reference frames). The MPEG system consists of two major layers namely, the System Layer (timing information to synchronize video and audio) and Compression Layer.

The MPEG standard stream is organized as a hierarchy of layers consisting of Video Sequence layer, Group-Of-Pictures (GOP) layer, Picture layer, Slice layer, Macroblock layer and Block layer.

The Video Sequence layer begins with a sequence header (and optionally other sequence headers), and usually includes one or more groups of pictures and ends with an end-of-sequence-code. The sequence header contains the basic parameters such as the size of the coded pictures, the size of the displayed video pictures if different, -bit rate, frame rate, aspect ratio of a video, the profile and level identification, interlace or progressive sequence identification, private user data, plus other global parameters related to a video.

The GOP layer consists of a header and a series of one or more pictures intended to allow random access, fast search and edition. The GOP header contains a time code used by certain recording devices. It also contains editing flags to indicate whether Bidirectional (B)-pictures following the first Intra (I)-picture of the GOP can be decoded following a random access called a closed GOP. In MPEG, a video picture is generally divided into a series of GOPs.

The Picture layer is the primary coding unit of a video sequence. A picture consists of three rectangular matrices representing luminance (Y) and two chrominance (Cb and Cr or U and V) values. The picture header contains information on the picture coding type of a picture (intra (I), predicted (P), Bidirectional (B) picture), the structure of a picture (frame, field picture), the type of the zigzag scan and other information related for the decoding of a picture. For progressive mode video, a picture is identical to a frame and can be used interchangeably, while for interlaced mode video, a picture refers to the top field or the bottom field of the frame.

A slice is composed of a string of consecutive macroblocks which is commonly built from a 2 by 2 matrix of blocks and it allows error resilience in case of data corruption. Due to the existence of a slice in an error resilient environment, a partial picture can be constructed instead of the whole picture being corrupted. If the bitstream contains an error, the decoder can skip to the start of the next slice. Having more slices in the bitstream allows better error hiding, but it can use space that could otherwise be used to improve picture quality. The slice is composed of macroblocks traditionally running from left to right and top to bottom where all macroblocks in the I-pictures are transmitted. In P and B-pictures, typically some macroblocks of a slice are transmitted and some are not, that is, they are skipped. However, the first and last macroblock of a slice should always be transmitted. Also the slices should not overlap.

A block consists of the data for the quantized DCT coefficients of an 8×8 block in the macroblock. The 8 by 8 blocks of pixels in the spatial domain are transformed to the frequency domain with the aid of DCT and the frequency coefficients are quantized. Quantization is the process of approximating each frequency coefficient as one of a limited number of allowed values. The encoder chooses a quantization matrix that determines how each frequency coefficient in the 8 by 8 block is quantized. Human perception of quantization error is lower for high spatial frequencies (such as color), so high frequencies are typically quantized more coarsely (with fewer allowed values).

The combination of the DCT and quantization results in many of the frequency coefficients being zero, especially those at high spatial frequencies. To take maximum advantage of this, the coefficients are organized in a zigzag order to produce long runs of zeros. The coefficients are then converted to a series of run-amplitude pairs, each pair indicating a number of zero coefficients and the amplitude of a non-zero coefficient. These run-amplitudes are then coded with a variable-length code, which uses shorter codes for commonly occurring pairs and longer codes for less common pairs. This procedure is more completely described in “Digital Video: An Introduction to MPEG-2” (Chapman & Hall, December, 1996) by Barry G. Haskell, Atul Puri, Arun N. Netravali. A more detailed description may also be found at “Generic Coding of Moving Pictures and Associated Audio Information—Part 2: Videos”, ISO/IEC 13818-2 (MPEG-2), 1994 (see World Wide Web at mpeg.org).

Inter-Picture Coding

Inter-picture coding is a coding technique used to construct a picture by using previously encoded pixels from the previous frames. This technique is based on the observation that adjacent pictures in a video are usually very similar. If a picture contains moving objects and if an estimate of their translation in one frame is available, then the temporal prediction can be adapted using pixels in the previous frame that are appropriately spatially displaced. The picture type in MPEG is classified into three types of picture according to the type of inter prediction used. A more detailed description of Inter-picture coding may be found at “Digital Video: An Introduction to MPEG-2” (Chapman & Hall, December, 1996) by Barry G. Haskell, Atul Puri, Arun N. Netravali.

Picture Types

The MPEG standards (MPEG-1, MPEG-2, MPEG-4) specifically define three types of pictures (frames) Intra (I), Predicted (P), and Bidirectional (B).

Intra (I) pictures are pictures that are traditionally coded separately only in the spatial domain by themselves. Since intra pictures do not reference any other pictures for encoding and the picture can be decoded regardless of the reception of other pictures, they are used as an access point into the compressed video. The intra pictures are usually compressed in the spatial domain and are thus large in size compared to other types of pictures.

Predicted (P) pictures are pictures that are coded with respect to the immediately previous I or P-frame. This technique is called forward prediction. In a P-picture, each macroblock can have one motion vector indicating the pixels used for reference in the previous I or P-frames. Since the a P-picture can be used as a reference picture for B-frames and future P-frames, it can propagate coding errors. Therefore the number of P-pictures in a GOP is often restricted to allow for a clearer video.

Bidirectional (B) pictures are pictures that are coded by using immediately previous I- and/or P-pictures as well as immediately next I- and/or P-pictures. This technique is called bidirectional prediction. In a B-picture, each macroblock can have one motion vector indicating the pixels used for reference in the previous I- or P-frames and another motion vector indicating the pixels used for reference in the next I- or P-frames. Since each macroblock in a B-picture can have up to two motion vectors, where the macroblock is obtained by averaging the two macroblocks referenced by the motion vectors, this results in the reduction of noise. In terms of compression efficiency, the B-pictures are the most efficient, P-pictures are somewhat worse, and the I-pictures are the least efficient. The B-pictures do not propagate errors because they are not traditionally used as a reference picture for inter-prediction.

Video Stream Composition

The number of I-frames in a MPEG stream (MPEG-1, MPEG-2 and MPEG-4) may be varied depending on the applications needed for random access and the location of scene cuts in the video sequence. In applications where random access is important, I-frames are used often, such as two times a second. The number of B-frames in between any pair of reference (I or P) frames may also be varied depending on factors such as the amount of memory in the encoder and the characteristics of the material being encoded. A typical display order of pictures may be found at “Digital Video: An Introduction to MPEG-2 (Digital Multimedia Standards Series)” by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org). The sequence of pictures is re-ordered in the encoder such that the reference pictures needed to reconstruct B-frames are sent before the associated B-frames. A typical encoded order of pictures may be found at “Digital Video: An Introduction to MPEG-2 (Digital Multimedia Standards Series)” by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org).

Motion Compensation

In order to achieve a higher compression ration, the temporal redundancy of a video is eliminated by a technique called motion compensation. Motion compensation is utilized in P- and B-pictures at macro block level where each macroblock has a spatial vector between the reference macroblock and the macroblock being coded and the error between the reference and the coded macroblock. The motion compensation for macroblocks in P-picture may only use the macroblocks in the previous reference picture (I-picture or P-picture), while macroblocks in a B-picture may use a combination of both the previous and future pictures as a reference pictures (I-picture or P-picture). A more extensive description of aspects of motion compensation may be found at “Digital Video: An Introduction to MPEG-2 (Digital Multimedia Standards Series)” by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org).

MPEG-2 System Layer

A main function of MPEG-2 systems is to provide a means of combining several types of multimedia information into one stream. Data packets from several elementary streams (ESs) (such as audio, video, textual data, and possibly other data) are interleaved into a single stream. ESs can be sent either at constant-bit rates or at variable-bit rates simply by varying the lengths or frequency of the packets. The ESs consist of compressed data from a single source plus ancillary data needed for synchronization, identification, and characterization of the source information. The ESs themselves are first packetized into either constant-length or variable-length packets to form a Packetized Elementary stream (PES).

MPEG-2 system coding is specified in two forms: the Program Stream (PS) and the Transport Stream (TS). The PS is used in relatively error-free environment such as DVD media, and the TS is used in environments where errors are likely, such as in digital broadcasting. The PS usually carries one program where a program is a combination of various ESs. The PS is made of packs of multiplexed data. Each pack consists of a pack header followed by a variable number of multiplexed PES packets from the various ESs plus other descriptive data. The TSs consists of TS packets, such as of 188 bytes, into which relatively long, variable length PES packets are further packetized. Each TS packet consists of a TS Header followed optionally by ancillary data (called an adaptation field), followed typically by one or more PES packets. The TS header usually consists of a sync (synchronization) byte, flags and indicators, packet identifier (PID), plus other information for error detection, timing and other functions. It is noted that the header and adaptation field of a TS packet shall not be scrambled.

In order to maintain proper synchronization between the ESs, for example, containing audio and video streams, synchronization is commonly achieved through the use of time stamp and clock reference. Time stamps for presentation and decoding are generally in units of 90 kHz, indicating the appropriate time according to the clock reference with a resolution of 27 MHz that a particular presentation unit (such as a video picture) should be decoded by the decoder and presented to the output device. A time stamp containing the presentation time of audio and video is commonly called the Presentation Time Stamp (PTS) that maybe present in a PES packet header, and indicates when the decoded picture is to be passed to the output device for display whereas a time stamp indicating the decoding time is called the Decoding Time Stamp (DTS). Program Clock Reference (PCR) in the Transport Stream (TS) and System Clock Reference (SCR) in the Program Stream (PS) indicate the sampled values of the system time clock. In general, the definitions of PCR and SCR may be considered to be equivalent, although there are distinctions. The PCR that maybe be present in the adaptation field of a TS packet provides the clock reference for one program, where a program consists of a set of ESs that has a common time base and is intended for synchronized decoding and presentation. There may be multiple programs in one TS, and each may have an independent time base and a separate set of PCRs. As an illustration of an exemplary operation of the decoder, the system time clock of the decoder is set to the value of the transmitted PCR (or SCR), and a frame is displayed when the system time clock of the decoder matches the value of the PTS of the frame. For consistency and clarity, the remainder of this disclosure will use the term PCR. However, equivalent statements and applications apply to the SCR or other equivalents or alternatives except where specifically noted otherwise. A more extensive explanation of MPEG-2 System Layer can be found in “Generic Coding of Moving Pictures and Associated Audio Information—Part 2: Systems,” ISO/IEC 13818-1 (MPEG-2), 1994.

Differences Between MPEG-1 and MPEG-2

The MPEG-2 Video Standard supports both progressive scanned video and interlaced scanned video while the MPEG-1 Video standard only supports progressive scanned video. In progressive scanning, video is displayed as a stream of sequential raster-scanned frames. Each frame contains a complete screen-full of image data, with scanlines displayed in sequential order from top to bottom on the display. The “frame rate” specifies the number of frames per second in the video stream. In interlaced scanning, video is displayed as a stream of alternating, interlaced (or interleaved) top and bottom raster fields at twice the frame rate, with two fields making up each frame. The top fields (also called “upper fields” or “odd fields”) contain video image data for odd numbered scanlines (starting at the top of the display with scanline number 1), while the bottom fields contain video image data for even numbered scanlines. The top and bottom fields are transmitted and displayed in alternating fashion, with each displayed frame comprising a top field and a bottom field. Interlaced video is different from non-interlaced video, which paints each line on the screen in order. The interlaced video method was developed to save bandwidth when transmitting signals but it can result in a less detailed image than comparable non-interlaced (progressive) video.

The MPEG-2 Video Standard also supports both frame-based and field-based methodologies for DCT block coding and motion prediction while MPEG-1 Video Standard only supports frame-based methodologies for DCT. A block coded by field DCT method typically has a larger motion component than a block coded by the frame DCT method.

MPEG-4

The MPEG-4 is a Audiovisual (AV) encoder/decoder (codec) framework for creating and enabling interactivity with a wide set of tools for creating enhanced graphic content for objects organized in a hierarchical way for scene composition. The MPEG-4 video standard was started in 1993 with the object of video compression and to provide a new generation of coded representation of a scene. For example, MPEG-4 encodes a scene as a collection of visual objects where the objects (natural or synthetic) are individually coded and sent with the description of the scene for composition. Thus MPEG-4 relies on an object-based representation of a video data based on video object (VO) defined in MPEG-4 where each VO is characterized with properties such as shape, texture and motion. To describe the composition of these VOs to create audiovisual scenes, several VOs are then composed to form a scene with Binary Format for Scene (BIFS) enabling the modeling of any multimedia scenario as a scene graph where the nodes of the graph are the VOs. The BIFS describes a scene in the form a hierarchical structure where the nodes may be dynamically added or removed from the scene graph on demand to provide interactivity, mix/match of synthetic and natural audio or video, manipulation/composition of objects that involves scaling, rotation, drag, drop and so forth. Therefore the MPEG-4 stream is composed BIFS syntax, video/audio objects and other basic information such as synchronization configuration, decoder configurations and so on. Since BIFS contains information on the scheduling, coordinating in temporal and spatial domain, synchronization and processing interactivity, the client receiving the MPEG-4 stream needs to firstly decode the BIFS information that which composes the audio/video ES. Based on the decoded BIFS information the decoder accesses the associated audio-visual data as well as other possible supplementary data. To apply MPEG-4 object-based representation to a scene, objects included in the scene should first be detected and segmented which cannot be easily automated by using the current state-of-art image analysis technology.

H.264 (AVC)

H.264 also called Advanced Video Coding (AVC) or MPEG-4 part 10 is the newest international video coding standard. Video coding standards such as MPEG-2 enabled the transmission of HDTV signals over satellite, cable, and terrestrial emission and the storage of video signals on various digital storage devices (such as disc drives, CDs, and DVDs). However, the need for H.264 has arisen to improve the coding efficiency over prior video coding standards such MPEG-2.

Relative to prior video coding standards, H.264 has features that allow enhanced video coding efficiency. H.264 allows for variable block-size quarter-sample-accurate motion compensation with block sizes as small as 4×4 allowing more flexibility in the selection of motion compensation block size and shape over prior video coding standards.

H.264 has an advanced reference picture selection technique such that the encoder can select the pictures to be referenced for motion compensation compared to P- or B-pictures in MPEG-1 and MPEG-2 which may only reference a combination of a adjacent future and previous picture. Therefore a high degree of flexibility is provided in the ordering of pictures for referencing and display purposes compared to the strict dependency between the ordering of pictures for motion compensation in the prior video coding standard.

Another technique of H.264 absent from other video coding standards is that H.264 allows the motion-compensated prediction signal to be weighted and offset by amounts specified by the encoder to improve the coding efficiency dramatically.

All major prior coding standards (such as JPEG, MPEG-1, MPEG-2) use a block size of 8×8 for transform coding while H.264 design uses a block size of 4×4 for transform coding. This allows the encoder to represent signals in a more adaptive way, enabling more accurate motion compensation and reducing artifacts. H.264 also uses two entropy coding methods, called Context-adaptive variable length coding (CAVLC) and Context-adaptive binary arithmetic coding (CABAC), using context-based adaptivity to improve the performance of entropy coding relative to prior standards.

H.264 also provides robustness to data error/losses for a variety of network environments. For example, a parameter set design provides for robust header information which is sent separately for handling in a more flexible way to ensure that no severe impact in the decoding process is observed even if a few bits of information are lost during transmission. In order to provide data robustness H.264 partitions pictures into a group of slices where each slice may be decoded independent of other slices, similar to MPEG-1 and MPEG-2. However the slice structure in MPEG-2 is less flexible compared to H.264, reducing the coding efficiency due to the increasing quantity of header data and decreasing the effectiveness of prediction.

In order to enhance the robustness, H.264 allows regions of a picture to be encoded redundantly such that if the primary information regarding a picture is lost, the picture can be recovered by receiving the redundant information on the lost region. Also H.264 separates the syntax of each slice into multiple different partitions depending on the importance of the coded information for transmission.

ATSC/DVB

The ATSC is an international, non-profit organization developing voluntary standards for digital television (TV) including digital HDTV and SDTV. The ATSC digital TV standard, Revision B (ATSC Standard A/53B) defines a standard for digital video based on MPEG-2 encoding, and allows video frames as large as 1920×1080 pixels/pels (2,073,600 pixels) at 19.29 Mbps, for example. The Digital Video Broadcasting Project (DVB—an industry-led consortium of over 300 broadcasters, manufacturers, network operators, software developers, regulatory bodies and others in over 35 countries) provides a similar international standard for digital TV. Digitalization of cable, satellite and terrestrial television networks within Europe is based on the Digital Video Broadcasting (DVB) series of standards while USA and Korea utilize ATSC for digital TV broadcasting.

In order to view ATSC and DVB compliant digital streams, digital STBs which may be connected inside or associated with user's TV set began to penetrate TV markets. For purpose of this disclosure, the term STB is used to refer to any and all such display, memory, or interface devices intended to receive, store, process, repeat, edit, modify, display, reproduce or perform any portion of a program, including personal computer (PC) and mobile device. With this new consumer device, television viewers may record broadcast programs into the local or other associated data storage of their Digital Video Recorder (DVR) in a digital video compression format such as MPEG-2. A DVR is usually considered a STB having recording capability, for example in associated storage or in its local storage or hard disk. A DVR allows television viewers to watch programs in the way they want (within the limitations of the systems) and when they want (generally referred to as “on demand”). Due to the nature of digitally recorded video, viewers should have the capability of directly accessing a certain point of a recorded program (often referred to as “random access”) in addition to the traditional video cassette recorder (VCR) type controls such as fast forward and rewind.

In standard DVRs, the input unit takes video streams in a multitude of digital forms, such as ATSC, DVB, Digital Multimedia Broadcasting (DMB) and Digital Satellite System (DSS), most of them based on the MPEG-2 TS, from the Radio Frequency (RF) tuner, a general network (for example, Internet, wide area network (WAN), and/or local area network (LAN)) or auxiliary read-only disks such as CD and DVD.

The DVR memory system usually operates under the control of a processor which may also control the demultiplexor of the input unit. The processor is usually programmed to respond to commands received from a user control unit manipulated by the viewer. Using the user control unit, the viewer may select a channel to be viewed (and recorded in the buffer), such as by commanding the demultiplexor to supply one or more sequences of frames from the tuned and demodulated channel signals which are assembled, in compressed form, in the random access memory, which are then supplied via memory to a decompressor/decoder for display on the display device(s).

The DVB Service Information (SI) and ATSC Program Specific Information Protocol (PSIP) are the glue that holds the DTV signal together in DVB and ATSC, respectively. ATSC (or DVB) allow for PSIP (or SI) to accompany broadcast signals and is intended to assist the digital STB and viewers to navigate through an increasing number of digital services. The ATSC-PSIP and DVB-SI are more fully described in “ATSC Standard A/53C with Amendment No. 1: ATSC Digital Television Standard”, Rev. C, and in “ATSC Standard A/65B: Program and System Information Protocol for Terrestrial Broadcast and Cable”, Rev. B 18 Mar. 2003 (see World Wide Web at atsc.org) and “ETSI EN 300 468 Digital Video Broadcasting (DVB); Specification for Service Information (SI) in DVB Systems” (see World Wide Web at etsi.org).

Within DVB-SI and ATSC-PSIP, the Event Information Table (EIT) is especially important as a means of providing program (“event”) information. For DVB and ATSC compliance it is mandatory to provide information on the currently running program and on the next program. The EIT can be used to give information such as the program title, start time, duration, a description and parental rating.

In the article “ATSC Standard A/65B: Program and System Information Protocol for Terrestrial Broadcast and Cable,” Rev. B, 18 Mar. 2003 (see World Wide Web at atsc.org), it is noted that PSIP is a voluntary standard of the ATSC and only limited parts of the standard are currently required by the Federal Communications Commission (FCC). PSIP is a collection of tables designed to operate within a TS for terrestrial broadcast of digital television. Its purpose is to describe the information at the system and event levels for all virtual channels carried in a particular TS. The packets of the base tables are usually labeled with a base packet identifier (PID, or base PID). The base tables include System Time Table (STT), Rating Region Table (RRT), Master Guide Table (MGT), Virtual Channel Table (VCT), EIT and Extent Text Table (ETT), while the collection of PSIP tables describe elements of typical digital TV service.

The STT is the simplest and smallest table in the PSIP table to indicate the reference for time of day to receivers. The System Time Table is a small data structure that fits in one TS packet and serves as a reference for time-of-day functions. Receivers or STBs can use this table to manage various operations and scheduled events, as well as display time-of-day. The reference for time-of-day functions is given in system time by the system_time field in the STT based on current Global Positioning Satellite (GPS) time, from 12:00 a.m. Jan. 6, 1980, in an accuracy of within 1 second. The DVB has a similar table called Time and Date Table (TDT). The TDT reference of time is based on the Universal Time Coordinated (UTC) and Modified Julian Date (MJD) as described in Annex C at “ETSI EN 300 468 Digital Video Broadcasting (DVB); Specification for Service Information (SI) in DVB systems” (see World Wide Web at etsi.org).

The Rating Region Table (RTT) has been designed to transmit the rating system in use for each country having such as system. In the United States, this is incorrectly but frequently referred to as the “V-chip” system; the proper title is “Television Parental Guidelines” (TVPG). Provisions have also been made for multi-country systems.

The Master Guide Table (MGT) provides indexing information for the other tables that comprise the PSIP Standard. It also defines table sizes necessary for memory allocation during decoding, defines version numbers to identify those tables that need to be updated, and generates the packet identifiers that label the tables. An exemplary Master Guide table (MGT) and its usage may be found at “ATSC Standard A/65B: Program and System Information Protocol for Terrestrial Broadcast and Cable, Rev. B 18 Mar. 2003” (see World Wide Web at atsc.org).

The Virtual Channel Table (VCT), also referred to as the Terrestrial VCT (TVCT), contains a list of all the channels that are or will be on-line, plus their attributes. Among the attributes given are the channel name, channel number, the carrier frequency and modulation mode to identify how the service is physically delivered. The VCT also contains a source identifier (ID) which is important for representing a particular logical channel. Each EIT contains a source ID to identify which minor channel will carry its programming for each 3 hour period. Thus the source ID may be considered as a Universal Resource Locator (URL) scheme that could be used to target a programming service. Much like Internet domain names in regular Internet URLs, such a source ID type URL does not need to concern itself with the physical location of the referenced service, providing a new level of flexibility into the definition of source ID. The VCT also contains information on the type of service indicating whether analog TV, digital TV or other data is being supplied. It also may contain descriptors indicating the PIDs to identify the packets of service and descriptors for extended channel name information.

The EIT table is a PSIP table that carries information regarding the program schedule information for each virtual channel. Each instance of an EIT traditionally covers a three hour span, to provide information such as event duration, event title, optional program content advisory data, optional caption service data, and audio service descriptor(s). There are currently up to 128 EITs-EIT-0 through EIT-127—each of which describes the events or television programs for a time interval of three hours. EIT-0 represents the “current” three hours of programming and has some special needs as it usually contains the closed caption, rating information and other essential and optional data about the current programming. Because the current maximum number of EITs is 128, up to 16 days of programming may be advertised in advance. At minimum, the first four EITs should always be present in every TS, and 24 are recommended. Each EIT-k may have multiple instances, one for each virtual channel in the VCT. The current EIT table contains information only on the current and future events that are being broadcast and that will be available for some limited amount of time into the future. However, a user might wish to know about a program previously broadcast in more detail.

The ETT table is an optional table which contains a detailed description in various languages for an event and/or channel. The detailed description in the ETT table is mapped to an event or channel by a unique identifier.

In the Article “ATSC Standard A/65B: Program and System Information Protocol for Terrestrial Broadcast and Cable,” Rev. B, 18 Mar. 2003 (see World Wide Web at atsc.org), it is noted that there may be multiple ETTs, one or more channel ETT sections describing the virtual channels in the VCT, and an ETT-k for each EIT-k, describing the events in the EIT-k. The ETTs are utilized in case it is desired to send additional information about the entire event since the number of characters for the title is restricted in the EIT. These are all listed in the MGT. An ETT-k contains a table instance for each event in the associated EIT-k. As the name implies, the purpose of the ETT is to carry text messages. For example, for channels in the VCT, the messages can describe channel information, cost, coming attractions, and other related data. Similarly, for an event such as a movie listed in the EIT, the typical message would be a short paragraph that describes the movie itself. ETTs are optional in the ATSC system.

The PSIP tables carry a mixture of short tables with short repeat cycles and larger tables with long cycle times. The transmission of one table must be complete before the next section can be sent. Thus, transmission of large tables must be complete within a short period in order to allow fast cycling tables to achieve specified time interval. This is more completely discussed at “ATSC Recommended Practice: Program and System Information Protocol Implementation Guidelines for Broadcasters” (see World Wide Web at atsc.org/standards/a_{—}69.pdf).

DVD

Digital Video (or Versatile) Disc (DVD) is a multi-purpose optical disc storage technology suited to both entertainment and computer uses. As an entertainment product DVD allows home theater experience with high quality video, usually better than alternatives, such as VCR, digital tape and CD.

DVD has revolutionized the way consumers use pre-recorded movie devices for entertainment. With video compression standards such as MPEG-2, content providers can usually store over 2 hours of high quality video on one DVD disc. In a double-sided, dual-layer disc, the DVD can hold about 8 hours of compressed video which corresponds to approximately 30 hours of VHS TV quality video. DVD also has enhanced functions, such as support for wide screen movies; up to eight (8) tracks of digital audio each with as many as eight (8) channels; on-screen menus and simple interactive features; up to nine (9) camera angles; instant rewind and fast forward functionality; multi-lingual identifying text of title name; album name, song name, and automatic seamless branching of video. The DVD also allows users to have a useful and interactive way to get to their desired scenes with the chapter selection feature by defining the start and duration of a segment along with additional information such as an image and text (providing limited, but effective random access viewing). As an optical format, DVD picture quality does not degrade over time or with repeated usage, as compared to video tapes (which are magnetic storage media). The current DVD recording format uses 4:2:2 component digital video, rather than NTSC analog composite video, thereby greatly enhancing the picture quality in comparison to current conventional NTSC.

TV-Anytime and MPEG-7

TV viewers are currently provided with information on programs such as title and start and end times that are currently being broadcast or will be broadcast, for example, through an EPG. At this time, the EPG contains information only on the current and future events that are being broadcast and that will be available for some limited amount of time into the future. However, a user might wish to know about a program previously broadcast in more detail. Such demands have arisen due to the capability of DVRs enabling recording of broadcast programs. A commercial DVR service based on proprietary EPG data format is available, as by the company TiVo (see World Wide Web at tivo.com).

The simple service information such as program title or synopsis that is currently delivered through the EPG scheme appears to be sufficient to guide users to select a channel and record a program. However, users might wish to fast access to specific segments within a recorded program in the DVR. In the case of current DVD movies, users can access to a specific part of a video through “chapter selection” interface. Access to specific segments of the recorded program requires segmentation information of a program that describes a title, category, start position and duration of each segment that could be generated through a process called “video indexing”. To access to a specific segment without the segmentation information of a program, viewers currently have to linearly search through the video from the beginning, as by using the fast forward button, which is a cumbersome and time-consuming process.

TV-Anytime

Local storage of AV content and data on consumer electronics devices accessible by individual users opens a variety of potential new applications and services. Users can now easily record contents of their interests by utilizing broadcast program schedules and later watch the programs, thereby taking advantage of more sophisticated and personalized contents and services via a device that is connected to various input sources such as terrestrial, cable, satellite, Internet and others. Thus, these kinds of consumer devices provide new business models to three main provider groups: content creators/owners, service providers/broadcasters and related third parties, among others. The global TV-Anytime Forum (see World Wide Web at tv-anytime.org) is an association of organizations which seeks to develop specifications to enable audio-visual and other services based on mass-market high volume digital local storage in consumer electronics platforms. The forum has been developing a series of open specifications since being formed on September 1999.

The TV-Anytime Forum identifies new potential business models, and introduced a scheme for content referencing with Content Referencing Identifiers (CRIDs) with which users can search, select, and rightfully use content on their personal storage systems. The CRID is a key part of the TV-Anytime system specifically because it enables certain new business models. However, one potential issue is, if there are no business relationships defined between the three main provider groups, as noted above, there might be incorrect and/or unauthorized mapping to content. This could result in a poor user experience. The key concept in content referencing is the separation of the reference to a content item (for example, the CRID) from the information needed to actually retrieve the content item (for example, the locator). The separation provided by the CRID enables a one-to-many mapping between content references and the locations of the contents. Thus, search and selection yield a CRID, which is resolved into either a number of CRIDs or a number of locators. In the TV-Anytime system, the main provider groups can originate and resolve CRIDs. Ideally, the introduction of CRIDs into the broadcasting system is advantageous because it provides flexibility and reusability of content metadata. In existing broadcasting systems, such as ATSC-PSIP and DVB-SI, each event (or program) in an EIT table is identified with a fixed 16-bit event identifier (EID). However, CRIDs require a rather sophisticated resolving mechanism. The resolving mechanism usually relies on a network which connects consumer devices to resolving servers maintained by the provider groups. Unfortunately, it may take a long time to appropriately establish the resolving servers and network.

TV-Anytime also defines the metadata format for metadata that may be exchanged between the provider groups and the consumer devices. In a TV-Anytime environment, the metadata includes information about user preferences and history as well as descriptive data about content such as title, synopsis, scheduled broadcasting time, and segmentation information. Especially, the descriptive data is an essential element in the TV-Anytime system because it could be considered as an electronic content guide. The TV-Anytime metadata allows the consumer to browse, navigate and select different types of content. Some metadata can provide in-depth descriptions, personalized recommendations and detail about a whole range of contents both local and remote. In TV-Anytime metadata, program information and scheduling information are separated in such a way that scheduling information refers its corresponding program information via the CRIDs. The separation of program information from scheduling information in TV-Anytime also provides a useful efficiency gain whenever programs are repeated or rebroadcast, since each instance can share a common set of program information.

The schema or data format of TV-Anytime metadata is usually described with XML Schema, and all instances of TV-Anytime metadata are also described in an extensible Markup Language (XML). Because XML is verbose, the instances of TV-Anytime metadata require a large amounts of data or high bandwidth. For example, the size of an instance of TV-Anytime metadata might be 5 to 20 times larger than that of an equivalent EIT (Event Information Table) table according to ATSC-PSIP or DVB-SI specification. In order to overcome the bandwidth problem, TV-Anytime provides a compression/encoding mechanism that converts an XML instance of TV-Anytime metadata into equivalent binary format. According to TV-Anytime, compression specification, the XML structure of TV-Anytime metadata is coded using BiM, an efficient binary encoding format for XML adopted by MPEG-7. The Time/Date and Locator fields also have their own specific codecs. Furthermore, strings are concatenated within each delivery unit to ensure efficient Zlib compression is achieved in the delivery layer. However, despite the use of the three compression techniques in TV-Anytime, the size of a compressed TV-Anytime metadata instance is hardly smaller than that of an equivalent EIT in ATSC-PSIP or DVB-SI because the performance of Zlib is poor when strings are short, especially fewer than 100 characters. Since Zlib compression in TV-Anytime is executed on each TV-Anytime fragment that is a small data unit such as a title of a segment or a description of a director, good performance of Zlib can not generally be expected.

MPEG-7

Motion Picture Expert Group—Standard 7 (MPEG-7), formally named “Multimedia Content Description Interface,” is the standard that provides a rich set of tools to describe multimedia content. MPEG-7 offers a comprehensive set of audiovisual description tools for the elements of metadata and their structure and relationships), enabling the effective and efficient access (search, filtering and browsing) to multimedia content. MPEG-7 uses XML schema language as the Description Definition Language (DDL) to define both descriptors and description schemes. Parts of MPEG-7 specification such as user history are incorporated in TV Anytime specification.

Generating Visual Rhythm

Visual Rhythm (VR) is a known technique whereby video is sub-sampled, frame-by-frame, to produce a single image (visual timeline) which contains (and conveys) information about the visual content of the video. It is useful, for example, for shot detection. A visual rhythm image is typically obtained by sampling pixels lying along a sampling path, such as a diagonal line traversing each frame. A line image is produced for the frame, and the resulting line images are stacked, one next to the other, typically from left-to-right. Each vertical slice of visual rhythm with a single pixel width is obtained from each frame by sampling a subset of pixels along the predefined path. In this manner, the visual rhythm image contains patterns or visual features that allow the viewer/operator to distinguish and classify many different types of video effects, (edits and otherwise) including: cuts, wipes, dissolves, fades, camera motions, object motions, flashlights, zooms, and so forth. The different video effects manifest themselves as different patterns on the visual rhythm image. Shot boundaries and transitions between shots can be detected by observing the visual rhythm image which is produced from a video. Visual Rhythm is further described in commonly-owned, copending U.S. patent application Ser. No. 09/911,293 filed Jul. 23, 2001 (Publication No. 2002/0069218).

Interactive TV

The interactive TV is a technology combining various mediums and services to enhance the viewing experience of the TV viewers. Through two-way interactive TV, a viewer can participate in a TV program in a way that is intended by content/service providers, rather than the conventional way of passively viewing what is displayed on screen as in analog TV. Interactive TV provides a variety of kinds of interactive TV applications such as news tickers, stock quotes, weather service and T-commerce. One of the open standards for interactive digital TV is Multimedia Home Platform (MHP) (in the united states, MHP has its equivalent in the Java-Based Advanced Common Application Platform (ACAP), and Advanced Television Systems Committee (ATSC) activity and in OCAP, the Open Cable Application Platform specified by the OpenCable consortium) which provides a generic interface between the interactive digital applications and the terminals (for example, DVR) that receive and run the applications. A content producer produces an MHP application written mostly in JAVA using a set of MHP Application Program Interface (API) set. The MHP API set contains various API sets for primitive MPEG access, media control, tuner control, graphics, communications and so on. MHP broadcasters and network operators then are responsible for packaging and delivering the MHP application created by the content producer such that it can be delivered to the users having an MHP compliant digital appliances or STBs. MHP applications are delivered to SBTs by inserting the MHP-based services into the MPEG-2 TS in the form of Digital Storage Media-Command and Control (DSM-CC) object carousels. A MHP compliant DVR then receives and process the MHP application in the MPEG-2 TS with a Java virtual machine.

Real-Time Indexing of TV Programs

A scenario, called “quick metadata service” on live broadcasting, is described in the above-referenced U.S. patent application Ser. No. 10/369,333 filed Feb. 19, 2003, and U.S. patent application Ser. No. 10/368,304 filed Feb. 18, 2003 where descriptive metadata of a broadcast program is also delivered to a DVR while the program is being broadcast and recorded. In the case of live broadcasting of sports games such as football, television viewers may want to selectively view and review highlight events of a game as well as plays of their favorite players while watching the live game. Without the metadata describing the program, it is not easy for viewers to locate the video segments corresponding to the highlight events or objects (for example, players in case of sports games or specific scenes or actors, actresses in movies) by using conventional controls such as fast forwarding.

As disclosed herein, the metadata includes time positions such as start time positions, duration and textual descriptions for each video segment corresponding to semantically meaningful highlight events or objects. If the metadata is generated in real-time and incrementally delivered to viewers at a predefined interval or whenever new highlight event(s) or object(s) occur or whenever broadcast, the metadata can then be stored at the local storage of the DVR or other device for a more informative and interactive TV viewing experience such as the navigation of content by highlight events or objects. Also, the entirety or a portion of the recorded video may be re-played using such additional data. The metadata can also be delivered just one time immediately after its corresponding broadcast television program has finished, or successive metadata materials may be delivered to update, expand or correct the previously delivered metadata. Alternatively, metadata may be delivered prior to broadcast of an event (such as a pre-recorded movie) and associated with the program when it is broadcast. Also, various combinations of pre-, post-, and during broadcast delivery of metadata are hereby contemplated by this disclosure.

One of the key components for the quick metadata service is a real-time indexing of broadcast television programs. Various methods have been proposed for video indexing, such as U.S. Pat. No. 6,278,446 (“Liou”) which discloses a system for interactively indexing and browsing video; and, U.S. Pat. No. 6,360,234 (“Jain”) which discloses a video cataloger system. These current and existing systems and methods, however, fall short of meeting their avowed or intended goals, especially for real-time indexing systems.

The various conventional methods can, at best, generate low-level metadata by decoding closed-caption texts, detecting and clustering shots, selecting key frames, attempting to recognize faces or speech, all of which could perhaps synchronized with video. However, with the current state-of-art technologies on image understanding and speech recognition, it is very difficult to accurately detect highlights and generate semantically meaningful and practically usable highlight summary of events or objects in real-time for many compelling reasons:

First, as described earlier, it is difficult to automatically recognize diverse semantically meaningful highlights. For example, a keyword “touchdown” can be identified from decoded closed-caption texts in order to automatically find touchdown highlights, resulting in numerous false alarms.

Therefore, according to the present disclosure, generating semantically meaningful and practically usable highlights still require the intervention of a human or other complex analysis system operator, usually after broadcast, but preferably during broadcast (usually slightly delayed from the broadcast event) for a first, rough, metadata delivery. A more extensive metadata set(s) could be later provided and, of course, pre-recorded events could have rough or extensive metadata set(s) delivered before, during or after the program broadcast. The later delivered metadata set(s) may augment, annotate or replace previously-sent, later-sent metadata, as desired.

Second, the conventional methods do not provide an efficient way for manually marking distinguished highlights in real-time. Consider a case where a series of highlights occurs at short intervals. Since it takes time for a human operator to type in a title and extra textual descriptions of a new highlight, there might be a possibility of missing the immediately following events.

Media Localization

The media localization within a given temporal audio-visual stream or file has been traditionally described using either the byte location information or the media time information that specifies a time point in the stream. In other words, in order to describe the location of a specific video frame within an audio-visual stream, a byte offset (for example, the number of bytes to be skipped from the beginning of the video stream) has been used. Alternatively, a media time describing a relative time point from the beginning of the audio-visual stream has also been used. For example, in the case of a video-on-demand (VOD) through interactive Internet or high-speed network, the start and end positions of each audio-visual program is defined unambiguously in terms of media time as zero and the length of the audio-visual program, respectively, since each program is stored in the form of a separate media file in the storage at the VOD server and, further, each audio-visual program is delivered through streaming on each client's demand. Thus, a user at the client side can gain access to the appropriate temporal positions or video frames within the selected audio-visual stream as described in the metadata.

However, as for TV broadcasting, since a digital stream or analog signal is continuously broadcast, the start and end positions of each broadcast program are not clearly defined. Since a media time or byte offset are usually defined with reference to the start of a media file, it could be ambiguous to describe a specific temporal location of a broadcast program using media times or byte offsets in order to relate an interactive application or event, and then to access to a specific location within an audio-visual program.

One of the existing solutions to achieve the frame accurate media localization or access in broadcast stream is to use PTS. The PTS is a field that may be present in a PES packet header as defined in MPEG-2, which indicates the time when a presentation unit is presented in the system target decoder. However, the use of PTS alone is not enough to provide a unique representation of a specific time point or frame in broadcast programs since the maximum value of PTS can only represent the limited amount of time that corresponds to approximately 26.5 hours. Therefore, additional information will be needed to uniquely represent a given frame in broadcast streams. On the other hand, if a frame accurate representation or access is not required, there is no need for using PTS and thus the following issues can be avoided: The use of PTS requires parsing of PES layers, and thus it is computationally expensive. Further, if a broadcast stream is scrambled, the descrambling process is needed to access to the PTS. The MPEG-2 System specification contains an information on a scrambling mode of the TS packet payload, indicating the PES contained in the payload is scrambled or not. Moreover, most of digital broadcast streams are scrambled, thus a real-time indexing system cannot access the stream in frame accuracy without an authorized descrambler if a stream is scrambled.

Another existing solution for media localization in broadcast programs is to use MPEG-2 DSM-CC Normal Play Time (NPT) that provides a known time reference to a piece of media. MPEG-2 DSM-CC Normal Play Time (NPT is more fully described at “ISO/IEC 13818-6, Information technology—Generic coding of moving pictures and associated audio information—Part 6: Extensions for DSM-CC” (see World Wide Web at iso.org). For applications of TV-Anytime metadata in DVB-MHP broadcast environment, it was proposed that the NPT should be used for the purpose of time description, more fully described at “ETSI TS 102 812: DVB Multimedia Home Platform (MHP) Specification” (see World Wide Web at etsi.org) and “MyTV: A practical implementation of TV-Anytime on DVB and the Internet” (International Broadcasting Convention, 2001) by A. McPrland, J. Morris, M. Leban, S. Rarnall, A. Hickman, A. Ashley, M. Haataja, F. dejong. In the proposed implementation, however, it is required that both head ends and receiving client device can handle NPT properly, thus resulting in highly complex controls on time.

Schemes for authoring metadata, video indexing/navigation and broadcast monitoring are known. Examples of these can be found in U.S. Pat. No. 6,357,042, U.S. patent application Ser. No. 10/756,858 filed Jan. 10, 2001 (Pub. No. U.S. 2001/0014210 A1), and U.S. Pat. No. 5,986,692.

Glossary

Unless otherwise noted, or as may be evident from the context of their usage, any terms, abbreviations, acronyms or scientific symbols and notations used herein are to be given their ordinary meaning in the technical discipline to which the disclosure most nearly pertains. The following terms, abbreviations and acronyms may be used in the description contained herein:
ACAP Advanced Common Application Platform (ACAP) is the result of harmonization of the CableLabs OpenCable (OCAP) standard and the previous DTV Application Software Environment (DASE) specification of the Advanced Television Systems Committee (ATSC). A more extensive explanation of ACAP may be found at “Candidate Standard: Advanced Common Application Platform (ACAP)” (see World Wide Web at atsc.org).
API Application Program Interface (API) is a set of software calls and routines that can be referenced by an application program as means for providing an interface between two software application. An explanation and examples of an API may be found at “Dan Appleman's Visual Basic Programmer's guide to the Win32 API” (Sams, February, 1999) by Dan Appleman.
ATSC Advanced Television Systems Committee, Inc. (ATSC) is an international, non-profit organization developing voluntary standards for digital television. Countries such as U.S. and Korea adopted ATSC for digital broadcasting. A more extensive explanation of ATSC may be found at “ATSC Standard A/53C with Amendment No. 1: ATSC Digital Television Standard, Rev. C,” (see World Wide Web at atsc.org). More description may be found in “Data Broadcasting: Understanding the ATSC Data Broadcast Standard” (McGraw-Hill Professional, April 2001) by Richard S. Chernock, Regis J. Crinon, Michael A. Dolan, Jr., John R. Mick; and may also be available in “Digital Television, DVB-T COFDM and ATSC 8-VSB” (Digitaltvbooks.com, October 2000) by Mark Massel. Alternatively, Digital Video Broadcasting (DVB) is an industry-led consortium committed to designing global standards that were adopted in European and other countries, for the global delivery of digital television and data services.
AV Audiovisual.
AVC Advanced Video Coding (H.264) is newest video coding standard of the ITU-T Video Coding Experts Group and the ISO/IEC Moving Picture Experts Group. An explanation of AVC may be found at “Overview of the H.264/AVC video coding standard”, Wiegand, T., Sullivan, G. J., Bjntegaard, G., Luthra, A., Circuits and Systems for Video Technology, IEEE Transactions on, Volume: 13, Issue: 7, July 2003, Pages: 560-576; another may be found at “ISO/IEC 14496-10: Information technology—Coding of audio-visual objects—Part 10: Advanced Video Coding” (see World Wide Web at iso.org); Yet another description is found in “H.264 and MPEG-4 Video Compression” (Wiley) by lain E. G. Richardson, all three of which are incorporated herein by reference. MPEG-1 and MPEG-2 are alternatives or adjunct to AVC and are considered or adopted for digital video compression.
BD Blue-ray Disc (BD) is a high capacity CD-size storage media disc for video, multimedia, games, audio and other applications. A more complete explanation of BD may be found at “White paper for Blue-ray Disc Format” (see World Wide Web at bluraydisc.com/assets/downloadablefile/general bluraydiscformat-12834.pdf). DVD (Digital Video Disc), CD (Compact Disc), minidisk, hard drive, magnetic tape, circuit-based (such as flash RAM) data storage medium are alternatives or adjuncts to BD for storage, either in analog or digital format.
BIFS Binary Format for Scene is a scene graph in the form of hierarchical structure describing how the video objects should be composed to form a scene in MPEG-4. A more extensive information of BIFS may be found at “H.264 and MPEG-4 Video Compression” (John Wiley & Sons, August, 2003) by lain E. G. Richardson and “The MPEG-4 Book” (Prentice Hall PTR, July, 2002) by Touradj Ebrahimi, Fernando Pereira.
BiM Binary Metadata (BiM) Format for MPEG-7. A more extensive explanation of BiM may be found at “ISO/IEC 15938-1: Multimedia Context Description Interface—Part 1 Systems” (see World Wide Web at iso.ch).
BNF Backus Naur Form (BNF) is a formal metadata syntax to describe the syntax and grammar of structure languages such as programming languages. A more extensive explanation of BNF may be found at “The World of Programming Languages” (Springer-Verlag 1986) by M. Marcotty & H. Ledgard.
bslbf bit string, left-bit first. The-bit string is written as a string of 1s and 0s in the left order first. A more extensive explanation of bslbf may be found at may be found at “Generic Coding of Moving Pictures and Associated Audio Information—Part 1: Systems,” ISO/IEC 13818-1 (MPEG-2), 1994 (http://iso.org).
CA Conditional Access (CA) is a system utilized to prevent unauthorized users to access contents such as video, audio and so forth such that it ensures that viewers only see those programs they have paid to view. A more extensive explanation of CA may be found at “Conditional access for digital TV: Opportunities and challenges in Europe and the U.S.” (2002) by MarketResearch.com.
codec enCOder/DECoder is a short word for the encoder and the decoder. The encoder is a device that encodes data for the purpose of achieving data compression. Compressor is a word used alternatively for encoder. The decoder is a device that decodes the data that is encoded for data compression. Decompressor is a word alternatively used for decoder. Codecs may also refer to other types of coding and decoding devices.
COFDM Coded Octal frequency division multiplex (COFDM) is a modulation scheme used predominately in Europe and is supported by the Digital Video Broadcasting (DVB) set of standards. In the U.S., the Advanced Television Standards Committee (ATSC) has chosen 8-VSB (8-level Vestigial Sideband) as its equivalent modulation standard. A more extensive explanation on COFDM may be found at “Digital Television, DVB-T COFDM and ATSC 8-VSB” (Digitaltvbooks.com, October 2000) by Mark Massel.
CRC Cyclic Redundancy Check (CRC) is a 32-bit value to check if an error has occurred in a data during transmission, it is further explained in Annex A of ISO/IEC 13818-1 (see World Wide Web at iso.org).
CRID Content Reference IDentifier (CRID) is an identifier devised to bridge between the metadata of a program and the location of the program distributed over a variety of networks. A more extensive explanation of CRID may be found at “Specification Series: S-4 On: Content Referencing” (http://tv-anytime.org).
DAB Digital Audio Broadcasting (DAB) on terrestrial networks providing Compact Disc (CD) quality sound, text, data, and videos on the radio. A more detailed explanation of DAB may be found on the World Wide Web at worlddab.org/about.aspx. A more detailed description may also be found in “Digital Audio Broadcasting: Principles and Applications of Digital Radio” (John Wiley and Sons, Ltd.) by W. Hoeg, Thomas Lauterbach.
DASE DTV Application Software Environment (DASE) is a standard of ATSC that defines a platform for advanced functions in digital TV receivers such as a set top box. A more extensive explanation of DASE may be found at “ATSC Standard A/100: DTV Application Software Environment—Level 1 (DASE-1)” (see World Wide Web at atsc.org).
DCT Discrete Cosine Transform (DCT) is a transform function from spatial domain to frequency domain, a type of transform coding. A more extensive explanation of DCT may be found at “Discrete-Time Signal Processing” (Prentice Hall, 2^{nd} edition, February 1999) by Alan V. Oppenheim, Ronald W. Schafer, John R. Buck. Wavelet transform is an alternative or adjunct to DCT for various compression standards such as JPEG-2000 and Advanced Video Coding. A more thorough description of wavelet may be found at “Introduction on Wavelets and Wavelets Transforms” (Prentice Hall, 1^{st} edition, August 1997)) by C. Sidney Burrus, Ramesh A. Gopinath. DCT may be combined with Wavelet, and other transformation functions, such as for video compression, as in the MPEG 4 standard, more fully describes at “H.264 and MPEG-4 Video Compression” (John Wiley & Sons, August 2003) by lain E. G. Richardson and “The MPEG-4 Book” (Prentice Hall, July 2002) by Touradj Ebrahimi, Fernando Pereira.
DCCT Directed Channel Change Table (DCCT) is a table permitting broadcasters to recommend users to change between channels when the viewing experience can be enhanced. A more extensive explanation of DCCT may be found at “ATSC Standard A/65B: Program and System Information Protocol for Terrestrial Broadcast and Cable”, Rev. B 18 Mar. 2003 (see World Wide Web at atsc.org).
DDL Description Definition Language (DDL) is a language that allows the creation of new Description Schemes and, possibly, Descriptors, and also allows the extension and modification of existing Description Schemes. An explanation on DDL may be found at “Introduction to MPEG 7: Multimedia Content Description Language” (John Wiley & Sons, June 2002) by B. S. Manjunath, Philippe Salembier, and Thomas Sikora. More generally, and alternatively, DDL can be interpreted as the Data Definition Language that is used by the database designers or database administrator to define database schemas. A more extensive explanation of DDL may be found at “Fundamentals of Database Systems” (Addison Wesley, July 2003) by R. Elmasri and S. B. Navathe.
DirecTV DirecTV is a company providing digital satellite service for television. A more detailed explanation of DirecTV may be found on the World Wide Web at directv.com/. Dish Network (see World Wide Web at dishnetwork.com), Voom (see World Wide Web at voom.com), and SkyLife (see World Wide Web at skylife.co.kr) are other companies providing alternative digital satellite service.
DMB Digital Multimedia Broadcasting (DMB), commercialized in Korea, is a new multimedia broadcasting service providing CD-quality audio, video, TV programs as well as a variety of information (for example, news, traffic news) for portable (mobile) receivers (small TV, PDA and mobile phones) that can move at high speeds.
DSL Digital Subscriber Line (DSL) is a high speed data line used to connect to the Internet. Different types of DSL were developed such as Asymmetric Digital Subscriber Line (ADSL) and Very high data rate Digital Subscriber Line (VDSL).
DSM-CC Digital Storage Media—Command and Control (DSM-CC) is a standard developed for the delivery of multimedia broadband services. A more extensive explanation of DSM-CC may be found at “ISO/IEC 13818-6, Information technology—Generic coding of moving pictures and associated audio information—Part 6: Extensions for DSM-CC” (see World Wide Web at iso.org).
DSS Digital Satellite System (DSS) is a network of satellites that broadcast digital data. An example of a DSS is DirecTV, which broadcasts digital television signals. DSS's are expected to become more important especially as TV and computers converge into a combined or unitary medium for information and entertainment (see World Wide Web at webopedia.com)
DTS Decoding Time Stamp (DTS) is a time stamp indicating the intended time of decoding. A more complete explanation of DTS may be found at “Generic Coding of Moving Pictures and Associated Audio Information—Part 1: Systems” ISO/IEC 13818-1 (MPEG-2), 1994 (http://iso.org).
DTV Digital Television (DTV) is an alternative audio-visual display device augmenting or replacing current analog television (TV) characterized by receipt of digital, rather than analog, signals representing audio, video and/or related information. Video display devices include Cathode Ray Tube (CRT), Liquid Crystal Display (LCD), Plasma and various projection systems. Digital Television is more fully described at “Digital Television: MPEG-1, MPEG-2 and Principles of the DVB System” (Butterworth-Heinemann, June, 1997) by Herve Benoit.
DVB Digital Video Broadcasting is a specification for digital television broadcasting mainly adopted in various countered in Europe adopt. A more extensive explanation of DVB may be found at “DVB: The Family of International Standards for Digital Video Broadcasting” by Ulrich Reimers (see World Wide Web at dvb.org). ATSC is an alternative or adjunct to DVB and is considered or adopted for digital broadcasting used in many countries such as the U.S. and Korea.
DVD Digital Video Disc (DVD) is a high capacity CD-size storage media disc for video, multimedia, games, audio and other applications. A more complete explanation of DVD may be found at “An Introduction to DVD Formats” (see World Wide Web at disctronics.co.uk/downloads/tech_docs/dvdintroduction.pdf) and “Video Discs Compact Discs and Digital Optical Discs Systems” (Information Today, June 1985) by Tony Hendley. CD (Compact Disc), minidisk, hard drive, magnetic tape, circuit-based (such as flash RAM) data storage medium are alternatives or adjuncts to DVD for storage, either in analog or digital format.
DVR Digital Video Recorder (DVR) is usually considered a STB having recording capability, for example in associated storage or in its local storage or hard disk A more extensive explanation of DVR may be found at “Digital Video Recorders: The Revolution Remains On Pause” (MarketResearch.com, April 2001) by Yankee Group.
EIT Event Information Table (EIT) is a table containing essential information related to an event such as the start time, duration, title and so forth on defined virtual channels. A more extensive explanation of EIT may be found at “ATSC Standard A/65B: Program and System Information Protocol for Terrestrial Broadcast and Cable,” Rev. B, 18 Mar. 2003 (see World Wide Web at atsc.org).
EPG Electronic Program Guide (EPG) provides information on current and future programs, usually along with a short description. EPG is the electronic equivalent of a printed television program guide. A more extensive explanation on EPG may be found at “The evolution of the EPG: Electronic program guide development in Europe and the U.S.” (MarketResearch.com) by Datamonitor.
ES Elementary Stream (ES) is a stream containing either video or audio data with a sequence header and subparts of a sequence. A more extensive explanation of ES may be found at “Generic Coding of Moving Pictures and Associated Audio Information—Part 1: Systems,” ISO/IEC 13818-1 (MPEG-2), 1994 (http://iso.org).
ESD Event Segment Descriptor (ESD) is a descriptor used in the Program and System Information Protocol (PSIP) and System Information (SI) to describe segmentation information of a program or event.
ETM Extended Text Message (ETM) is a string data structure used to represent a description in several different languages. A more extensive explanation on ETM may be found at “ATSC Standard A/65B: Program and System Information Protocol for Terrestrial Broadcast and Cable”, Rev. B, 18 Mar. 2003” (see World Wide Web at atsc.org).
ETT Extended Text Table (ETT) contains Extended Text Message (ETM) streams, which provide supplementary description of virtual channel and events when needed. A more extensive explanation of ETM may be found at “ATSC Standard A/65B: Program and System Information Protocol for Terrestrial Broadcast and Cable”, Rev. B, 18 Mar. 2003” (see World Wide Web at atsc.org).
FCC The Federal Communications Commission (FCC) is an independent United States government agency, directly responsible to Congress. The FCC was established by the Communications Act of 1934 and is charged with regulating interstate and international communications by radio, television, wire, satellite and cable. More information can be found at their website (see World Wide Web at fcc.gov/aboutus.html).
F/W Firmware (F/W) is a combination of hardware (H/W) and software (S/W), for example, a computer program embedded in state memory (such as a Programmable Read Only Memory (PROM)) which can be associated with an electrical controller device (such as a microcontroller or microprocessor) to operate (or “run) the program on an electrical device or system. A more extensive explanation may be found at “Embedded Systems Firmware Demystified” (CMP Books 2002) by Ed Sutter.
GPS Global Positioning Satellite (GPS) is a satellite system that provides three-dimensional position and time information. The GPS time is used extensively as a primary source of time. UTC (Universal Time Coordinates), NTP (Network Time Protocol) Program Clock Reference (PCR) and Modified Julian Date (MJD) are alternatives or adjuncts to GPS Time and is considered or adopted for providing time information.
GUI Graphical User Interface (GUI) is a graphical interface between an electronic device and the user using elements such as windows, buttons, scroll bars, images, movies, the mouse and so forth.
HD-DVD High Definition—Digital Video Disc (HD-DVD) is a high capacity CD-size storage media disc for video, multimedia, games, audio and other applications. A more complete explanation of HD-DVD may be found at DVD Forums (see World Wide Web at dvdforum.org/). CD (Compact Disc), minidisk, hard drive, magnetic tape, circuit-based (such as flash RAM) data storage medium are alternatives or adjuncts to HD-DVD for storage, either in analog or digital format.
HDTV High Definition Television (HDTV) is a digital television which provides superior digital picture quality (resolution). The 1080i (1920×1080 pixels interlaced), 1080p (1920×1080 pixels progressive) and 720p (1280×720 pixels progressive formats in a 16:9 aspect ratio are the commonly adopted acceptable HDTV formats. The “interlaced” or “progressive” refers to the scanning mode of HDTV which are explained in more detail in “ATSC Standard A/53C with Amendment No. 1: ATSC Digital Television Standard”, Rev. C, 21 May 2004 (see World Wide Web at atsc.org).
Huffman Coding Huffman coding is a data compression method which may be used alone or in combination with other transformations functions or encoding algorithms (such as DCT, Wavelet, and others) in digital imaging and video as well as in other areas. A more extensive explanation of Huffman coding may be found at “Introduction to Data Compression” (Morgan Kaufmann, Second Edition, February, 2000) by Khalid Sayood.
H/W Hardware (H/W) is the physical components of an electronic or other device. A more extensive explanation on H/W may be found at “The Hardware Cyclopedia” (Running Press Book, 2003) by Steve Ettlinger.
infomercial Infomercial includes audiovisual (or part) programs or segments presenting information and commercials such as new program teasers, public announcement, time-sensitive promotion sales, advertisements, and commercials.
IP Internet Protocol, defined by IETF RFC791, is the communication protocol underlying the internet to enable computers to communicate to each other. An explanation on IP may be found at IETF RFC 791 Internet Protocol Darpa Internet Program Protocol Specification. (see World Wide Web at ietf.org/rfc/rfc0791.txt)
ISO International Organization for Standardization (ISO) is a network of the national standards institutes in charge of coordinating standards. More information can be found at their website (see World Wide Web at iso.org).
ISDN Integrated Services Digital Network (ISDN) is a digital telephone scheme over standard telephone lines to support voice, video and data communications.
ITU-T International Telecommunication Union (ITU) Telecommunication Standardization Sector (ITU-T) is one of three sectors of the ITU for defining standards in the field of telecommunication. More information can be found at their website (see World Wide Web at itu.int/ITU-T).
JPEG JPEG (Joint Photographic Experts Group) is a standard for still image compression. A more extensive explanation of JPEG may be found at “ISO/IEC International Standard 10918-1” (see World Wide Web at jpeg.org/jpeg/). Various MPEQ Portable Network Graphics (PNG), Graphics Interchange Format (GIF), XBM (X Bitmap Format), Bitmap (BMP) are alternatives or adjuncts to JPEG and is considered or adopted for various image compression(s).
keyframe Key frame (key frame image) is a single, still image derived from a video program comprising a plurality of images. A more extensive information of keyframe may be found at “Efficient video indexing scheme for content-based retrieval” (Transactions on Circuit and System for Video Technology, April, 2002)” by Hyun Sung Chang, Sanghoon Sull, Sang Uk Lee.
LAN Local Area Network (LAN) is a data communication network spanning a relatively small area. Most LANs are confined to a single building or group of buildings. However, one LAN can be connected to other LANs over any distance, for example, via telephone lines and radio wave and the like to form Wide Area Network (WAN). More information can be found by at “Ethernet: The Definitive Guide” (O'Reilly& Associates) by Charles E. Spurgeon.
MHz (Mhz) A measure of signal frequency expressing millions of cycles per second.
MGT Master Guide Table (MGT) provides information about the tables that comprise the PSIP. For example, MGT provides the version number to identify tables that need to be updated, the table size for memory allocation and packet identifiers to identify the tables in the Transport Stream. A more extensive explanation of MGT may be found at “ATSC Standard A/65B: Program and System Information Protocol for Terrestrial Broadcast and Cable”, Rev. B, 18 Mar. 2003 (see World Wide Web at atsc.org).
MHP Multimedia Home Platform (MHP) is a standard interface between interactive digital applications and the terminals. A more extensive explanation of MHP may be found at “ETSI TS 102 812: DVB Multimedia Home Platform (MHP) Specification” (see World Wide Web at etsi.org). Open Cable Application Platform (OCAP), Advanced Common Application Platform (ACAP), Digital Audio Visual Council (DAVIC) and Home Audio Video Interoperability (HAVi) are alternatives or adjuncts to MHP and are considered or adopted as interface options for various digital applications.
MJD Modified Julian Date (MJD) is a day numbering system derived from the Julian calendar date. It was introduced to set the beginning of days at 0 hours, instead of 12 hours and to reduce the number of digits in day numbering. UTC (Universal Time Coordinates), GPS (Global Positioning Systems) time, Network Time Protocol (NTP) and Program Clock Reference (PCR) are alternatives or adjuncts to PCR and are considered or adopted for providing time information.
MPEG The Moving Picture Experts Group is a standards organization dedicated primarily to digital motion picture encoding in Compact Disc. For more information, see their web site at (see World Wide Web at mpeg.org).
MPEG-2 Moving Picture Experts Group—Standard 2 (MPEG-2) is a digital video compression standard designed for coding interlaced/noninterlaced frames. MPEG-2 is currently used for DTV broadcast and DVD. A more extensive explanation of MPEG-2 may be found on the World Wide Web at mpeg.org and “Digital Video: An Introduction to MPEG-2 (Digital Multimedia Standards Series)” (Springer, 1996) by Barry G. Haskell, Atul Puri, Arun N. Netravali.
MPEG-4 Moving Picture Experts Group—Standard 4 (MPEG-4) is a video compression standard supporting interactivity by allowing authors to create and define the media objects in a multimedia presentation, how these can be synchronized and related to each other in transmission, and how users are to be able to interact with the media objects. A more extensive information of MPEG-4 can be found at “H.264 and MPEG-4 Video Compression” (John Wiley & Sons, August, 2003) by lain E. G. Richardson and “The MPEG-4 Book” (Prentice Hall PTR, July, 2002) by Touradj Ebrahimi, Fernando Pereira.
MPEG-7 Moving Picture Experts Group—Standard 7 (MPEG-7), formally named “Multimedia Content Description Interface” (MCDI) is a standard for describing the multimedia content data. More extensive information about MPEG-7 can be found at the MPEG home page (http://mpeg.tilab.com), the MPEG-7 Consortium website (see World Wide Web at mp7c.org), and the MPEG-7 Alliance website (see World Wide Web at mpeg-industry.com) as well as_“Introduction to MPEG 7: Multimedia Content Description Language” (John Wiley & Sons, June, 2002) by B. S. Manjunath, Philippe Salembier, and Thomas Sikora, and “ISO/IEC 15938-5:2003 Information technology—Multimedia content description interface—Part 5: Multimedia description schemes” (see World Wide Web at iso.ch).
NPT Normal Playtime (NPT) is a time code embedded in a special descriptor in a MPEG-2 private section, to provide a known time reference for a piece of media. A more extensive explanation of NPT may be found at “ISO/IEC 13818-6, Information Technology—Generic Coding of Moving Pictures and Associated Audio Information—Part 6: Extensions for DSM-CC” (see World Wide Web at iso.org).
NTP Network Time Protocol (NTP) is a protocol that provides a reliable way of transmitting and receiving the time over the Transmission Control Protocol/Internet Protocol (TCP/IP) networks. A more extensive explanation of NTP may be found at “RFC (Request for Comments) 1305 Network Time Protocol (Version 3) Specification” (see World Wide Web at faqs.org/rfcs/rfc1305.html). UTC (Universal Time Coordinates), GPS (Global Positioning Systems) time, Program Clock Reference (PCR) and Modified Julian Date (MJD) are alternatives or adjuncts to NTP and are considered or adopted for providing time information.
NTSC The National Television System Committee (NTSC) is responsible for setting television and video standards in the United States (in Europe and the rest of the world, the dominant television standards are PAL and SECAM). More information is available by viewing the tutorials on the World Wide Web at ntsc-tv.com.
OpenCable The OpenCable managed by CableLabs, is a research and development consortium to provide interactive services over cable. More information is available by viewing their website on the World Wide Web at opencable.com.
PC Personal Computer (PC).
PCR Program Clock Reference (PCR) in the Transport Stream (TS) indicates the sampled value of the system time clock that can be used for the correct presentation and decoding time of audio and video. A more extensive explanation of PCR may be found at “Generic Coding of Moving Pictures and Associated Audio Information—Part 1: Systems,” ISO/IEC 13818-1 (MPEG-2), 1994 (http://iso.org). SCR (System Clock Reference) is an alternative or adjunct to PCR used in MPEG program streams.
PES Packetized Elementary Stream (PES) is a stream composed of a PES packet header followed by the bytes from an Elementary Stream (ES). A more extensive explanation of PES may be found at “Generic Coding of Moving Pictures and Associated Audio Information—Part 1: Systems,” ISO/IEC 13818-1 (MPEG-2), 1994 (http://iso.org).
PID A Packet Identifier (PID) is a unique integer value used to identify Elementary Streams (ES) of a program or ancillary data in a single or multi-program Transport Stream (TS). A more extensive explanation of PID may be found at “Generic Coding of Moving Pictures and Associated Audio Information—Part 1: Systems,” ISO/IEC 13818-1 (MPEG-2), 1994 (http://iso.org).
PS Program Stream (PS), specified by the MPEG-2 System Layer, is used in relatively error-free environment such as DVD media. A more extensive explanation of PS may be found at “Generic Coding of Moving Pictures and Associated Audio Information—Part 1: Systems,” ISO/IEC 13818-1 (MPEG-2), 1994 (http://iso.org).
PSI Program Specific Information (PSI) is the MPEG-2 data that enables the identification and de-multiplexing of transport stream packets belonging to a particular program. A more extensive explanation of PSI may be found at “Generic Coding of Moving Pictures and Associated Audio Information—Part 1: Systems,” ISO/IEC 13818-1 (MPEG-2), 1994 (http://iso.org).
PSIP Program and System Information Protocol (PSIP) for ATSC data tables for delivering EPG information to consumer devices such as DVRs in countries using ATSC (such as the U.S. and Korea) for digital broadcasting. Digital Video Broadcasting System Information (DVB-SI) is an alternative or adjunct to ATSC-PSIP and is considered or adopted for Digital Video Broadcasting (DVB) used in Europe. A more extensive explanation of PSIP may be found at “ATSC Standard A/65B: Program and System Information Protocol for Terrestrial Broadcast and Cable,” Rev. B, 18 Mar. 2003 (see World Wide Web at atsc.org).
PSTN Public Switched Telephone Network (PSTN) is the world's collection of interconnected voice-oriented public telephone networks.
PTS Presentation Time Stamp (PTS) is a time stamp that indicates the presentation time of audio and/or video. A more extensive explanation of PTS may be found at “Generic Coding of Moving Pictures and Associated Audio Information—Part 1: Systems,” ISO/IEC 13818-1 (MPEG-2), 1994 (http://iso.org).
PVR Personal Video Recorder (PVR) is a term that is commonly used interchangeably with DVR.
ReplayTV ReplayTV is a company leading DVR industry in maximizing users TV viewing experience. An explanation on ReplayTV may be found at http://digitalnetworksna.com, http://replaytv.com.
RF Radio Frequency (RF) refers to any frequency within the electromagnetic spectrum associated with radio wave propagation.
RRT A Rate Region Table (RRT) is a table providing program rating information in an ATSC standard. A more extensive explanation of RRT may be found at “ATSC Standard A/65B: Program and System Information Protocol for Terrestrial Broadcast and Cable,” Rev. B, 18 Mar. 2003 (see World Wide Web at atsc.org).
SCR System Clock Reference (SCR) in the Program Stream (PS) indicates the sampled value of the system time clock that can be used for the correct presentation and decoding time of audio and video. A more extensive explanation of SCR may be found at “Generic Coding of Moving Pictures and Associated Audio Information—Part 1: Systems,” ISO/IEC 13818-1 (MPEG-2), 1994 (http://iso.org). PCR (Program Clock Reference) is an alternative or adjunct to SCR.
SDTV Standard Definition Television (SDTV) is one mode of operation of digital television that does not achieve the video quality of HDTV, but are at least equal, or superior to, NTSC pictures. SDTV may usually have either 4:3 or 16:9 aspect ratios, and usually includes surround sound. Variations of frames per second (fps), lines of resolution and other factors of 480p and 480i make up the 12 SDTV formats in the ATSC standard. The 480p and 480i each represent 480 progressive and 480 interlaced format explained in more detail in ATSC Standard A/53C with Amendment No. 1: ATSC Digital Television Standard, Rev. C 21 May 2004 (see World Wide Web at atsc.org).
SGML Standard Generalized Markup Language (SGML) is an international standard for the definition of device and system independent methods of representing texts in electronic form. A more extensive explanation of SGML may be found at “Learning and Using SGML” (see World Wide Web at w3.org/MarkUp/SGML/), and at “Beginning XML” (Wrox, December, 2001) by David Hunter.
SI System Information (SI) for DVB (DVB-SI) provides EPG information data in DVB compliant digital TVs. A more extensive explanation of DVB-SI may be found at “ETSI EN 300 468 Digital Video Broadcasting (DVB); Specification for Service Information (SI) in DVB Systems”, (see World Wide Web at etsi.org). ATSC-PSIP is an alternative or adjunct to DVB-SI and is considered or adopted for providing service information to countries using ATSC such as the U.S. and Korea.
STB Set-top Box (STB) is a display, memory, or interface devices intended to receive, store, process, repeat, edit, modify, display, reproduce or perform any portion of a program, including personal computer (PC) and mobile device.
STT System Time Table (STT) is a small table defined to provides the time and date information in ATSC. Digital Video Broadcasting (DVB) has a similar table called a Time and Date Table (TDT). A more extensive explanation of STT may be found at “ATSC Standard A/65B: Program and System Information Protocol for Terrestrial Broadcast and Cable”, Rev. B, 18 Mar. 2003 (see World Wide Web at atsc.org).
S/W Software is a computer program or set of instructions which enable electronic devices to operate or carry out certain activities. A more extensive explanation of S/W may be found at “Concepts of Programming Languages” (Addison Wesley) by Robert W. Sebesta.
TCP Transmission Control Protocol (TCP) is defined by the Internet Engineering Task Force (IETF) Request for Comments (RFC) 793 to provide a reliable stream delivery and virtual connection service to applications. A more extensive explanation of TCP may be found at “Transmission Control Protocol Darpa Internet Program Protocol Specification” (see World Wide Web at ietf.org/rfc/rfc0793.txt).
TDT Time Date Table (TDT) is a table that gives information relating to the present time and date in Digital Video Broadcasting (DVB). STT is an alternative or adjunct to TDT for providing time and date information in ATSC. A more extensive explanation of TDT may be found at “ETSI EN 300 468 Digital Video Broadcasting (DVB); Specification for Service Information (SI) in DVB systems” (see World Wide Web at etsi.org).
TiVo TiVo is a company providing digital content via broadcast to a consumer DVR it pioneered. More information on TiVo may be found at http://tivo.com.
TOC Table of contents herein refers to any listing of characteristics, locations, or references to parts and subparts of a unitary presentation (such as a book, video, audio, AV or other references or entertainment program or content) preferably for rapidly locating and accessing the particular part(s) or subpart(s) or segment(s) desired.
TS Transport Stream (TS), specified by the MPEG-2 System layer, is used in environments where errors are likely, for example, broadcasting network. TS packets into which PES packets are further packetized are 188 bytes in length. An explanation of TS may be found at “Generic Coding of Moving Pictures and Associated Audio Information—Part 1: Systems,” ISO/IEC 13818-1 (MPEG-2), 1994 (http://iso.org).
TV Television, generally a picture and audio presentation or output device; common types include cathode ray tube (CRT), plasma, liquid crystal and other projection and direct view systems, usually with associated speakers.
TV-Anytime TV-Anytime is a series of open specifications or standards to enable audio-visual and other data service developed by the TV-Anytime Forum. A more extensive explanation of TV-Anytime may be found at the home page of the TV-Anytime Forum (see World Wide Web at tv-anytime.org).
TVPG Television Parental Guidelines (TVPG) are guidelines that give parents more information about the content and age-appropriateness of TV programs. A more extensive explanation of TVPG may be found on the World Wide Web at tvguidelines.org/default.asp.
uimsbf unsigned integer, most significant-bit first. The unsigned integer is made up of one or more 1s and 0s in the order of most significant-bit first (the left-most-bit is the most significant bit). A more extensive explanation of uimsbf may be found at may be found at “Generic Coding of Moving Pictures and Associated Audio Information—Part 1: Systems,” ISO/IEC 13818-1 (MPEG-2), 1994 (http://iso.org).
UTC Universal Time Coordinated (UTC), the same as Greenwich Mean Time, is the official measure of time used in the world's different time zones.
VCR Video Cassette Recorder (VCR). DVR is alternatives or adjuncts to VCR.
VCT Virtual Channel Table (VCT) is a table which provides information needed for the navigating and tuning of a virtual channels in ATSC and DVB. A more extensive explanation of VCT may be found at “ATSC Standard A/65B: Program and System Information Protocol for Terrestrial Broadcast and Cable,” Rev. B, 18 Mar. 2003 (see World Wide Web at atsc.org).
VOD Video On Demand (VOD) is a service that enables television viewers to select a video program and have it sent to them over a channel via a network such as a cable or satellite TV network.

VR The Visual Rhythm (VR) of a video is a single image or frame, that is, a two-dimensional abstraction of the entire three-dimensional content of a video segment constructed by sampling certain groups of pixels of each image sequence and temporally accumulating the samples along time. A more extensive explanation of Visual Rhythm may be found at “An Efficient Graphical Shot Verifier Incorporating Visual Rhythm”, by H. Kim, J. Lee and S. M. Song, Proceedings of IEEE International Conference on Multimedia Computing and Systems, pp. 827-834, June, 1999.

VSB Vestigial Side Band (VSB) is a method for modulating a signal. A more extensive explanation on VSB may be found at “Digital Television, DVB-T COFDM and ATSC 8-VSB” (Digitaltvbooks.com, October 2000) by Mark Massel.

WANA Wide Area Network (WAN) is a network that spans a wider area than does a Local Area Network (LAN). More information can be found by at “Ethernet: The Definitive Guide” (O'Reilly& Associates) by Charles E. Spurgeon.
W3C The World Wide Web Consortium (W3C) is an organization developing various technologies to enhance the Web experience. More information on W3C may be found at see World Wide Web at w3c.org.
XML eXtensible Markup Language (XML) defined by W3C (World Wide Web Consortium), is a simple, flexible text format derived from SGML. A more extensive explanation of XML may be found at “XML in a Nutshell” (O'Reilly, 2004) by Elliotte Rusty Harold, W. Scott Means.
XML Schema A schema language defined by W3C to provide means for defining the structure, content and semantics of XML documents. A more extensive explanation of XML Schema may be found at “Definitive XML Schema” (Prentice Hall, 2001) by Priscilla Walmsley.
Zlib Zlib is a free, general-purpose lossless data-compression library for use independent of the hardware and software. More information can be obtained on the World Wide Web at gzip.org/zlib.

### BRIEF DESCRIPTION (SUMMARY)

Generally, techniques (method, apparatus, system) are provided for efficiently delivering segmentation information of broadcast or other delivered programs to DVRs and the like associated with a conventional type program guide (for example, ATSC-PSIP or DVB-SI EPGs) for efficient random accessing to segments of a program which may be recorded in DVRs using the delivered segmentation information. The segmentation information may include segment titles, temporal start positions and durations of the segments of broadcast programs.

Generally, two exemplary techniques are provided for specifying the segmentation information for existing program guides such as EPGs. In a first exemplary technique, the segmentation information is inserted into the extended text message (ETM) within an extended text table (ETT) for use with PSIP and the short/extended event descriptors or program for use with SI. In a second exemplary technique, the segmentation information of an event is inserted into PSIP and SI tables, such as an event information table (EIT), by using a new metadata structure (descriptor).

The segmentation information can be delivered for transmitting to TV viewer's STBs in various ways.

Generally, a first technique is provided for transmitting the segmentation information incrementally through the program guide, especially when the segmentation information for a program is indexed in real-time. The segmentation information for a segment is inserted into the program guide as soon as a meaningful occurrence or event occurs. Furthermore, the segmentation information for a segment or a group of segments may also be inserted into the program guide periodically.

Generally, a second technique is provided for transmitting segmentation information just after a program has finished via a conventional program guide. In such a case, the program guide should be able to provide not only the information about current and near future programs but also about those programs that have already been broadcast. The existing program guides are extended to provide additional functionality.

This will allow STB users to browse recorded programs based on the segmentation information delivered to STBs in a manner similar to DVD chapter selection.

Generally, a technique is provided for parsing the segmentation, or the like information provided by ETM strings in ETT or segmentation information descriptors in EIT for a viewer's DVR.

Generally, a technique is provided for displaying the segmentation information based on the received segmentation information either through the ETM strings in ETT or the segmentation information descriptors in EIT, or the like.

Generally, a technique is provided for fast accessing and displaying segments of a program through a forward and backward key in a remote control.

Generally, a technique is provided for processing and presenting infomercials.

Generally, a technique is provided for scrambling the segmentation information.

Generally, a technique is provided for specifying triggering information for recording at least portions of specific broadcast programs into existing program guides in order to automatically record at least portions of one or more programs in a targeted (audiences' or viewer's) DVR.

Generally, a technique is provided for delivering and displaying frame associated information in broadcast programs.

According to the techniques of the disclosure, a method of presenting content-relevant information associated with one or more frames in an AV program comprises enabling retrieving information on content associated with the one or more frames. The information may comprise names of actors or actresses who appear in a scene of a movie, or the names of players for sports game while watching.

According to the techniques of the disclosure, a method of receiving content-relevant information associated with an AV program comprises receiving an AV program and receiving content-relevant information separate from the AV program. The content-relevant information may be retrieved from a database in a server.

Other objects, features and advantages of the techniques disclosed herein will become apparent from the ensuing descriptions thereof.

### BRIEF DESCRIPTION OF THE DRAWINGS (FIGS)

Reference will be made in detail to embodiments of the techniques disclosed herein, examples of which are illustrated in the accompanying drawings (figures). The drawings are intended to be illustrative, not limiting, and it should be understood that it is not intended to limit the techniques to the illustrated embodiments.

FIG. 1 is a diagram of exemplary media localization.

FIG. 2 is a diagram illustrating an exemplary hierarchical tree structure of segments that belong to a single video program.

FIG. 3 is a table illustrating an example of Categorical Genre Code Assignments utilized for a Directed Channel Change Table (DCCT) in PSIP, according to the prior art.

FIGS. 4A and 4B illustrate exemplary segmentation information metadata generated based on the disclosed BNF syntax specified in Table 2.

FIG. 5A is an illustration of exemplary graphic user interface (GUI) showing a brief program synopsis in an ETT, according to the prior art.

FIG. 5B is an illustration of exemplary GUI showing how the segmentation information inserted into an ETT and short/extended descriptors may look on a conventional STB without appropriate parsing software.

FIGS. 6A and 6B are illustrations of a simplified version of generated segmentation information based on the-bit stream syntax of an event segment descriptor.

FIGS. 6C and 6D are diagrams of examples of the command mode operation for a segment.

FIG. 7 is a diagram of how incremental data is multiplexed into transport streams.

FIG. 8 is an illustration of a program guide showing segmentation information for a recorded program in a DVR.

FIG. 9 is an illustration of a program guide showing an exemplary storyboard for a recorded program in a DVR.

FIG. 10 is a flow chart describing how segmentation information metadata may be processed at a DVR when the metadata is delivered through an EPG.

FIGS. 11 and 12 are illustrations of graphic user interfaces (GUI) for an infomercial guide.

FIGS. 13 and 14 are illustrations of the overall process of for processing infomercials in the DVR.

FIG. 15 is a diagram of an exemplary delivery interval time of an event segment descriptor, to reduce the skipping of advertisements by only sending the infomercial segmentation information occasionally at appropriate times.

FIG. 16 is a flow chart describing how automatic recording for a program is triggered.

FIGS. 17A, 17B, 17C and 17D are the exemplary service schemes for providing the information relevant to frame(s) of (broadcast) AV streams.

FIGS. 18A, 18B, 18C and 18D are block diagrams of exemplary client STBs or DVRs for processing the information relevant to frame(s) of broadcast programs.

FIGS. 19A, 19B, 19C and 19D are exemplary GUIs for TV viewers.

### DETAILED DESCRIPTION

This disclosure relates to the processing of program guide information (usually EPG information in digital broadcasting) and, more particularly, to techniques for delivering information on video segments of broadcast TV programs to STBs having associated data storage through conventional program guide specifications such as the Program and System Information Protocol (PSIP) and Service Information (SI) that are currently defined in various DTV broadcasting standards.

A variety of devices may be used to process and display delivered content(s), such as, for example, a STB which may be connected inside or associated with user's TV set. Typically, today's STB capabilities include receiving analog and/or digital signals from broadcasters who may provide programs in any number of channels, decoding the received signals and displaying the decoded signals.

1. Media Localization

To represent or locate a position in a broadcast program (or stream) that is uniquely accessible by both indexing systems and client DVRs is critical in a variety of applications including video browsing, commercial replacement, and information service relevant to specific frame(s). To overcome the existing problem in localizing broadcast programs, a solution is disclosed in the above-referenced U.S. patent application Ser. No. 10/369,333 filed Feb. 19, 2003, using broadcasting time as a media locator for broadcast stream, which is a simple and intuitive way of representing a time line within a broadcast stream as compared with the methods that require the complexity of implementation of DSM-CC NPT in DVB-MHP and the non-uniqueness problem of the single use of PTS. Broadcasting time is the current time a program is being aired for broadcast. Techniques are disclosed herein to use, as a media locator for broadcast stream or program, information on time or position markers multiplexed and broadcast in MPEG-2 TS or other proprietary or equivalent transport packet structure by terrestrial DTV broadcast stations, satellite/cable DTV service providers, and DMB service providers. For example, techniques are disclosed to utilize the information on time-of-day carried in the broadcast stream in the system_time field in STT of ATSC/OpenCable (usually broadcast once every second) or in the UTC_time field in TDT of DVB (could be broadcast once every 30 seconds), respectively. For Digital Audio Broadcasting (DAB), DMB or other equivalents, the similar information on time-of-day broadcast in their TSs can be utilized. In this disclosure, such information on time-of-day carried in the broadcast stream (for example, the system_time field in STT or other equivalents described above) is collectively called “system time marker”.

An exemplary technique for localizing a specific position or frame in a broadcast stream is to use a system_time field in STT (or UTC_time field in TDT or other equivalents) that is periodically broadcast. More specifically, the position of a frame can be described and thus localized by using the closest (alternatively, the closest, but preceding the temporal position of the frame) system_time in STT from the time instant when the frame is to be presented or displayed according to its corresponding PTS in a video stream. Alternatively, the position of a frame can be localized by using the system_time in STT that is nearest from the bit stream position where the encoded data for the frame starts. It is noted that the single use of this system_time field usually do not allow the frame accurate access to a stream since the delivery interval of the STT is within 1 second and the system_time field carried in this STT is accurate within one second. Thus, a stream can be accessed only within one-second accuracy, which could be satisfactory in many practical applications. Note that although the position of a frame localized by using the system_time field in STT is accurate within one second, an arbitrary time before the localized frame position may be played to ensure that a specific frame is displayed. It is also noted that the information on broadcast STT or other equivalents should also be stored with the AV stream itself in order to utilize it later for localization.

Another method is disclosed to achieve (near) frame-accurate access or localization to a specific position or frame in a broadcast stream. A specific position or frame to be displayed is localized by using both system_time in STT (or UTC_time in TDT or other equivalents) as a time marker and relative time with respect to the time marker. More specifically, the localization to a specific position is achieved by using system_time in STT that is a preferably first-occurring and nearest one preceding the specific position or frame to be localized, as a time marker. Additionally, since the time marker used alone herein does not usually provide frame accuracy, the relative time of the specific position with respect to the time marker is also computed in the resolution of preferably at least or about 30 Hz by using a clock, such as PCR, STB's internal system clock if available with such accuracy, or other equivalents. It is also noted that the information on broadcast STT or other equivalents should also be stored with the AV stream itself in order to utilize it later for localization.

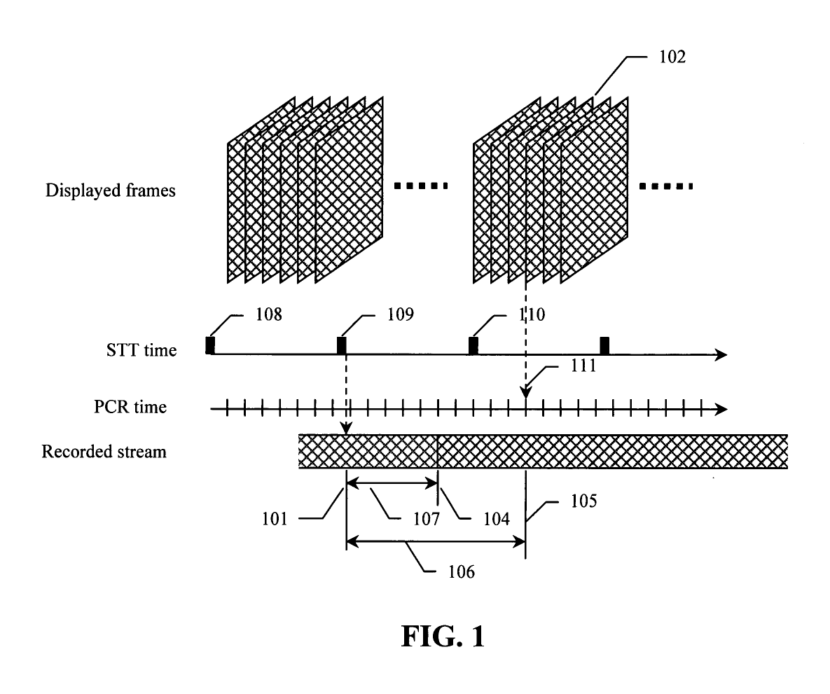

FIG. 1 illustrates how to localize the frame 102 using system_time in STT and relative time. The positions 108, 109 and 110 correspond to the broadcast STTs, respectively. Assume that the STT is broadcast once every 0.7 seconds. Then, the STTs at 109 and 110 could have the same values of system_time due to round-off whereas the STT in 108 has a distinct system_time. The system_time or time marker for 102 is the STT at 109 obtained by finding the first-occurring and nearest STT preceding 102. The relative time is calculated from the position of the TS packet carrying the last byte of STT containing system_time 109 in resolution of at least or about 30 Hz. The relative time 106 for the position 102 could be calculated by the difference of PCR values between 105 and 101 in resolution of 90 kHz. Alternatively, the localization to a specific position may be achieved by interpolating or extrapolating the values of system_time in STT (or UTC_time in TDT or other equivalents) in the resolution of preferably at least or about 30 Hz by using a clock, such as PCR, STB's internal system clock if available with such accuracy, or other equivalents.

Another method is disclosed to achieve (near) frame-accurate access or localization to a specific position or frame in a broadcast stream. The localization information on a specific position or frame to be displayed is obtained by using both system_time in STT (or UTC_time in TDT or other equivalents) as a time marker and relative byte offset with respect to the time marker. More specifically, the localization to a specific position is achieved by using system_time in STT that is a preferably first-occurring and nearest one preceding the specific position or frame to be localized, as a time marker. Additionally, the relative byte offset with respect to the time marker maybe obtained by calculating the relative byte offset from the first packet carrying the last byte of STT containing the corresponding value of system_time. It is also noted that the information on broadcast STT or other equivalents should also be stored with the AV stream itself in order to utilize it later for localization. FIG. 1 also illustrates how to localize the frame 102 using system_time in STT and relative byte offset. Assume also that the STT is broadcast once every 0.7 seconds. Then, the STTs at 109 and 110 could have the same values of system_time due to round-off whereas the STT in 108 has a distinct system_time. The system_time or time marker for 102 is the STT at 109 obtained by finding the first-occurring and nearest STT preceding 102. The position 104 is the byte position of the recorded bit stream where the encoded frame data starts. The position 101 is the byte position of the recorded bit stream corresponding to the position of the TS packet carrying the last byte of STT containing system_time 109. The relative byte offset 107 is obtained by subtracting the byte position 104 from 104.

Another method for frame-accurate localization is to use both system_time field in STT (or UTC_time field in TDT or other equivalents) and PCR. The localization information on a specific position or frame to be displayed is achieved by using system_time in STT and the PTS for the position or frame to be described. Since the value of PCR usually increases linearly with a resolution of 27 MHz, it can be used for frame accurate access. However, since the PCR wraps back to zero when the maximum bit count is achieved, we should also utilize the system_time in STT that is a preferably nearest one preceding the PTS of the frame, as a time marker to uniquely identify the frame. FIG. 1 illustrates the corresponding values of system_time 110 and PCR 111 to localize the frame 102. It is also noted that the information on broadcast STT or other equivalents should also be stored with the AV stream itself in order to utilize it later for localization.

2. Insertion of Segmentation Information into Program Guides

TV and other video viewers are often currently provided with some information on programs, such as title and start and end times that are currently being broadcast or will be broadcast, for example, through an EPG. In current digital broadcasting systems, an EPG is provided by conventional program guide schemes such as PSIP and SI that are currently defined in various DTV broadcasting standards such as ATSC and DVB, respectively. Such standards on service information are also used by various digital cable and satellite committees. At this time, the EPG contains information only on the programs (events) that are currently being broadcast and near-term future events (programs) that will be available a limited amount of time in the future. However, a user might wish to know about a program that has been already broadcast in more detail. Such demands have arisen due to the capability of DVRs enabling recording of broadcast programs for later play-back.

Techniques are herein provided to deliver segmentation information through program guides such as PSIP and SI currently being provided under DTV broadcasting standards such as ATSC and DVB, respectively. Examples of delivering segmentation information related to a program by using PSIP and SI will be described. However, before presenting such techniques, the segmentation information is described in more detail.

Segmentation refers to the ability to define and access temporal intervals (i.e. segments) within a video program or the like. A segment is a set of continuous frames or subsets within a video or program or content. A segment can be divided into multiple sub-segments, and a sub-segment can be further divided into multiple sub-sub-segments, and so forth. If a particular sub-segment is restricted to belong to a single segment, the inclusion relationships between segments and sub-segments can be represented as a tree structure. In the tree, all sub-segments of a particular segment (all sibling nodes having the same parent node) are chronologically ordered. That is, for any pair of two sub-segments belonging to the same segment, one sub-segment that temporally precedes the other one is located before the other one, for example, graphically depicted left of the other one. Segmentation information of a program is information on segments, sub-segments and their inclusion relationships. Segmentation information of a program usually describes at least a title, start position and duration of each segment or sub-segment. By using the segmentation information, it is possible to browse and navigate the tree structure to easily access a particular segment or sub-segment.

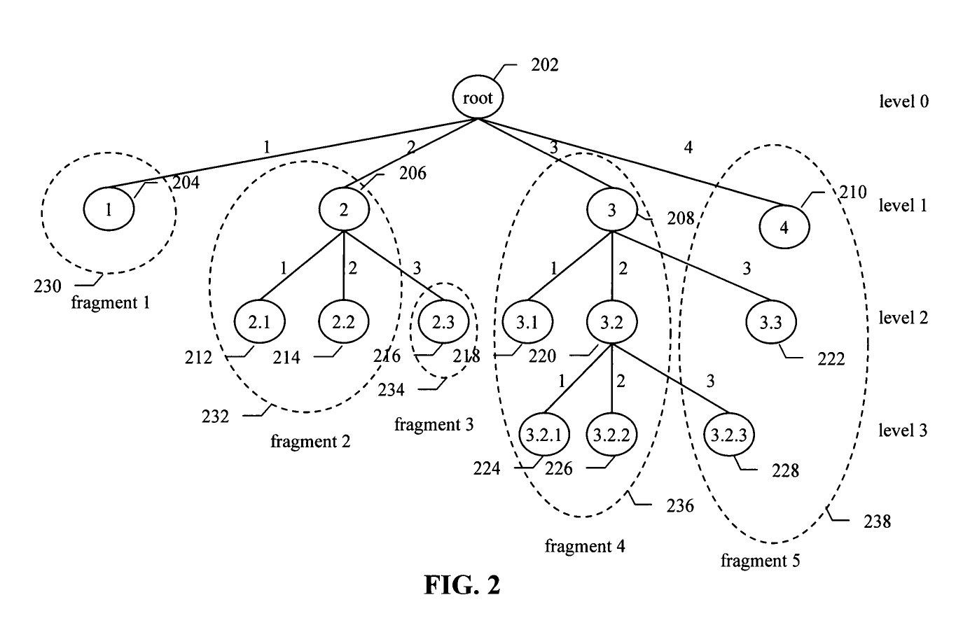

FIG. 2 illustrates an exemplary hierarchical tree structure of segments that belong to a single video program. A tree is a collection of nodes with a distinguished node called the root 202 when the tree is not empty. Each node has none or more children, and a unique parent node (except the root node). For example, the children of node 206 are nodes 212, 214, 216 and the parent node of node 206 is root node 202. The depth (level) of a node is defined as the length of the unique path from the root to the designated node. For example, the level of root node 202 is 0, the level of the node 204 is 1, and the level of the node 212 is 2. Root node 202 is a segment representing the entire program. The segment represented by root node 202 consists of four sub-segments represented by the nodes 204, 206, 208 and 210, respectively. The four nodes are chronologically ordered, depicted graphically from left to right. Thus, the sub-segment 204 precedes 206, and the sub-segment 206 precedes 208, and finally and the sub-segment 208 precedes 210. The segment 206 is further divided into three sub-segments 212, 214, 216, and the segment 208 into three sub-segments 218, 220, 222, and the sub-segment 220 into the sub-sub-segments 224, 226, 228. For ease of consideration, sub-sub-segments and their sub-segments will all be generally referred to as “sub-segments”.

Since the tree structure of segments is an ordered tree, it is possible to assign a sequence number to each child node having the same parent node so that the sequence number of the left-most child node equals to 1, and the sequence numbers of the following child nodes should be incremented as by 1 according to their chronological order. Thus, for the sibling nodes having the same parent, each node has a lower sequence number than any sibling nodes it precedes. For example, for the four sibling nodes having the root node 202 as their parent, the left-most node 204 has 1 as a sequence number, and the other three nodes 206, 208, and 210 have 2, 3, and 4 as their sequence numbers, respectively. Also, for the three sibling nodes having the third child node 208 of the root node 202 as their parent, the three nodes 218, 220, 222 have 1, 2, and 3 as their sequence numbers, respectively. Note that the root node 202 should not have any sequence number because it has no parent node. Except for the root node 202, the position or chronological order of a node located in a hierarchical tree can be uniquely identified by a hierarchical sequence number obtained from the sequence number of each node. The hierarchical sequence number of a given node is obtained by concatenating all sequence numbers of the nodes located along a path from the root node 202 to the given node with a “.” (dot).

The hierarchical sequence number of each node is shown within each node in FIG. 2. For example, the third sub-segment 208 of the root node 202 has 3 as a hierarchical sequence number, and the second sub-segment 220 of the segment 208 has 3.2 as a hierarchical sequence number. Also, the third sub-segment 228 of the segment 220 whose hierarchical sequence number is 3.2 has 3.2.3 as a hierarchical sequence number. Note that the root node 202 has no hierarchical sequence number. For any two segments located in the same tree, if their hierarchical sequence numbers are given, their chronological orders and inclusion relationship can be determined by comparing two hierarchical sequences obtained by concatenating all the sequence numbers of the nodes located along a path from the root node to a given node. A fragment is one or a set of segments. The segmentation information of a program is transmitted in the unit of fragments, where a fragment is defined as one or a set of segments. In FIG. 2, the segments are partitioned into 5 fragments 230, 232, 234, 236, 238.

It would be advantageous, and is described herein below, to provide users with the segmentation information for an event (program) such that the recorded program can be easily (such as a random access) accessed or browsed at various reference locations or frames.

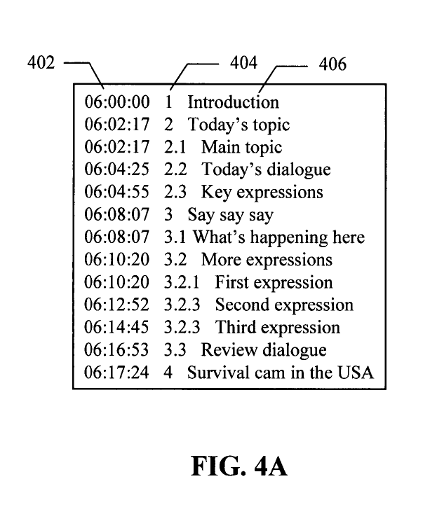

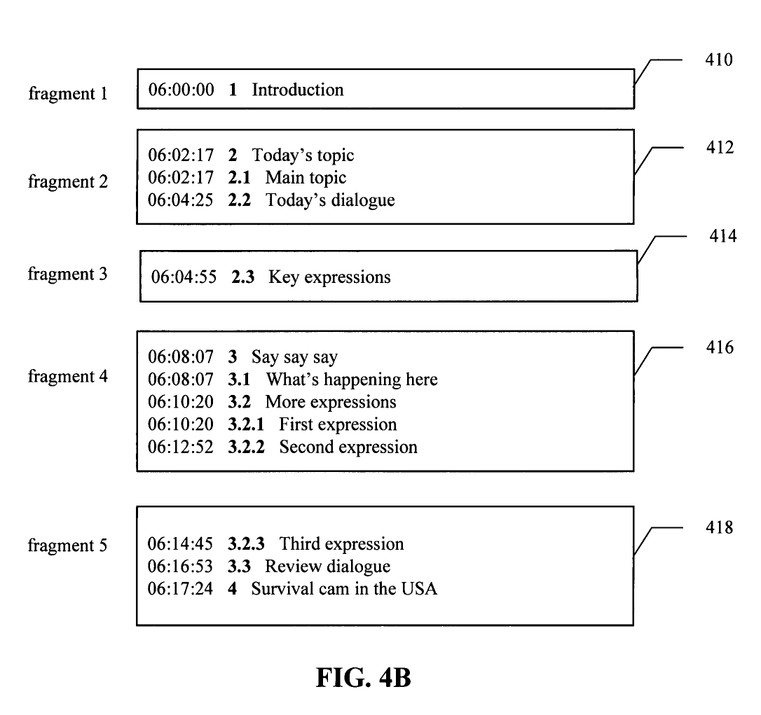

One way to describe segmentation information is by utilizing international standards on metadata specification(s), such as MPEG-7 or TV-Anytime or others, and multiplexing the metadata for segmentation information in the digital broadcast TS. The segmentation metadata can be provided with the AV content or generated by a video indexer or others, preferably before, during, or after the broadcast or recording, and could be re-provided or updated previously or later. It would be desirable that the segmentation metadata include a reference to the program the segment belongs to, a description of the content of the segment, and location of the segment (start time and duration). As well as being able to identify whole programs, segmentation metadata allows segments within an AV stream to be identified by their start and end time(s). Table 1 shows the exemplary sizes of the segmentation information specified by MPEG-7 and TV-Anytime, respectively, in order to describe the table of contents shown in FIG. 4A for an educational program called “Survival English” currently being broadcast in Korea.

TABLE 1
Data size of segmentation information
according to various metadata formats

| Metadata Format | Size |
|---|---|
| MPEG-7 | 26,216 bytes |
| TV-Anytime | 40,820 bytes |

In order to overcome the bandwidth problem, MPEG-7 provides an efficient binary encoding format for XML document called BiM, and TV-Anytime provides an advanced compression/encoding mechanism that converts an XML instance of TV-Anytime metadata into equivalent binary format. However, despite the use of the three compression techniques in TV-Anytime as previously described in the BACKGROUND section of this disclosure, the size of a compressed metadata file or packet is hardly smaller than that of an original textual data file or packet including segmentation information.

Therefore, new techniques are presented to provide segmentation information by extending the conventional program guide schemes such as ATSC-PSIP or DVB-SI. The technique provides segmentation information smaller in size than that based on MPEG-7 and TV-Anytime, and requires only minor modification of current digital broadcasting system software. Once the current program guide protocols such as PSIP and SI are extended to include such segmentation information, users can not only scroll through the program guide for a display of available programs to watch or record but also scroll through the segmentation information for a specific program recorded in a user's DVR. The segmentation information can also be used to access commercials or other smaller and sub-files of interest stored in the DVR.

Alternatively, or in combination, the segmentation information can be transported, such as in one of the following three ways: i) through the DSM-CC sections carried by MPEG-2 PES packets, ii) by defining a new PID in MPEG-2 TS, or iii) by using a data broadcasting channel such as DVB-MHP (multimedia home platform), or OpenCable-OCAP (OpenCable Applications Platform) or ATSC-ACAP (Advanced Common Application Platform), or other suitable system.

Existing program guides such as PSIP and SI specifications, promulgated by the ATSC and DVB, respectively, only provide simple textual descriptions of events (broadcast programs) themselves and do not provide a way for describing the segmentation information of an event such that a segment of an event can be directly accessed when recorded. Furthermore, the existing program guides only provide the information on the programs currently being shown and those that will be available for some limited amount of time in the future.

If programs are available before broadcasting such as pre-produced or pre-recorded “soap-opera” drama and educational programs, they may be indexed prior to broadcasting, for example, with reference to media time that describes a relative time point from the beginning of a video stream/program. In such a case, the resulting segmentation information can be contained, for example, in the program guide that will be broadcast to TV viewers' STB although the temporal positions of the pre-indexed segmentation information should be transformed into their corresponding scheduled broadcasting times. Alternatively, the original description of the temporal positions can be adjusted with respect to the actual start (broadcasting) time of the program. However, if programs cannot be made available before broadcasting, such as news, live events and sports games, the programs may be indexed in real-time while they are being broadcast, or indexed after the broadcast, with the index then being available to or transmitted to the viewer's STB.

One way to deliver segmentation information in the program guide is to transmit segmentation information incrementally or progressively. The segmentation information can be supplied incrementally by either inserting the incremental segmentation information whenever a meaningful event happens in the program or periodically into the program guide, preferably before a program finishes. In this way, the segmentation information can be supplied before a program finishes presentation. However if the segmentation information is supplied after the broadcast program finishes, the program guide should be able to provide segmentation information of the programs that have been broadcast in the past. Unfortunately, existing program guides only provide information regarding programs currently being shown and those that will be available for some limited amount of time in the future since the program guides are basically an upcoming broadcasting schedule. Therefore, the techniques of this disclosure are useful, for example, to extend the functionalities of the current program guides to overcome such issues.

Since the standards on the specification of metadata, which may be used as a basis for program guides, have the same objective of defining a standard protocol for transmission of the relevant metadata tables contained within packets carried in the MPEG-2 TS, they are very similar in structure to both the DVB-SI and ATSC-PSIP so that those skilled in the art can easily understand the disclosed and equivalent techniques for adapting one standard to another. Therefore, the present disclosure which is primarily described based on PSIP and SI can also be easily applied to all existing and future program guide related standards which have been adopted by ATSC, DVB, OpenCable, DAB (Digital Audio Broadcasting), DMB (Digital Multimedia Broadcasting) and others.

There are two primary ways of inserting segmentation information of a program into existing program guides such as PSIP and SI.

First, a technique is herein disclosed for inserting the segmentation information into the ETT in the case of PSIP and into the short/extended event descriptors included in the EIT in the case of SI. The ETT and short/extended event descriptors in EIT can contain optional text descriptions for the events and are used to provide detailed description(s) of virtual channels and events (broadcast programs) such as a synopsis of events. A novel aspect of this disclosure is that it inserts the textual segmentation information into the ETT or short/extended event descriptors, such that the textual information can not only be parsed and displayed to provide fast access to a specific segment of a recorded program in a DVR containing appropriate simple parsing software, but can also be readable by TV viewers to get a detailed description for a program. For example, the segmentation information can be described as in Table 2 in Backus Naur Form (BNF) syntax.

TABLE 2
BNF syntax for the segmentation information inserted into the ETT
or short/extended event descriptors

```
<segment_info> ::= [{<genre_category>}] {<segment_string>}
<segment_string> ::= <segment_start_time>
                  [{genre_category}]
                [<segment_duration>]
                [<hierarchical_sequence_number>]
                [<segment_message_text>] <LF>
<segment_start_time> ::= [<DIGIT> <DIGIT> ‘:’]
                        <DIGIT> <DIGIT> ‘:’ <DIGIT> <DIGIT>
<segment_duration> ::= {<DIGIT>}
<hierarchical_sequence_number> ::= <sequence_number> |
    <hierarchical_sequence_number> ‘.’ <sequence_number>
<sequence_number> ::= {<DIGIT>}
<segment_message_text> ::= {<CHAR> except <LF>}
<genre_category> ::= {<CHAR>}
Note:
{ * } means repetition,
[ * ] means optional,
<DIGIT> means any decimal digit 0-9,
<CHAR> means a single character in any character set, and
<LF> denotes a line feed character.
```

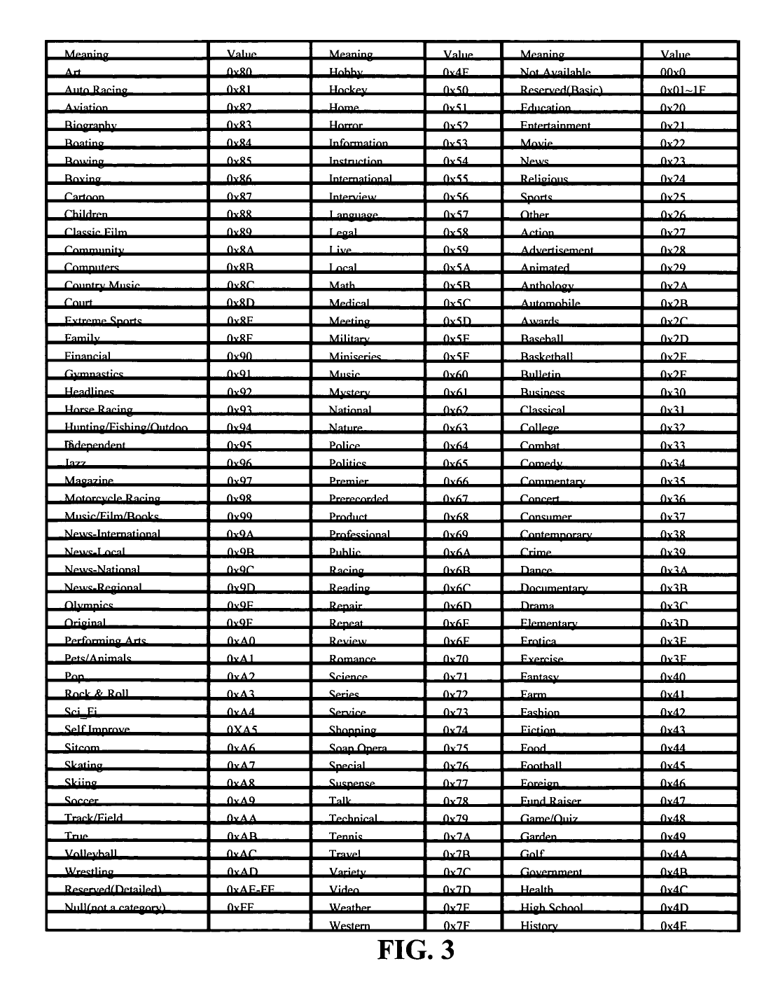

The segment information comprises an optional set of genre_category and a set of segment_string. The genre category is text from the categorical genre coded assignment table for Directed Channel Change Table (DCCT) as in FIG. 3 which identifies the type of genre for the segments enumerated in the set of segment_string. The categorical genre coded assignment table for DCCT in FIG. 3 is originally used for TV users to set their STB to one or more of the genres of interest in the table such that broadcasters may recommend TV viewers to change channels when viewing experience can be enhanced.

The set of genre_categories are ANDed to describe the genre category of the segment strings. The genre categories are applied to all segments defined through the segment_string in the current ETT except when the genre category is defined to individual segments in the segment_string.

The segment_string of a segment comprises a mandatory segment_start_time field and optional segment_duration, hierarchical_Sequence_number, set of genre_category and segment_message_text fields. The segment_start_time field preferably describes the start time of the segment in either absolute or relative time. When the segment_start_time field is described in absolute time, it is preferable to use the broadcast time contained within the STT defined in PSIP or the TDT in SI. For relative time, the segment_start_time field preferably contains the offset time with respect to the start time of the corresponding event described by the EIT in PSIP and SI. The optional segment_duration field is a quantity (preferably an integer) representing the duration of the segment in seconds. The optional hierarchical_sequence_number field indicates the position of the segment located in the tree structure of segmentation information. The optional segment_message_text field contains the textual description for the segment such as a segment title.

FIGS. 4A and 4B illustrate the segmentation information metadata generated based on the Backus Naur Form (BNF) syntax specified in Table 2. In FIG. 4A, the segment_string field of each segment provides the start time 402, the hierarchical sequence number 404 and the segment message text 406. Note that the fields 404 and 406 are optional according to the specification of the segmentation information in Table 2. Thus, in the simplest case, only the start time of each segment can be given, which could be useful for fast browsing of a video or other program, such as by quick-jumping to the start of each segment. In FIG. 4B, the metadata is partitioned into five fragments 410, 412, 414, 416, 418 corresponding to fragments 230, 232, 234, 236, 238, each of which is graphically depicted in FIG. 2. The fragments in FIG. 2 and FIG. 4B are partitioned such that they do not overlap in time (identical segment information is not included in different fragments) minimizing the bandwidths for transferring the fragments. By using the hierarchical sequence numbers of nodes, the whole tree structure of segments can be reconstructed in the receiving DVRs. But, the fragments will usually be structured such that the fragment is a sub-tree rooted at the first level of the whole tree due to the nature of real-time indexing. Thus, an entire video event or program can be sub-divided for random access of start times for important events as by identifying and jumping to the start times of sub-segments (such as 204, 206, 208, 228) and/or start times of fragments (such as 230, 232, 234, 236, 238) which include one or more related sub-segments.

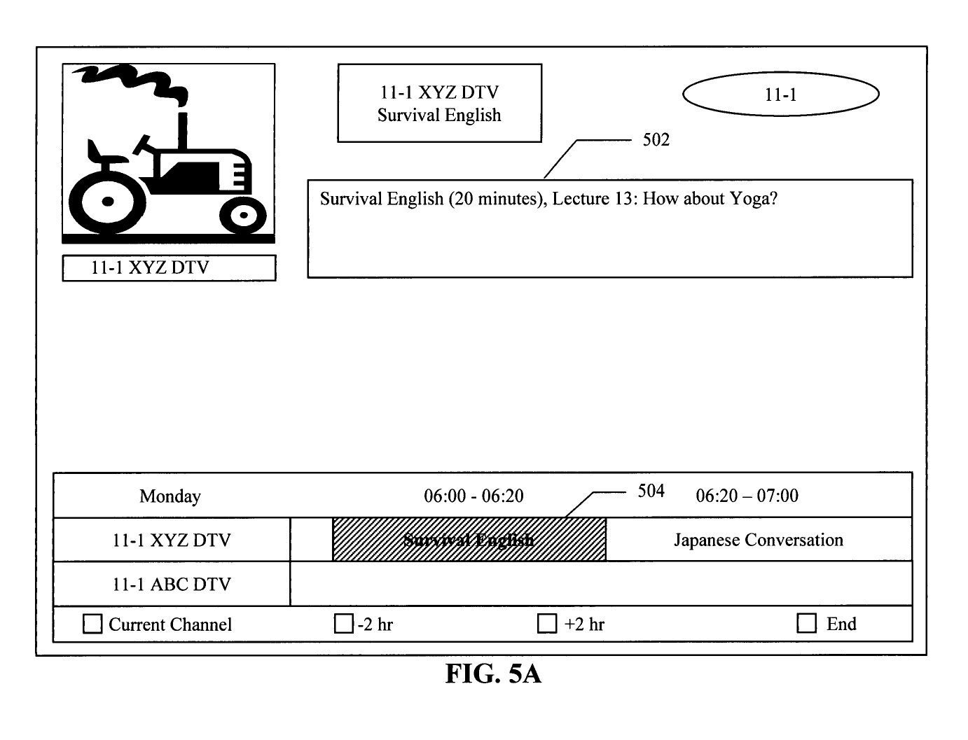

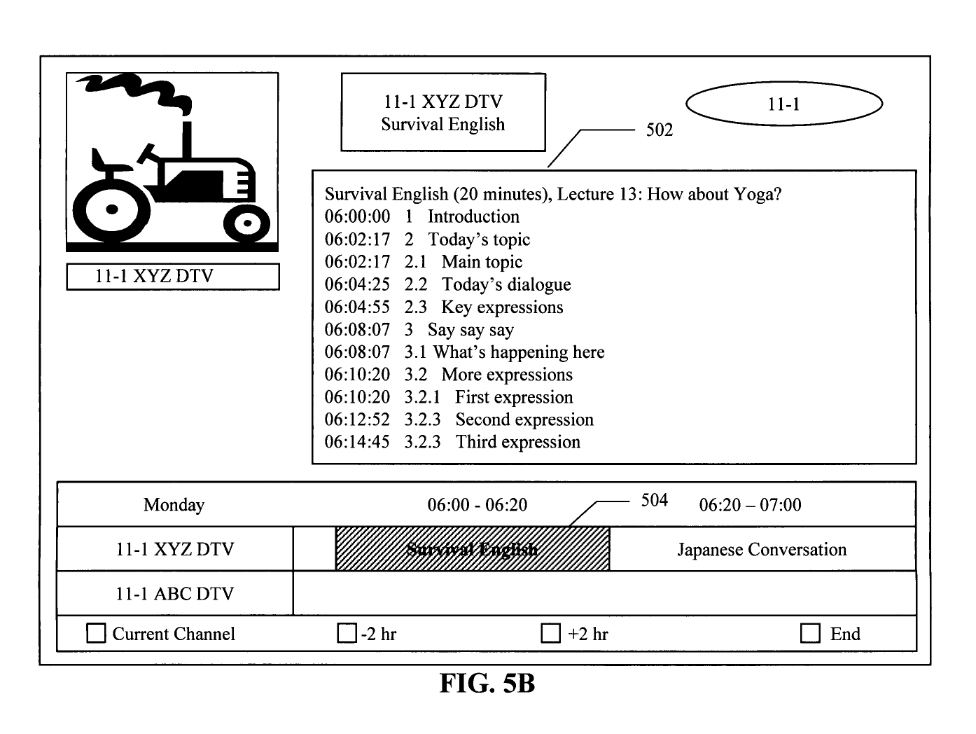

FIG. 5A shows a GUI screenshot showing a typical detailed description, included in an ETT, of a program. The detailed description (for example, program synopsis), but without segmentation information, of the program indicated by the highlighted cursor 504 is shown in the window 502 for the conventional DVRs or STBs. FIG. 5B shows an example GUI screenshot of how the herein disclosed segmentation information inserted in the ETT or short/extended event descriptors generated based on Table 2 might look on a conventional STB's display that does not have appropriate parsing software. It can be seen that the segmentation information shown in the window 502 for a program indicated by the highlighted cursor 504 does in fact provide some detailed description of events for the conventional DVRs or STBs that are not able to interpret the segmentation information. Thus, although conventional DVRs or STBs (without appropriate parsing software that can handle the segmentation information in the format of Table 2) cannot provide users with fast access to any random or specific part of a recorded program, they can still provide a possibly useful table of contents (TOC) or equivalent information for users, with the ability to jump to the beginning of each TOC or the like section. Therefore, the techniques described herein are backward compatible to conventional STBs and DVRs, and if the software for parsing the segmentation information is incorporated into conventional DVRs, users can also browse a recorded program by fast accessing to each segment, as through the TOC or the like.

Alternatively, another technique for inserting segmentation information for a program or content into current PSIP and SI is herein provided by defining a new descriptor, called named “event segment descriptor (ESD)”, to be included in the EITs defined in PSIP and SI and the like. The ESD will now be discussed in more detail. Note that the fields, in the ESD, with the same names as those described in Table 2 are defined in the same way. An exemplary ESD will now be described with particular preferred variables as noted, especially with reference to Table 3.

The ESD is used to describe segmentation information of a program or event. The ESD preferably comprises a header and a data part where the header contains general information about the segmentation information from the descriptor_tag_field to the reserved_future_use field after the max_level_of_hierarchy field, and the data part corresponds to the remaining part of the descriptor describing the segmentation information in detail.

The exemplary ESD shown in Table 3 has exemplary preferred fields. The descriptor_tag field is an 8-bit unsigned integer to identify the descriptor as the ESD and should be defined to a value not reserved for currently defined descriptors in PSIP or SI, respectively. The descriptor_length field is an 8-bit integer specifying the length (in bytes) for the fields immediately following this field through the end of the event segment descriptor. The num_segments field is an 8-bit unsigned integer that indicates the total number of segments contained within the current event segment descriptor. The genre_category_count is a 2-bit unsigned integer which indicates the total number of genre categories defined by the genre_category field.

The values for the genre_category might be used from the Categorical Genre Code Assignments utilized for DCCT in PSIP, as those illustrated in FIG. 3. The genre categories may then be ANDed to describe the genre category. For example, the genre category “Advertisement” and “Automobile” are ANDed for a car commercial to specify that the segments in the current descriptor belong to a car commercial. As another example, genre category “Sports” and “Entertainment” are ANDed to specify, for example, a tennis game. By specifying the genre type, DVR users can easily select the segment(s) of interest by specifying the type of genre(s) they are interested in. There are three ways (others are possible and are contemplated, as will be understood to those with skill in the art) of defining the fields for genre_category in the event segment descriptor(s) as follows:
1. When the fields for genre categories are defined only in the header of the descriptor, a set of genre_category, if specified, is applied to the set of all segments in a current descriptor.
2. When the fields for genre_category are defined only in the data part of the descriptor, a set of genre_category, if specified, is applied to the corresponding segment in the current event segment descriptor.
3. When the fields for genre_category are defined both in the header and in the data part of the descriptor, a set of genre_category, if specified in the header, is applied to the set of all segments in the current descriptor. If another set of genre_category is specified for a segment in the data part of the descriptor, it overrules the set of category specified in the header and is applied to the corresponding segment. (Alternatively, the first set may overrule later sets, or a controller or master set may be used to overrule prior set(s).)

The genre categories are thus applied to all segments in the current descriptor except for the case where the genre categories are defined to individual segments. Such cases occur, for example, when a segment belonging to an advertisement occurs within between a single program (between the beginning and end) such that the major genre category would specify the genre type of the program and another genre category, defined to an individual segment in between, would specify the genre type of the advertisement.

The segment_duration_flag is a flag which indicates whether the segment information in the current descriptor contains duration information for the individual segments in the current descriptor. By way of example, the segment_duration_flag is set to ‘1’ when the current segment descriptor contains duration information, else it is set to ‘0’. Even if the duration information of a segment does not exist when the segment_duration_flag is set ‘0’, it still provides the index of start times for the segments in the current descriptor to aid users to reach to the segment of interest.

The frame_accurate_flag is a flag which indicates whether the segment information in the current descriptor provides frame accurate segmentation information. By way of example, when the frame accurate flag is set to ‘1’, it indicates that the current event segment descriptor provides frame accurate information, else it is set to ‘0’. In the case where the frame accurate flag is set to ‘1’, the event_segment_descriptor provides additional time information, usually in the resolution of 60 Hz considering that the ATSC stream has a frame rate of up to 60 frames per second.

The command_mode field is a flag which identifies the commands to be performed for the segments contained in the current descriptor in the receiving client. By way of example, if the command mode field is set to ‘1’, it indicates that the segment information in the current descriptor should be added/modified in the receiving client, and if set to ‘0’ to remove segment information stored in the DVR. The procedure for handling the command mode field is explained in more detail afterwards.

The max_level_of_hierarchy field is a 3-bit field that specifies the maximum level of the nodes corresponding to the segments described in the current event segment descriptor. This field is an optional field that may be used to describe the segments in a hierarchy.

TABLE 3
bit stream syntax for the event segment
descriptor (ESD) inserted in EIT tables

| event_segment_descriptor( ) { | Bits | Format |
|---|---|---|
| descriptor_tag | 8 | 0x88 |
| descriptor_length | 8 | Uimsbf |
| num_segments | 7 | Uimsbf |
| genre_category_count | 2 | Uimsbf |
| for ( i=0; i < genre_category_count; i++) { | | |
| genre_category | 8 | Uimsbf |
| } | | |
| segment_duration_flag | 1 | Bslbf |
| frame_accurate_flag | 1 | Bslbf |
| command_mode | 1 | Bslbf |
| max_level_of_hierarchy | 3 | Uimsbf |
| reserved_future_use | 1 | Bslbf |
| for (i=0; i < num_segments; i++) { | | |
| for (j=0; j < max_level_of_hierarchy; j++) { | | |
| sequence_number | 8 | Uimsbf |
| } | | |
| segment_start_time | 32 | Uimsbf |
| segment_duration_base | 16 | Uimsbf |
| if (frame_accurate_flag==1) { | | |
| relative_segment_start_time | 7 | Uimsbf |
| if (segment_duration_flag==1) { | | |
| segment_duration_extension | 6 | Uimsbf |
| reserved_future_use | 2 | Uimsbf |
| } | | |
| reserved_future_use | 1 | Bslbf |
| } | | |
| genre_category_count | 2 | Uimsbf |
| for (j=0; j < genre_category; j++) { | | |
| genre_category | 8 | Uimsbf |
| } | | |
| reserved_future_use | 6 | Uimsbf |
| segment_message_length | 8 | Uimsbf |
| segment_message_text( ) | var | |
| } | | |
| } | | |

The outmost for-loop in Table 3 describes each of the segments contained within the current ESD. Thus, information on each given segment is described with the following fields. The optional inner for-loop gives a list of all the sequence numbers of the segments, located along a path from the root to the given segment in the whole hierarchical structure of segments for a program, according to the ascending order of levels.

The 8-bit integer sequence_number field gives the sequence number that is preferably defined in the same way as the sequence_number field in Table 2. Thus, the hierarchical sequence number of the given segment can be obtained by concatenating all (or a subset) of all the sequence numbers along the path from the root to the given segment with a “.” (dot) according to the ascending order of levels. For example, let d be the value given by the max_level_of_hierarchy field and n be the level of a segment. Since d sequence numbers have to be always specified for the given segment given the inner for-loop in Table 3, the segment should have n sequence numbers in the ascending order of levels if d=n. If the level of the segment is less than the maximum level of hierarchy (n<d), only n sequence numbers shall have value in ascending order of levels where otherwise the rest of d-n sequence numbers shall have a value “0x00”.

The segment_start_time field comprises a 32-bit unsigned integer quantity representing the start time of this segment as the number of GPS seconds since 00:00:00 universal time coordinated (UTC), Jan. 6, 1980 (Note that the segment_start_time field could optionally be defined as a 40-bit field in UTC and MJD as defined in annex C of DVB-SI (ETSI EN 300 468) or otherwise).

The segment_duration_base comprises a 16-bit field unsigned integer which defines the duration of the segment in seconds.

The relative_segment_start_time comprises the relative time, timed from the first arrival of a TS packet carrying the last byte of STT with system time equal to the value defined in segment_start_time field in resolution of preferably at least or about 60 Hz. The relative_segment_start_time thus gives relative time from the segment_start_time for frame accurate access.

The segment_duration_extension comprises an extension to the value defined in the segment_duration_base to give the duration of a segment in resolution of preferably at least or about 60 Hz.

The segment_message_length field comprises an 8-bit unsigned integer that specifies the length of the segment_message_text( ) description that immediately follows.

Finally, the segment_message_text( ) is for the description of the segment in the format of any string structure such as the multiple string structure in PSIP and the single string structure in SI.

The-bit stream syntax for the ESD described above is an example of how segments may be described in a descriptor and it should be noted that alternative ways of localizing a specific position or frame may be used, as described previously in media localization. For example, the-bit stream syntax for the ESD in Table 3 uses system_time in STT as a time marker and relative time with respect to the time marker through the segment_start_time field and relative_segment_start_time field, respectively, to represent or localize a specific position or frame. The values of segment_start_time field and relative_segment_start_time field could be adjusted, for example, so that the absolute value of the segment_start_time field should be less than one second, for the purpose of representation. Alternatively, localization information on a specific position or frame to be displayed may be obtained by using both system_time in STT (or UTC_time in TDT or other equivalents) as a time marker and relative byte offset with respect to the time marker. In such a case, the relative_sement_start_time field may be redefined to a field to represent the relative byte offset from the first packet carrying the last byte of STT containing the value defined in segment_start_time field. Furthermore, localization information on a specific position or frame to be displayed may be achieved by using system_time in STT and the PTS for the position or frame to be described. In such a case, the relative_segment_start_time field may also be redefined to a field to represent the PCR value at the start time of corresponding segment.

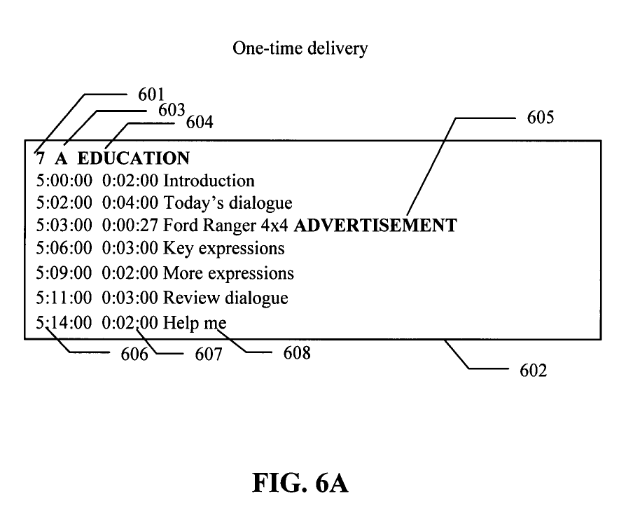

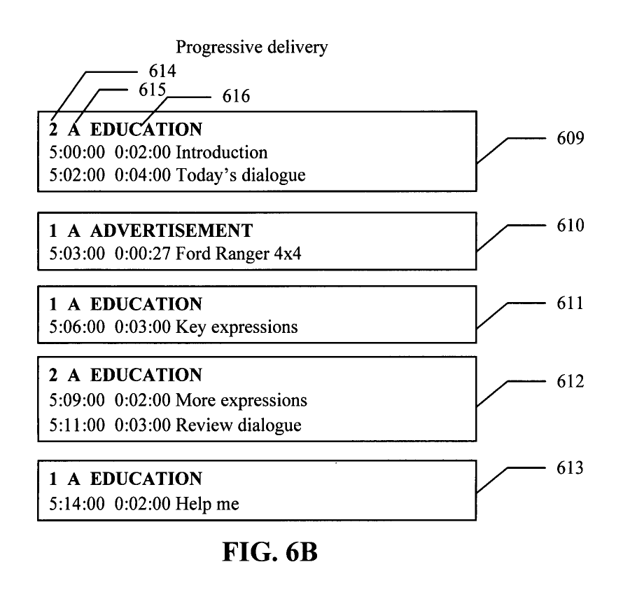

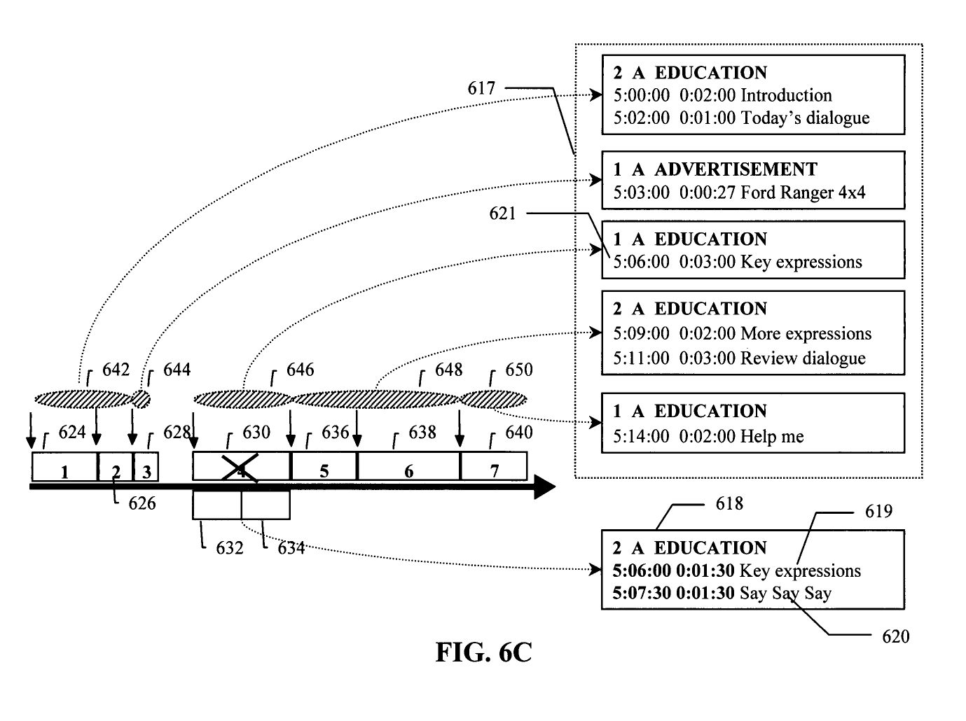

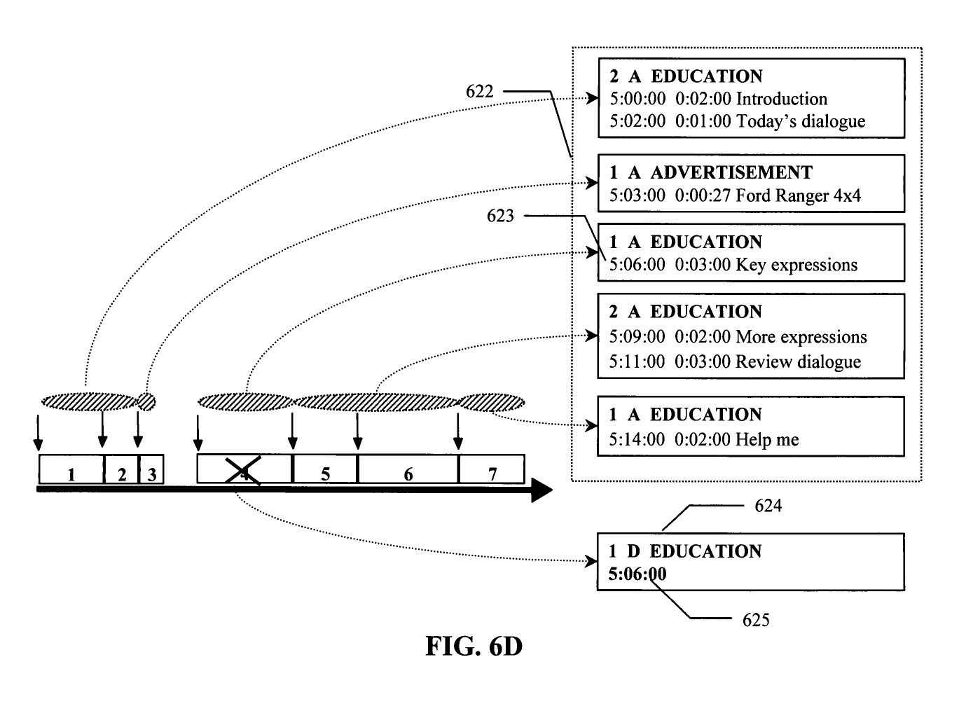

FIGS. 6A and 6B illustrate an exemplary, simplified version of segmentation information metadata generated based on the-bit stream syntax specified in Table 3. FIG. 6A illustrates the case where the whole metadata is sent all at once, usually before or after the corresponding video program is broadcast, or during broadcasting if the program was pre-viewed (and pre-indexed). In FIG. 6A, the field 606 represents the segment_start_time, the field 607 represents the segment_duration_base, and the field 608 represents the segment_message_text belonging to individual segments. In FIG. 6A, the reference numeral 601 indicates the value of num_segments field which has value ‘7’ that is the total number of segments in the current descriptor 602. The reference numeral 603 indicates the command_mode field. For example, the command_mode 603 is expressed as ‘A’ when the command_mode field is set to ‘1’ for addition/modification and expressed as ‘D’ when the command_mode field is set to ‘0’ for deletion. In this example, since the command_mode 603 is ‘A’, it indicates the segments in the current descriptor 602 should be added/modified to the receiving DVR. The fields 604 and 605 represent the genre_category. The field 604 represents the genre_category specified at the header of the descriptor while the field 605 represents the genre_category specified at the data part of the individual segments.

The genre categories specified at the header 604 are applied to all segments in the current descriptor except for the case where the genre categories are defined to individual segments. Therefore all the segments in the current descriptor 602 belong to category “EDUCATION” corresponding to the genre_category value 0x20 in FIG. 3 except for the segment with title “Ford Ranger 4×4″ where the genre_category is specified to be “ADVERTISEMENT” corresponding to the genre_category value 0x28 in FIG. 3. Such cases occur, for example, when a segment belonging to an advertisement occurs within a single program where the major genre_category would specify the genre type of the program and the genre category defined to an individual segment in-between would specify the genre type of the advertisement. Additionally, more than one category could be used with any particular segment.

FIG. 6B illustrates another case where the metadata is decomposed into five fragments that can be sent incrementally, fragment-by-fragment. This situation usually occurs when a video program is being indexed in real-time during broadcasting or when an updated portion of an index may be sent to a DVR. Each fragment is preferably sent repeatedly through event segment descriptors 609, 610, 611, 612, 613 at different times. For example, a fragment is sent at the descriptor 609 where the num_segments field 614 has value ‘2’, the command_mode field value 615 of ‘A’ and genre_category field 616 value of “EDUCATION”.

FIGS. 6C and 6D illustrate examples of command_mode operations for a segment.

FIG. 6C illustrates how a modification may be done for segment information that has been sent in the past. To modify segment information that was previously delivered and stored in the DVR, a descriptor containing the correct modified start time and/or duration of text for a segment is delivered with the command mode “addition”. If a segment in the delivered segment information with command mode “addition” overlaps in time with any other segment from the previously delivered segment information and stored in the DVR, it is replaced by the segment contained in the lastly delivered segment information. For example, to perform modification on segment information that has been delivered through descriptors 617 in the past, a descriptor 618 is sent to modify the duration of the segment 621 and adds an additional segment 620 in the DVR. Since the segment 619 in the descriptor 618 overlaps in time with the segment 621 which was sent previously and stored in the DVR, the segment 621 is deleted and replaced by 619. Furthermore, the segment 620 in the descriptor 618 is added to the DVR since it does not overlap with any segment stored in the DVR. The line 622 is the time line of a program where the blocks 624, 626, 628, 630, 632, 634, 636, 638, 640 represent segments (the blocks are mapped to the time line 622 such that the left of the block is located at the start time of a segments and the right of the block is located at the end time of a segment). The ovals 642, 644, 646, 648, 650 show the set of one or more segments that are grouped to form a fragment and the arrows are another representation to show the start time of each segment. For example, fragment 642 is formed by grouping segments 624 and 646, while fragment 648 is formed by grouping segments 636 and 638.

FIG. 6D illustrates a similar example of the process of deleting a segment from a previously delivered segment. Similar to the modification process of a segment described above, any segment from the previously delivered segment information that overlaps with a segment delivered under the command mode “deletion” is deleted from the DVR. For example, FIG. 6D illustrates the process of deleting the segment 623 that has been delivered through the descriptors 622 and stored in the DVR. The descriptor 624 is delivered with the command mode “D” meaning that any segments that overlap with a segment 625 in the segment information in 624 should be deleted from the DVR. Therefore the segment 623 that is stored in the DVR is deleted since it overlaps in time with the segment 625 in the descriptor 624.

Although the overlapping technique is used to identify the segment information to be deleted and added/modified, the hierarchical sequence number can also be used to identify the segments for addition or deletion when the hierarchical sequence number is utilized. In such cases, the segment information with the same hierarchical sequence number is utilized for the identification of segment information similar to the above procedures.

3. Transmission Time for Segmentation Information

Given the exemplary techniques described above for inserting segmentation information into either PSIP or SI, or using various alternatives, the segmentation information can be transmitted to users' STBs in various ways. Metadata may be delivered prior to broadcast of an event (such as a pre-recorded movie) and associated with the program when it is broadcast. Also, various combinations of pre-, post-, and during broadcast delivery of metadata are here by contemplated. A more extensive metadata set(s) could be later provided and, of course, pre-recorded events could have rough or extensive metadata set(s) delivered before, during or after the program broadcast. The later delivered metadata set(s) may augment, annotate or replace previously-sent, later-sent metadata, as desired.

First, since both SI and PSIP allow change in the information contained within the ETT or the short/extended event descriptors in the EIT, assuming that the segmentation information for a program is indexed in real-time, such that the segmentation information can be transmitted incrementally or progressively in the unit of a fragment through the program guide. In this case, the segmentation information is inserted within the ETT or the short/extended event descriptors in the EIT and the segmentation information for a segment or a group of segments is inserted into the program guide by inserting incremental segmentation information in the ETT or the short/extended event descriptors in the EIT for the current segment whenever a meaningful segment occurs or periodically with an arbitrary or preferred time interval. Where the segmentation information is inserted in the event segment descriptor of the EIT, it should be inserted in the event segment descriptor of the corresponding current segment contained within EIT-0 in the case of PSIP, and EIT present/following in the case of SI, which contains data related to the current event for the generation of a program guide. In this case, in order to keep the segmentation information of a program transmitted incrementally through PSIP or SI, STB should save or accumulate the incremental segmentation information into its local storage for utilizing the information.

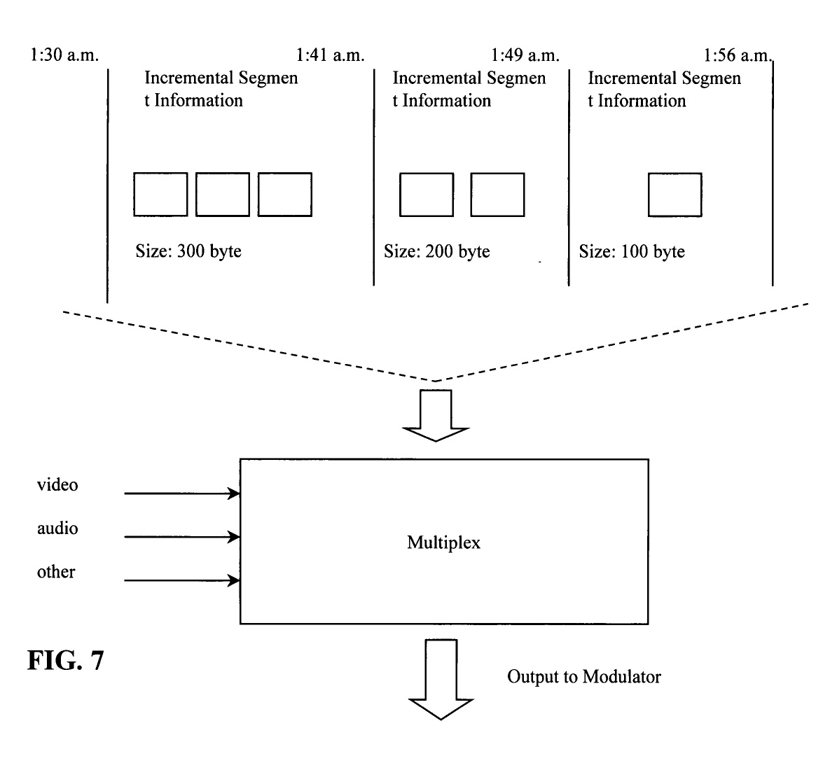

An advantage of transmitting the segmentation information incrementally is that less bandwidth is occupied since only small amounts of segmentation information need to be transmitted before the segmentation information for the next increment is available. Furthermore, since the tuner stays tuned to a certain frequency/channel while a program is being recorded, the segmentation information incrementally inserted in the program guide for the respective program is available during recording. For example, as shown in FIG. 7, only a portion of the segmentation information corresponding to a size of 300 bytes is multiplexed into the TS stream from, for example, 1:30 am to 1:41 until the next incremental segmentation information is to be sent. Assuming that the next incremental segmentation information corresponding to a size of 200 bytes is generated by the indexer at 1:41, it is solely multiplexed into the TS stream and delivered. Assuming that the next incremental segmentation information corresponding to a size of 100 bytes is generated by the indexer at 1:49, it is solely multiplexed into the TS stream and delivered. Thus the bandwidth occupied to deliver the whole segmentation information is 300 bytes from 1:30 a.m. to 1:41 a.m. and 200 bytes from 1:41 a.m. to 1:49 a.m. and 100 bytes from 1:49 a.m. to 1:56 a.m. Therefore the maximum instantaneous bandwidth occupied to deliver the whole segmentation information is 300 bytes which would have taken approximately 600 bytes if the complete segmentation information had been sent at one time.

Second, the segmentation information or a portion or updated portion for a program can be transmitted at a time after the respective broadcast program has finished. In this case, the segmentation information, preferably transmitted through the program guide, should be able to contain information about a program that has been broadcast in the past. That is, the EPG should not only be able to provide information about current and future programs but should also be able to provide information about programs that have already been broadcast. However, the current EPG specifications contain and emphasize only information regarding events currently being shown and that will be available for some amount of time into the future. Thus, the problems that can arise in transmitting the segmentation information after the respective broadcast program has finished are to be discussed in detail for PSIP and SI, and exemplary and preferred methods to overcome such issues are given. Other methods are contemplated as would occur to one of ordinary skill in the art.

Regarding PSIP, problems can arise when the segmentation information is transmitted after the respective broadcast program has finished. The PSIP supports up to 128 EITs (EIT-0 to EIT-127) where each EIT provides event information for a 3 hour span. The start times for EIT tables are constrained to be one of the following UTC times: 0:00(midnight), 3:00, 6:00, 9:00, 12:00 (noon), 15:00, 18:00, and 21:00 where EIT-0 covers the current 3-hour interval. The EIT-0 always denotes the current 3 hours of programming, EIT-1 the next three hours and so on. Consider the case where a broadcaster decides to carry an event which starts at UTC time 2:00 and finishes at UTC time 2:55. If the segmentation information cannot be supplied by 3:00, then the segmentation information cannot be inserted since the EIT for the corresponding program is not available. Now, EIT-0 can only describe events from 3:00 and on. Therefore, two methods are described to overcome this problem.

First, given that the segmentation information for a program is delivered through the ESD in the EIT tables, the problem can be overcome by defining EITs in PSIP such that EIT-(−i) covers the past 3-hour interval from 3i hours before of the current 3-hour interval. The Master Guide Table (MGT) specifies the type of table (through the table_type field) and its Packet Identifier (PID) value such that the specified table can be located in the TS. For example, the table_type field in the MGT uses the values from 0x0100 to 0x17F to specify the EIT tables from EIT-0 to EIT-127. However in order to define additional EIT tables, named EIT-(−i) (EIT-(−1), EIT-(−2), . . . ), a unique value for the table_type field is needed to specify each i additional EIT. Since the values available for the table_type field in PSIP for assigning the EIT-(−i) table is only available in the range reserved for either private or future ATSC usage (0x0006-0x00FF, 0x0180-0x017F, 0x0280-0x0300, 0x0400-0x0FFF, 0x0400-0x13FF, 0x1500-0xFFFF), a unique value needs to be chosen in those ranges to define each of the new EIT-(−i) table. The values for the table_type field also need to be specified in case the segmentation information is to be delivered through ETT in the same manner. The table_type field in the MGT uses the values from 0x0200 to 0x27F to specify the ETT tables from ETT-0 to ETT-127 and an unique value for the table_type field is specified for each i additional ETT in the range reserved for either private or future ATSC usage (0x0006-0x00FF, 0x0180-0x017F, 0x0280-0x0300, 0x0400-0x0FFF, 0x0400-0x13FF, 0x1500-0xFFFF). Therefore, if the current UTC time is 3:05, EIT-(−1) it then covers the 3-hour interval from UTC time 12:00 to UTC time 3:00 and EIT-0 covers the 3-hour interval form UTC time 3:00 to UTC time 6:00 and so forth.

Therefore, the segmentation information can be delivered through either EIT or ETT for the past 3i hours of program from the current time. However, as a practical matter, it is only necessary to define EIT-(−1) which covers the past 3-hour interval before the current 3-hour interval because real-time indexing tools practically make it possible for segmentation information to be provided within 3 hours after it is finished. Thus a 16-bit unsigned integer could be specified for the type of EIT-(−1) to 0x00FF which would form linearity in table type number through EIT-(−1) to EIT-(127) from 0x00FF to 0x017F. Similarly, even prior (more than the past 3 hour) intervals may be covered, and such is contemplated as being within the scope of this disclosure.

Another way to overcome such the problem arising when the segmentation information is transmitted after the respective broadcast program has finished is to insert the segmentation information of a finished event to EIT-0 of the current 3-hour interval if the EIT covering the corresponding event is already non-existent (past, gone). For example if the current UTC time is 3:05 and it is desired to send the segmentation information for an event which lasted from 2:00 to 2:55 UTC time, the event can be forcibly inserted to EIT-0 which covers the event from 3:00 to 6:00 UTC time. Although this method is not fully compliant to PSIP in the sense that EIT-0 should only contain information for events occurring in the current 3-hour interval, it is expected that STBs that cannot support the proposed features will discard such event and be able to process and use only the events that should be covered by the EIT-0 as specified in PSIP.

For SI, the EIT schedule information consists of 16 EIT sub-tables for actual TS and another 16 EIT sub-tables for other TS. Each sub-table can have 256 data sections having a maximum size of 4,096 bytes, which are divided into 32 segments of 8 sections each. Note that the terminology “segment” of EIT sub-table should not be confused with the “segment” of segmentation information in the event segment descriptor. The EIT sub-table of the EIT schedule information is structured such that the segment #0 of table_id 0x50 for actual TS (0x60 for other TS) contains information about events that start between midnight (UTC time) and 02:59:59 (UTC Time) of “today” and the segment #1 contains events that start between 03:00:00 and 05:59:59 UTC time, and so on. Thus the first sub-table (table_id 0x50, or 0x60 for other TS) contains information about the first four days of schedule, starting today at midnight UTC Time. Therefore, the first sub-table can contain information of the current 3-hour interval and also the past 3-hour interval unless the current interval is in the period between midnight and 02:59:59 compared to EIT-0 in PSIP that only contains information about the current 3-hour interval. Thus, the first EIT sub-table in SI not only contains information of the current 3-hour interval but also the information about event(s) from midnight of “today” to the current 3-hour interval. However, consider the case where a broadcaster decides to carry an event that starts at UTC time 23:00 and finishes at UTC time 23:55 of yesterday. If the segmentation information cannot be supplied by 00:00 UTC time of today, then the segmentation information cannot traditionally be inserted since the first sub-table of EIT for the corresponding program is not available since the first sub-table (table_id 0x50 for actual TS, or 0x60 for other TS) contains information of events starting today at midnight UTC Time. Therefore, two methods are herein described and provided to overcome such problems.

First, given that the segmentation information for a program is preferably delivered through the event segment descriptor in the EITs, the problem can be overcome by defining EIT sub-tables in SI such that segment # (−i) of table_id 0x50 for actual TS (0x60 for other TS) covers the 3-hour interval from 3i hours before midnight of today (UTC time 00:00). Therefore, segment #(−1) covers the 3-hour interval from UTC time 21:00 to UTC time 23:59 of yesterday and segment #(−2) covers the 3-hour interval from UTC time 18:00 to UTC time 20:59 and so forth. Therefore, the segmentation information can be delivered through EIT for the past 3i hours of program from the current 3-hour interval. However, as a practical matter, only segment #(−1) needs to be defined, which covers the past 3-hour interval before midnight of today because real-time indexing tools make it possible for segmentation information to be provided within 3 hours after it is finished (however, there is still a benefit for being able to send segmentation information, as for updates, more than three hours after a broadcast has finished).

Another way to overcome the problem is to insert the segmentation information of a finished event to the segment #0 if the EIT sub-table covering the corresponding event is already non-existent. For example if the current UTC time is 01:05 and it is desired to send the segmentation information for an event which lasted from 23:00 to 23:55 UTC time yesterday, the event is forcibly inserted to the segment #0 which covers event(s) from midnight to 03:00 UTC time. Although this method is not fully compliant to SI in the sense that the segment #0 of the first table should only contain information for events occurring in the current 3-hour interval from midnight of today, it is expected that STBs that cannot support the proposed features will discard such event and be able to process and use only the events that would be covered by the segment #0 of first EIT sub-table as specified in SI.

Along with the above-described issues that can arise in transmitting the whole segmentation information after the respective broadcast program has finished for PSIP and SI, an additional tuner might be needed if the user changes the channel after recording. The PSIP specifies that it is mandatory for PSIP tables to describe all of the digital channels in a TS and the digital channels in a different TS are optional. Accordingly, DVB also specifies that it is mandatory to include only the DVB tables for the digital channels of an actual TS and the tables of digital channels of a different TS are optional. Therefore in the event that a user decides to change to a TS different from the TS that was recorded before the segment information has arrived, a tuner might need to stay tuned to the transport that was recorded until the segment information has arrived from the corresponding TS while a second tuner (or third, or other additional) is utilized to tune to the other TSs of interest. Multiple tuners in DVRs and controlling the multiple tuners are known, and need not be described in any further detail herein.

4. Graphical User Interface of DVR

With the successful reception of segmentation information under the segmentation information data formats and transmission methods for a STB described hereinabove, two exemplary ways of generating an interactive graphical user interface (GUI) for browsing based on the received segmentation information are described in detail using thumbnail images from specific positions of the video file which can be generated either by hardware (H/W) or software (S/W) or firmware (F/W) or a combination thereof.

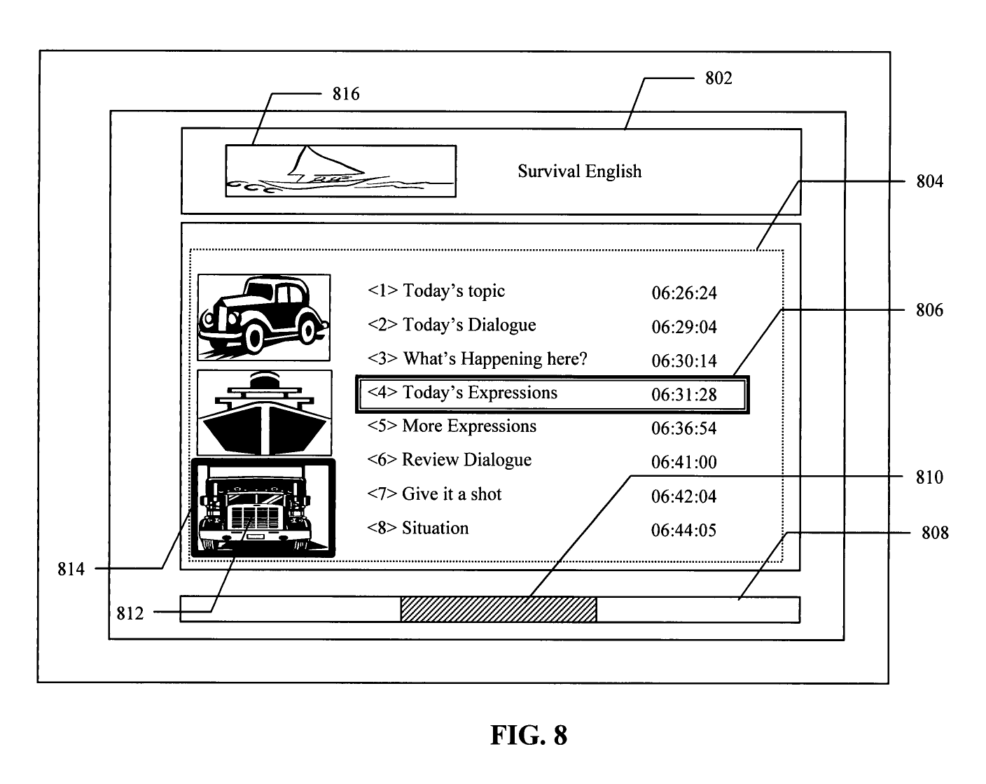

FIG. 8 is a depiction (screen shot of an on-screen display (OSD)) of an exemplary program guide showing the segmentation information for a recorded program in an STB. The boundary box 802 shows the title of the program that is recorded in a STB and 804 indicates the textual description of the segments of the corresponding program. The user can move the highlighted cursor 806 upwards or downwards to select the segment of interest based on (such as by clicking on) the displayed textual description of the segment for playback or where a corresponding representative thumbnail image 812 may be highlighted by a bounding box 814. A progress bar 908 is displayed to represent the total length of the recorded program, and another smaller bar 810 on top of and/or overlaying and/or below the bar 908 represents the approximate length which that portion of the segment (currently indicated by the highlighted cursor 806) occupies out of the total length of the recorded program. The position of the bar 810 relative to the bar 908 indicates the position of the segment in the overall program. The highlight bounding box 814 and the bar 810 may preferably move with respect to the movement of highlight cursor 806, and all of them are thus synchronized. Optionally, either of the other visual identifiers (thumbnails, such as 812 and small bars, such as 810) may be accessed or selected, with appropriate designation of the other visual identifier and/or the text (such as 814 highlighted at 806).

Techniques for making of thumbnails, based on video segments, are described in the above-referenced, commonly-owned, copending U.S. patent application Ser. No. 10/361,794 filed Feb. 10, 2003 (Published U.S. 2004/0126021), and U.S. patent application Ser. No. 10/365,576 filed Feb. 12, 2003 (Published 2004/0128317).

Although the exemplary GUI described above shows a textual description of each segment, a representative thumbnail image can be generated for each segment based on the delivered temporal positions of the segments to generate a storyboard for a recorded program with or without the textual description of each segment. Additionally, the thumbnails (such as 812) are shown as static, single image frames, but may be animated or short video clips, as described in the aforementioned U.S. patent application Ser. No. 10/365,576 filed Feb. 12, 2003 (Published 2004/0128317).

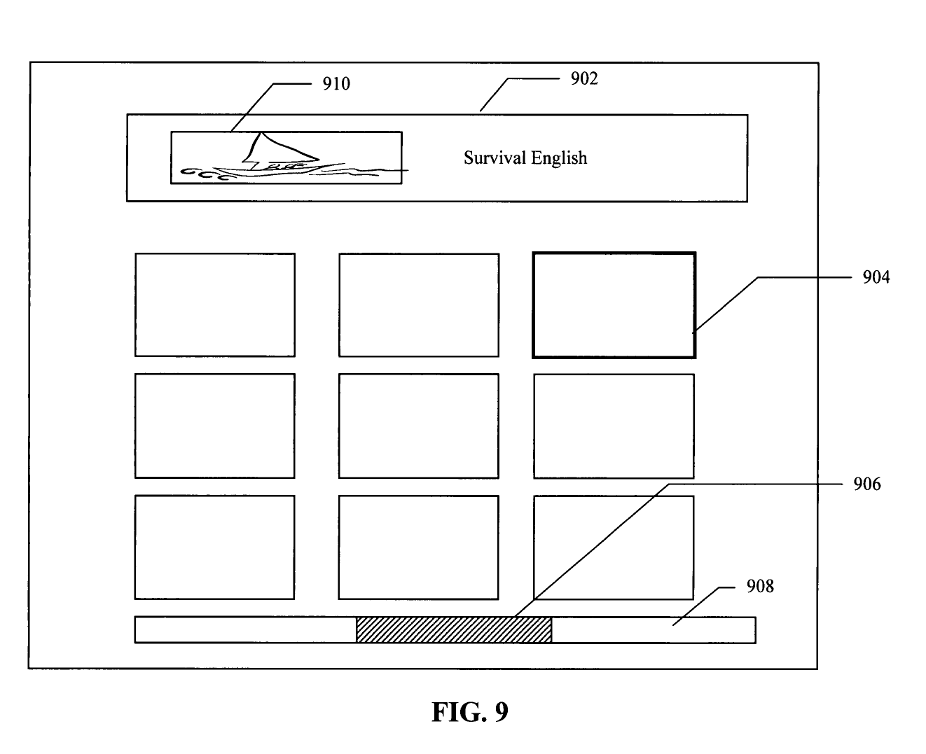

FIG. 9 is a depiction (screen shot of an OSD) of an exemplary program guide showing a storyboard for a recorded program in an STB based on segmentation information. The box 902 shows the title of the program that is recorded in the STB. A user may then move the highlighted bounding box 904 upwards, downwards, left or right to select the segment of interest based on the displayed thumbnail image(s) for playback. A bar 908 is displayed to represent the total length of the recorded program noted at 902 and where another small bar 906 on top of and/or overlaying and/or below the bar 908 represents the approximate length which that portion of the segment (currently indicated by the highlighted bounding box 904) occupies out of the total length of the recorded video. Since a GUI such as FIG. 9 does not require a textual description of each segment, only the temporal positions of the segments need to be given by the segmentation information, which results in saving the amount of bandwidth occupied for transmitting the segmentation information. A technique for presenting a comparable storyboard is described in the aforementioned U.S. patent application Ser. No. 10/365,576 filed Feb. 12, 2003 (Published 2004/0128317).

An optional image, animation or video 816 (in FIG. 8), 910 (in FIG. 9) may be added to the browser interface as a banner where the image or video might be transmitted by multiplexing the image, animation or video into the broadcast stream, or it can just be an image, animation or video as obtained from an on-air commercial contained within the broadcast stream. Alternatively, the image, animation or video for a banner can be obtained as, for example, from the commercials recorded with the TV program.

Without separate screens for browsing segmentation information, such as FIGS. 8 and 9, another way of providing users with segmentation information for an event (program) such that segments can be easily accessed is by providing dedicated keys for segment skipping in a remote control device such that the video may be randomly accessed and played from the start position of segments in temporal order either backwards or forwards. For example, pressing a dedicated segment skipping backward key would initiate the playback of the previous segment from the start position of previous segment. For example, pressing a dedicated segment skipping forward key would initiate the playback of the next segment from the start position of next segment based on delivered segmentation information.

5. Processing of Segmentation Information in DVR

Given the above disclosed methods for delivering and displaying segmentation information of a program in a DTV signal that complies with PSIP and/or SI metadata or other specification(s), the method of how the metadata received at a TV viewer's STB should be processed for use is herein described in detail.

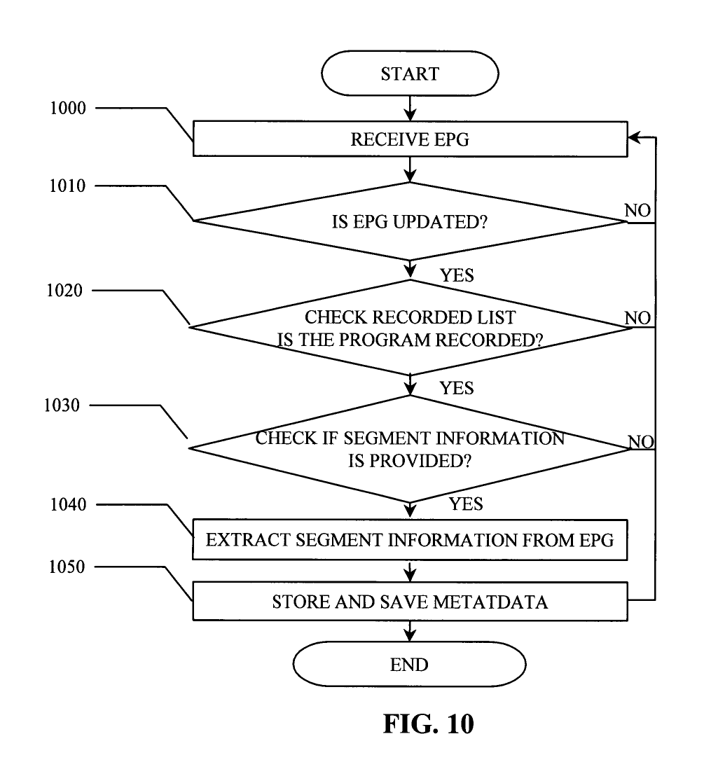

FIG. 10 is a flow chart showing an exemplary method of how segmentation information metadata can be processed at a DVR when the metadata is delivered through an EPG. Considering both methods of transmitting segmentation information through the ETT or short/extended descriptor in EIT and the disclosed event segment descriptor in EIT, when metadata is received (step 1000) the EPG engine first checks (step 1010) if an EPG data (data in EIT or ETT) for a program is updated based on the change in version_number field defined for ETT or EIT. If an updated EPG data for a program is detected, the EPG engine checks (step 1020) the recorded list to find out whether the corresponding program is being recorded or not. If an updated EPG data for a program is not detected, the program loops back. When the corresponding program is being recorded (positive result, step 1020), the EPG engine checks (step 1030) if new or incremental segmentation information exists. If so (positive result, step 1030), it checks segmentation information for various operations depending on the command mode, such as in Table 3, and is extracted (step 1040) and stored in the DVR (step 1050). All of the steps loop back, as shown, based on negative results.

6. Processing and Presentation of Infomercials

The turnaround on TV industry is about to commence due the proliferation of DVRs providing users with easy scheduled recording of broadcast TV programs based on EPG. Typical television users are no longer satisfied with conventional ways of viewing TV but will demand for new ways of viewing TV, for example, in a way similar to DVD chapter selection.

Ad-skipping, the technology that allows TV viewers to skip commercial TV spots recorded in a DVR, could threaten the broadcasting industry's business model. With DVRs such as TiVo or SONICblue's ReplayTV, most of the DVR users are known to skip commercials through fast forwarding through television spots during network primetime. The current model DVRs also often include intelligent functionalities such as a 30 second skip-forward button on a remote controller, and automatic commercial skipping which makes advertisements a lot easier to skip.

According to Bandon, an Oregon-based consultancy, almost 30% of DVR users, on average, fast forward through advertisements (commercials) whereas 65.3% of cable users skip advertisements. For fast food, credit card and upcoming network promotions, the numbers were exceptionally high: more than 93% of DVR owners fast-forwarded to avoid these sorts of commercials. On the other hand, advertising spots for beer fared the best, with only 32.7% of viewers fast-forwarding through the ads. DVR users also were likely to watch direct-to-consumer prescription drug ads and movie trailers, with 46.9% and 47.3% of those surveyed skipping ads, respectively (from article PVR Users Skip 71% of Ads” by Christopher Saunders, Jul. 3, 2002 (see World Wide Web at clickz.com/news/print.php/1380621)). Therefore a new paradigm is needed in providing commercials to DVR users where the commercial skipping functionality is inevitable.

But there is hope for the ad-funded television business satisfying both the television viewers and the broadcasters. Although users are allowed to skip commercials with the press of a button for “speed viewing” what they want continuously, the users are also beginning to feel the need for relevant programming and advertisements. For example, DVR users may want to see categorized segments/clips of recorded TV programs containing information and commercials (infomercials) such as new program teasers, public announcement, time-sensitive promotion sales and content-relevant commercials.

But in order for this to occur, a new television scheme needs to be developed to facilitate the capture of advertising and programming content in DVR hard drives, provide segmentation information for a stored program and enable linkages to this stored content from other programming and the television navigation system.

An exemplary method that is based on event_segment_descriptor( ) in ATSC-PSIP although it could be also implemented based on other standards such as TV Anytime or MPEG-7, is disclosed, enabling users to search for, select and/or watch the infomercial of interest including commercials, advertisements, and the like from the recorded stream. Although people have tendencies to skip advertisements that are not of their interest, people still may want to see advertisements within their interest. This can be observed by the difference of percentage in viewing advertisements according to their target, subject and purpose (as noted above).

In order to aid the DVR users to see commercials of their interest, as distinguished from other commercials stored in their DVR, the segment information in the event_segment_descriptor is sent with the categorical genre code “0x28” (Advertisement) or “0x53” (Information) in the genre_category field, such as of Table 3, which is used as the identification of an infomercial segment. For detailed categorization, the infomercial segment can have a maximum of two other codes specified in the categorical genre coded assignment table for DCCT as in FIG. 3. Therefore, through the genre code, category and intention information can be provided for easy navigation of infomercial such as time sensitive promotion sales, content specific commercials (for example, Vacation/Auto), company and product name (for example, Toyota), length (everything under 30 sec. or over 1 min.), and new program teaser(s). However, in order to provide navigation through advertisement(s), additional categories should be provided, such as the categories “Promotional”, “Campaign”, “Sale”, “New program teaser”, “New movie release”, “Cosmetics”, “Electronics”, “Household”, “Internet” and “Telecommunications” among others, which are often of great interest to the users, especially in case of advertisements to the categorical genre code assignments mainly focusing on providing various genre types for normal programs.

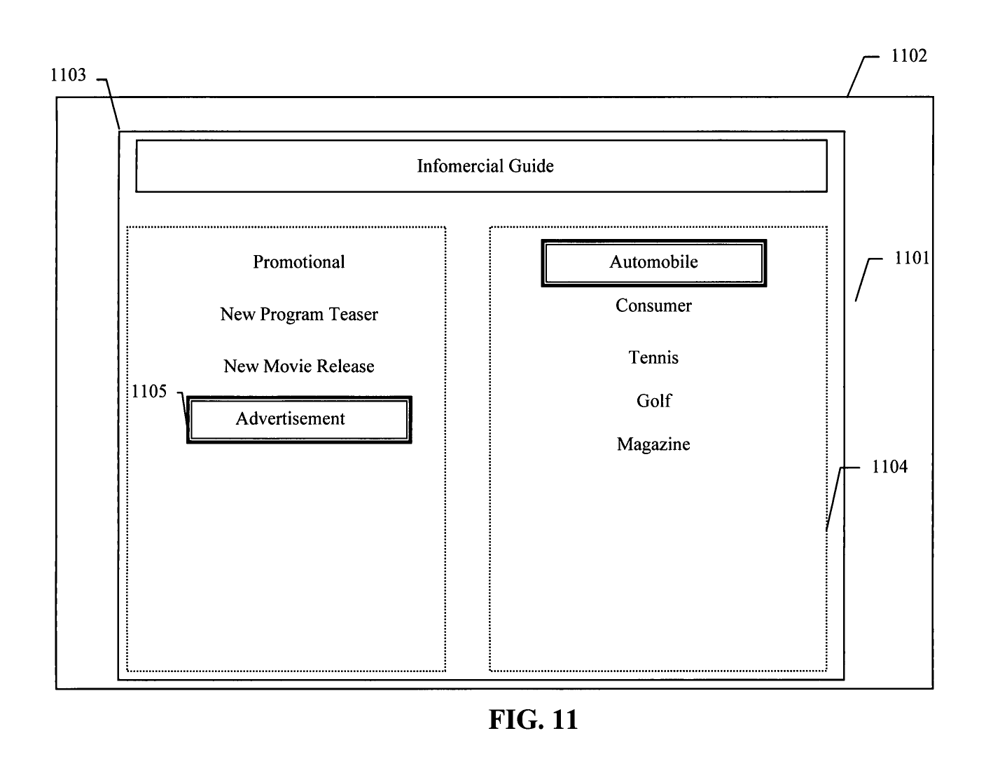

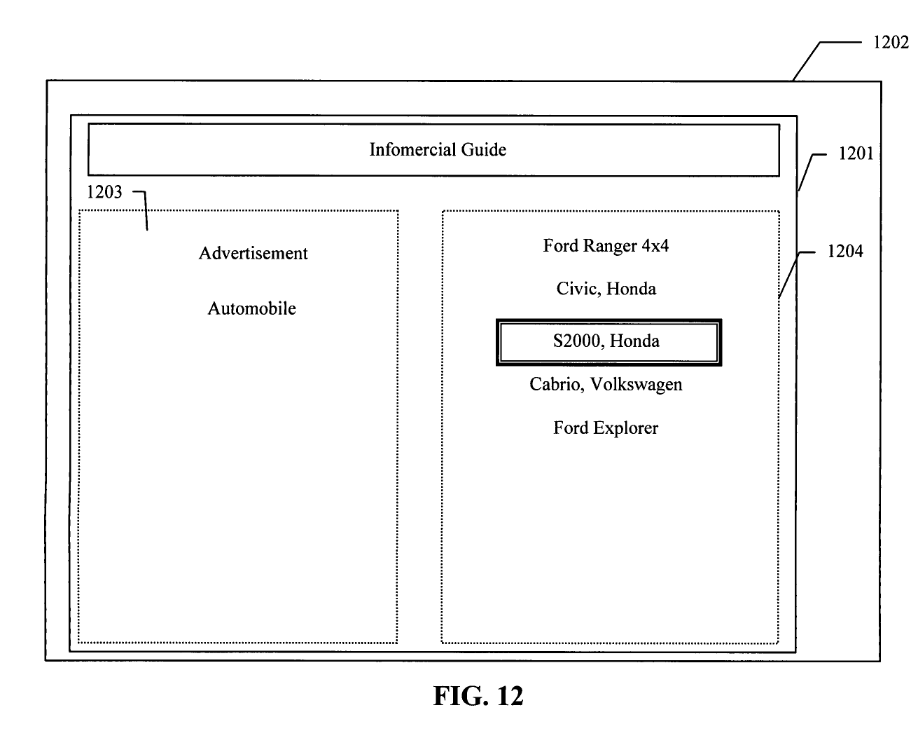

FIG. 11 is a depiction (screen shot) of an exemplary GUI for an infomercial (including commercials, advertisements, and the like) guide. Firstly, by pressing a dedicated key (on the remote control) for the infomercial guide, the GUI 1101 is displayed on a display device 1102 such that a DVR user can select the infomercial(s) of their interest. The window 1103 on the left of the GUI 1101 may be dedicated to display the upper category of infomercials that are recorded or downloaded in the DVR. The upper categories of the infomercials are selected from any of the categorical genre table such as shown in FIG. 3. The user may then select the upper category of interest by moving the highlight cursor 1105, as by using a dedicated input device. The window 1104 on the right side of the GUI 1101 is dedicated to display a more detailed categorization of the categories shown in 1103. Therefore if a user selects an upper category from window 1103, as through a dedicated key from an input device, the additional detailed genre_category of infomercial segment(s) with the selected genre_category from 1103 may be displayed in the window 1104. The user then selects the detailed genre_category of interest from the window 1104. By selecting a genre category from the window 1104, a new GUI, such as the exemplary GUI 1201 in FIG. 12 having a window 1204 that shows titles of infomercial segments will be displayed on a display device 1202. Note that the titles of infomercial segments may simply be the texts delivered via the segment_message_text( ) field of the segment, as in Table 3. The titles of infomercial segments can guide users to select infomercials of their interest where the text in the window 1203 shows the category and sub-category from which the infomercial segments in 1204 are derived.

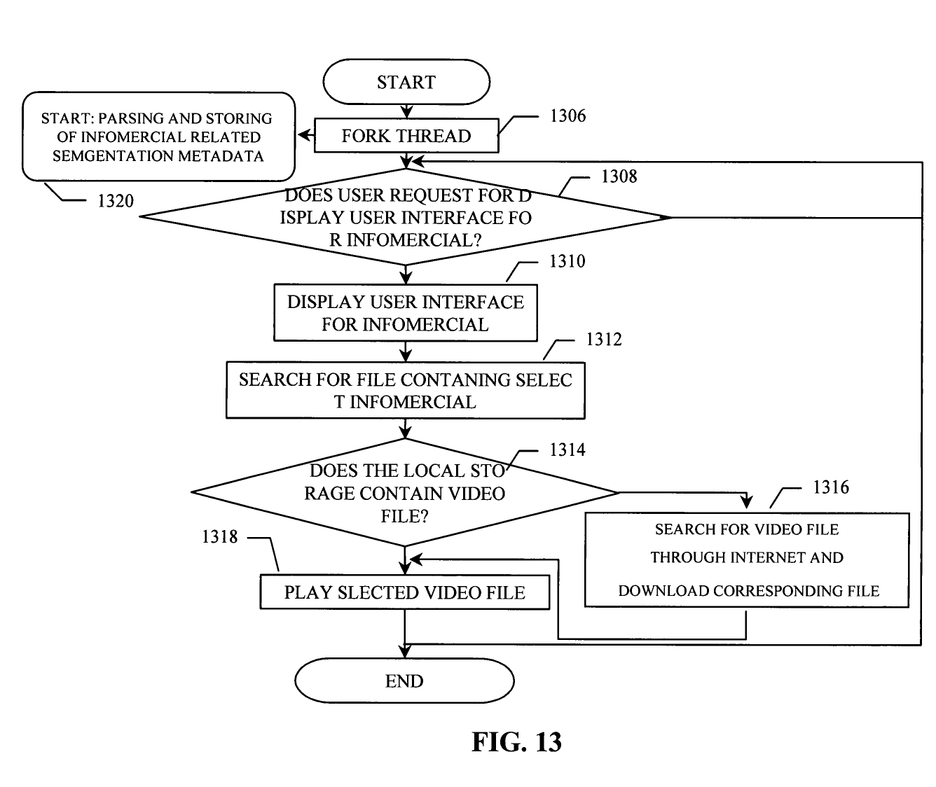

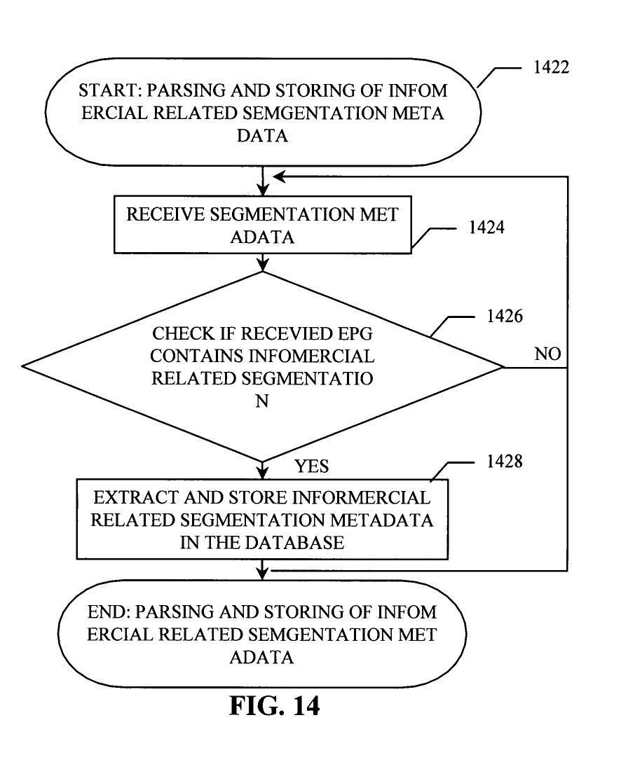

FIGS. 13 and 14 illustrate the overall process of for processing infomercials in the DVR. FIG. 14 illustrates the flow chart of the process for displaying and playing the infomercial where else FIG. 14 illustrates the flow chart of the process for parsing and storing infomercial related metadata. In FIG. 14 the DVR starts to parse and store infomercial related segmentation metadata in 1422 by receiving the EPG information in 1424 such as the ATSC-PSIP and DVB-SI and the EPG information is checked for infomercial related segmentation information in 1426. For example, the event_segment_descriptor( ) in the EIT of ATSC-PSIP or DVB-SI is verified to check if the value of the genre_category of the segment or a set of segment is “0x28” (Advertisement) or “0x53” (Information). If so, the corresponding infomercial metadata is extracted from the EPG and stored in the database of a DVR with additional information such as the PID, major/minor channel number, a visual feature of the first frame of the segment or the entire segment, start time of recording and the start time of the video stream which infomercial metadata references to in 1428. For managing the infomercial segments, it may be necessary for the DVR to keep a copy of an identical version of the infomercial segment. If a copy of an identical version of the infomercial segment is not available, there might occur cases where an infomercial segment in between a program may be lost due to the deletion of the program that contained it. Therefore, a user might want to keep and store a infomercial segmented related to a specific product even if a program that contained it is deleted. FIG. 13 illustrates the process for displaying and playing the infomercial. The process starts by forking a thread 1306 for parsing and storing infomercial related segmentation information in 1320. If a user requests for a user interface for infomercial in 1308, the graphical user interface such as those illustrated in FIGS. 11 and 12 are displayed on the display device in 1310. Upon user's request, the video file of the selected infomercial is searched in the local or associated storage of the DVR based on the database stored in 1428 in 1312. If the DVR cannot find the corresponding video file in the local storage of the DVR, it may download the corresponding video file from a video server based on the information available in the stored database in 1314 if the DVR is connected to internet in 1316. A detailed information related to the infomercial segment may also be obtained along with the video file for presentation. The last stage of the process for the infomercial is to play selected infomercial segment in 1318.

Although users can select the type of infomercial(s) to view in detail by selecting the infomercial(s) of interest, as through the GUI in FIG. 11, users can also select one or more genre type(s) from the categorical genre type such that all the infomercial(s) belonging to the selected genre type(s) are continuously played on the display device. Therefore, if a user has interest in automobiles, the user does not have to search for a specific model but may look through all the infomercial that are available on the subject of “automobile.” This optional presentation of infomercial can be advantageously used for new movie releases. Since the user is not aware of the title of new movies when they are announced, the user can simply select the genre category “new movie release” to continuously look through all infomercial(s) belonging to a new movie release to select a movie to see at a later time.

Alternatively, the advertisement(s) stored in a DVR can be played while a user is watching a live/recorded program in the DVR. Based on the teachings set forth herein, it is a straightforward matter for the DVR to keep track of the user preference(s) specified by a user as well as by being obtained by analyzing a user history such that the original advertisement in the live/recorded program can be replaced/inserted by one or more other advertisement(s) belonging to the genre type from the user history stored in the DVR.

The optional presentation of infomercials allows viewers to see those categories of commercials from the infomercials collected not only from the scheduled programs set to record, but over all recorded periods (even outside of the programs). In other words, the system can search for and selectively record target type advertisements. Alternatively, a run of commercials can be just shown to viewers.

7. Scrambling of Segmentation Information

In some cases, segmentation information should be scrambled or encrypted to protect its value (for the same reason that content is scrambled or encrypted) itself as well as to prevent it from being misused for commercial skipping. In other words, segmentation information should be accessible only to those who are authorized or permitted by providers. An example is described where segmentation information is scrambled in the case of PSIP.

The PSIP specification has constraints on the TS packets carrying the EIT table. One of the constraints for the TS packets carrying the EIT table is that the transport_scrambling_control field-bit in the TS header should have value “00” which signifies that the TS carrying the EIT table should not be scrambled. Therefore, the segmentation information carried inside the EIT table through the event_segment_descriptor( ) may not currently be scrambled. Various approaches are now described which will allow for the scrambling of segmentation information by extending or modifying the current technologies.

A first approach is to modify the PSIP specification or permit a modified specification, such that the EIT table can be scrambled at the TS packet level. Thus, the TS packets carrying the EIT tables should be allowed to have the values “10” or “11” in addition to the value “00” that is currently only permitted as defined in Table 4.

TABLE 4
Transport_scrambling_control field value definition.

| Bit Value | Description |
|---|---|
| 00 | No scrambling of TS packetload |
| 01 | Reserved |
| 10 | Transport packet scrambled with even key |
| 11 | Transport packet scrambled with odd key |

Although the PSIP currently has a constraint on the EIT table such that it is not scrambled, DVB-SI allows the current EIT schedule table to be scrambled where the EIT schedule table should be identified in the PSI (Program Specific Information). Service_id value 0xFFF is allocated to identifying a scrambled EIT, and the program map section for this service shall describe the EIT as a private stream and shall include one or more CA_descriptors which give the PID value, and optionally, other private data to identify the associated Conditional Access (CA) streams. Therefore, in case one wants to scramble the disclosed event segmentation information, one can insert the event segment descriptor in the TS containing the scrambled EIT schedule table.

A second approach for scrambling segmentation information is by defining a new table which is exemplarily called the Segmentation Information Table (SIT). The SIT table is an independent table which contains information on segments for an event which can be scrambled in TS level.

The SIT section should be carried in private sections with table ID from 0xE6 to 0xFE which is currently reserved for future ATSC use. The SIT section for an event is carried in a home physical transmission channel (the physical transmission channel carrying that virtual channel or event) with PID specified by the field table_type_PID in corresponding entries in the MGT. The table_type_PID value should have a value currently reserved for future ATSC use in 0x0006-0x00FF, 0x180-0x1FF, 0x280-0x300, 0x1000-0x13FF, 0x1500-0xFFF. This specific PID is preferably exclusively reserved for the SIT stream. The following constraints apply to the TS packets carrying the SIT section.

The PID for STT should have the same value as the field table_type_PID in corresponding entries in the MGT, and should be unique among the collection of table_type_PID values listed in the MGT. The transport_scrambling_control bits should have the values as shown in Table 4.

If a scrambling method operation over TS packets is used (transport_scrambling_control_field is ‘01’ or ‘11’) it may be necessary to use a stuffing mechanism to fill from the end of a section to the end of a packet so that any transitions between scrambled and unscrambled data occur at packet boundaries. The adaptation_field_control should have the value ‘01’. An exemplary bit stream syntax for the SIT is as shown in Table 5.

TABLE 5
bit stream syntax for the SIT

| Syntax | Bits | Format or Note |
|---|---|---|
| segment_information_table{ | | |
| table_id | 8 | 0xE6-0xFE |
| section_syntax_indicator | 8 | ‘1’ |
| private_indicator | 1 | ‘1’ |
| reserved | 2 | ‘11’ |
| section_length | 12 | Number of remaining bytes in the |
| | | section following section_field |
| SIT_table_id_extension | 16 | Serves to establish uniqueness |
| | | of each SIT instances with same |
| | | PID |
| reserved | 2 | ‘11’ |
| version_number | 5 | Indicates the version number of |
| | | the SIT |
| current_next_indicator | 1 | ‘1’ |
| section_length | 8 | 0x00 |
| last_section_number | 8 | 0x00 |
| protocol_version | 8 | Protocol version number |
| SIM_id | 32 | Unique 32-bit identifier for the |
| | | following descriptor in this table |
| descriptor_length | 12 | Total length of the descriptor |
| | | that follows |
| for (i=0;i<n;i++){ | | |
| descriptor( ) | | |
| } | | |
| CRC_32 | 32 | |
| } | | |

The table_id identifies this section as belonging to the SIT. This 1-bit field shall be set to ‘1’. It denotes that the section follows the generic section syntax beyond the section length field. The private_indicator is a 1-bit field which shall be set to ‘1’.

The section_length comprises a 12-bit field specifying the number of remaining bytes in the section immediately following the section_length field up to the end of the section. The value of the section_length shall be no larger than 4093 (only 12 bits are allocated to specify the section_length field making 4093 the maximum value for section_length field).

The SIT_table_id_extension comprises a 16-bit unsigned integer value that serves to establish the uniqueness of each SIT instance when tables appear in TS packets with common PID values. The SIT's table_id_extension shall be set to a value such that separate SIT instances appearing in transport stream packets with common PID values have a unique SIT-table_ID_extension value.

The version_number comprises a 5-bit field indicating the version number. The version number shall be incremented by 1 modulo 32 when any data in the SIT changes.

The current_next_indicator comprises a 1-bit indicator which is always set to 1.

The section_number comprises an 8-bit value which always should be 0x00.

The last_section_number comprises an 8-bit value which should always be 0x00.

The protocol_version comprises an 8-bit unsigned integer whose function is to allow, in the future, this table type to carry parameters that may be structured differently than those defined in the current protocol. At present the only valid value for protocol_version is zero.

The SIM_id comprises a 32-bit identifier of this SIT information. This identifier is assigned by the rule as shown in Table 6.

TABLE 6
SIM_id.

| | |
|---|---|
| MSB | LSB |

| | | | |
|---|---|---|---|
| Bit | 31 . . . 16 | 15 . . . 2 | 00 |
| SIM_id | source_id | event_id | 00 |

The descriptor_length is the length of the segmentation information descriptor that follows. Although more descriptors may be included, the current SIT table should include the event_segment_descriptor( ).

The CRC_{—}32 comprises a 32-bit field that contains the Cyclic Redundancy Check (CRC) value that ensures a zero output from the registers in the decoder defined in ISO-13818-1 “MPEG-2 Systems” after processing the entire SIT section.

A third approach is to define a privately structured event segment descriptor by only defining the descriptor tag number for the descriptor to deliver the segmentation information and leave the structure of the descriptor to be privately defined by segmentation information provider so that the segmentation information is not accessible to those who do not have knowledge on the structure. Table 7 illustrates the syntax of a privately structured event segment descriptor. Table 7. Privately Structured event segment descriptor

TABLE 7
Privately Structured event segment descriptor

| Syntax | Bits | Format or Note |
|---|---|---|
| Descriptor_tag | 8 | 0x88 |
| Descriptor_length | 8 | Number of bytes |
| | | following this field |
| SI_system_ID | 16 | Indicate the type of |
| | | segmentation information |
| | | system application for |
| | | the information conveyed |
| | | in this descriptor. The |
| | | coding information |
| | | conveyed in this |
| | | descriptor is privately |
| | | defined |
| for(i=0 ; I < descriptor_length−2;i++) | | |
| private_data_type( ) | | |

The privately structured event segment descriptor has a descriptor tag field value of 0x88 which identifies this descriptor as the event segment descriptor. The descriptor length is the length (in bytes) for the fields immediately following this field up through the end of the event segment descriptor.

The SI_system_ID comprises a 16-bit value used to identify the type of segmentation information system application for the information conveyed in this descriptor. The coding information conveyed in this descriptor is privately defined in the private_data_type.

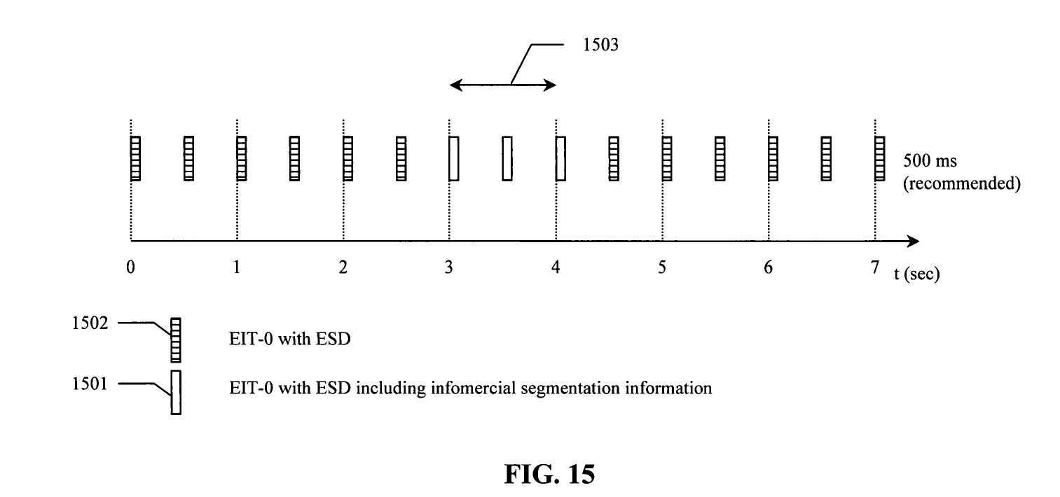

Another approach for reducing commercial skipping is to send the critical information to STBs for a short period of time to reduce its risk of being misused. FIG. 15 illustrates the cycle at which EIT-0 is transmitted in the TS. In this embodiment, the skipping of advertisements is effectively reduced by only sending the infomercial segmentation information occasionally at appropriate times as illustrated in FIG. 15. For example, the blocks 1502 represent EIT-0 table with ESD only while blocks 1501 represent EIT-0 with ESD including infomercial segmentation information. Since the ESD including infomercial segmentation information is only transmitted 3 times during period 1503 the infomercial segmentation information is not available at other times. Thus, DVRs are required to be operated to process the delivered information as soon as they are delivered by first copying the parts of TV programs containing the corresponding commercials into a local or associated storage and deleting the delivered and stored segmentation information on where the commercials appear on the TV programs.

8. Targeted Advertisement Through Automatic Recording in DVR

A method and system is disclosed to enable the automatic recording of broadcast TV programs for targeted audiences. Such demands have arisen because TV home shopping providers want to increase profits by ensuring that their specific TV home shopping programs are directed to the appropriate audiences. For example, TV home shopping programs for luxurious products directed to VIP customers are usually on-air at the deepest hour of the night since it is too expensive for a popularity of people to buy them and rouses antipathy amongst ordinary people. Therefore, it is not convenient for VIP potential customers to watch the advertised products of their interests for ordering. As disclosed and presented herein, a technique is provided for automatically recording specific TV home shopping programs and the like in STBs with storage through a conventional program guide protocol, allowing the TV viewers to view the recorded programs at anytime they want. This can increase home shopping channel providers' revenue. Furthermore, by utilizing the techniques disclosed herein, different products can be easily browsed where metadata information may include the additional information such as telephone number(s) and/or other contact information and/or price information and/or other information related to a product.

The automatic recording of a specific program broadcast on air is triggered through data, for example, embedded within the EPG protocols such as ATSC-PSIP and DVB-SI, respectively. The data for triggering the automatic recording of a program is inserted by preferably defining a new descriptor to be included in the EIT. Such a descriptor is called the “recording descriptor” which will now be disclosed in more detail.

The recording descriptor is used to describe the information necessary for automatically triggering the recording of a program. The exemplary recording descriptor in Table 8 comprises the following fields.

The descriptor tag comprises an 8-bit unsigned integer to identify the descriptor as the recording descriptor and should be defined to a value not reserved for currently defined descriptors in PSIP or SI.

The descriptor_length field comprises an 8-bit integer specifying the length (in bytes) for the fields immediately following this field through the end of the recording_descriptor.

The recording_flag field comprises a 1-bit unsigned integer that specifies whether the program should be recorded or not.

The provider_identifier comprises an 8-bit unsigned integer to uniquely identify the providers of the program(s) who wish to trigger the automatic recording of a program. This field is necessary considering the fact that few, if any, DVR owners would want any program to be recorded in their DVR without notice unless the DVR is free of charge or almost free of charge with the condition of always allowing any program to be automatically recorded. Therefore, providers such as the TV home shopping providers who wish specific programs to be recorded in a DVR might have the ownership of the DVR and in such cases would not wish for any other programs transmitted from competing providers to be recorded in the DVR.

TABLE 8
bit stream syntax for recording_descriptor
inserted in EIT tables

| Syntax | Bits | Format |
|---|---|---|
| recording_descriptor( ) { | | |
| descriptor_tag | 8 | 0x89 |
| descriptor_length | 8 | uimsbf |
| recording_flag | 1 | bslbf |
| reserved_future_use | 7 | bslbf |
| provider_identifier | 8 | uimsbf |
| } | | |

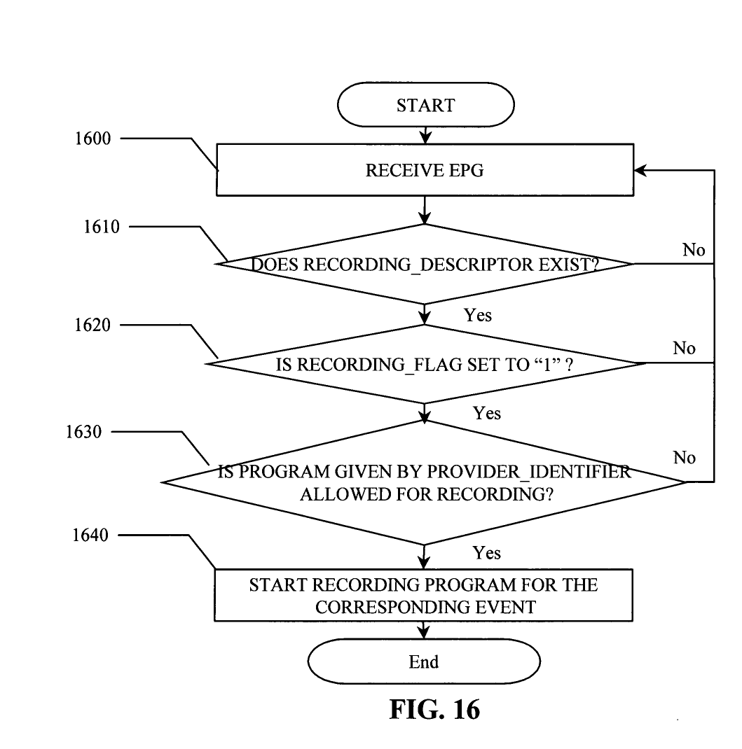

Given the recording_descriptor, the method of how the data received at the TV viewer's STB should be processed for use is hereby described in detail. FIG. 16 is a flow chart showing how the automatic recording for a program is triggered.

First, the DVR receives the EPG at 1600 to verify at 1610 whether the recording_descriptor exists. If so (positive result, step 1610), it verifies the recording_flag within the recording descriptor at step 1620 to identify whether the corresponding program should be recorded automatically or not. Secondly, even if the recording_flag is set for automatic recording, the recording is denied by the application in the DVR if the provider identified by the provider_identifier field is not allowed to automatically recording at step 1630. If the provider given in the provider_identifier field is allowed to automatically record the program, the recording is then initiated, as at step 1640. Alternatively a notice can be given to the viewer requesting permission to record the program—such an automatic notice for recording would be preferred. All of the steps loop back, as shown, based on negative results.

For the automatic recording of broadcast TV programs, the user's preferences can be taken into consideration. For example, the user history for a DVR can be analyzed locally such as in the DVR, or remotely, such as in a server, to estimate user preference(s), and user preference(s) can be used to choose which programs to record. Alternatively, if TV home shopping providers or the like have user preferences for their customers, the information related to user preference(s) can be sent to the DVR, such as through a network for automatic recording. Alternatively, the user preference(s) can be specified by users.

9. Delivery and Presentation of Content-Relevant Information associated with Frames

Product Placement (PPL) is a common and effective advertising method. In a movie (such as “Minority Report” directed by Steven Spielberg), there are many PPL advertisements such as automobile, perfume, watch, beverage and credit card. PPL is also big business for TV shows such as “The Oprah's Winfrey Show” and “Sex & the City” that have launched. TV viewers might want to know more information about merchandises, distributor, retailer, etc. While TV viewers watch TV programs, they sometimes want to buy merchandise. But, most of viewers lack information of merchandise due to the restricted nature of broadcasting.

It would be advantageous if TV viewers can retrieve information on the contents (for example, objects, items, concepts and the like) associated with a frame or a set of frames (AV segments) when they watch TV or AV programs. For example, viewers may want to know the names of actors or actresses who appear in a scene of a movie, or the names of players for sports game while watching. On the other hand, TV service or content providers may want to provide advertisement relevant to the content of frame(s) or current viewing time (for example, dinner time).

If there is a simple way of representing and localizing/pointing a specific frame(s)/time(s) of a recorded AV program/stream or live TV is available, viewers should be able to retrieve the content-relevant information on products, actors, players and others shown in the frame(s) as well as to buy items associated with the frame(s). In other words, the information relevant to the content of target frame(s) selected by viewers or information providers (or viewing time) could be delivered to STBs or DVRs by (third-party) information or metadata service providers through back channel if the information of how to accurately localize the target frames pointed by viewers is delivered to information providers. For the purpose of disclosure, the term “back channel” is used to refer to any wired/wireless data network such as Internet, Intranet, Public Switched Telephone Network (PSTN), Digital Subscriber Line (DSL), Integrated Services Digital Network (ISDN), cable modem and the like. Methods and apparatus are herein disclosed to deliver and present the content-relevant information associated with the target AV frame(s) (or AV segments), or the viewing-time dependent information. In this disclosure, the information of how to identify or localize the target frame(s) is called “content locator”, which is usually requested by viewers to frame-associated information server. The frame-associated information is retrieved by using the content locator which links the target frame(s) to the information relevant to the target frame(s) (or a short time before or after the target frames). The content locator for a target frame(s) may be defined or represented by using any information that can identify or locate the target frame(s), for example, through one or a combination of the followings:
1. Broadcasting time for the target frame, obtained from the media locators disclosed in “Section 1 Media Localization.”
2. Broadcasting time for the target frame obtained through the Internet (NTP, UTC time, GPS time): Internet time of the target frame may be used for content locator. Sampled Internet time may be associated to each frame of AV programs for content locator.
3. Media time of the target frame(s)
4. Bitstream of the target frame(s): A portion of compressed video or audio stream of the target frame(s) may be used for content locator.
5. Metadata associated with the target frame(s) including AV feature vectors (such as color histogram, visual rhythm) or description
6. Channel number of the target frame(s)
7. Program title of the target frame(s)
8. Multimedia bookmark: A content characteristic such as thumbnail image along with time pointer or media locator (for example, Internet time, system_time field in STT and the like described above) associated with multimedia bookmark may be utilized for content locator.

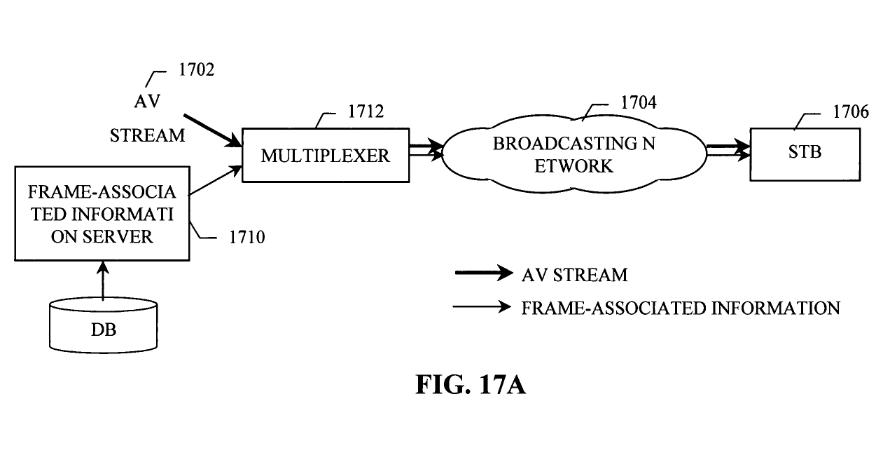

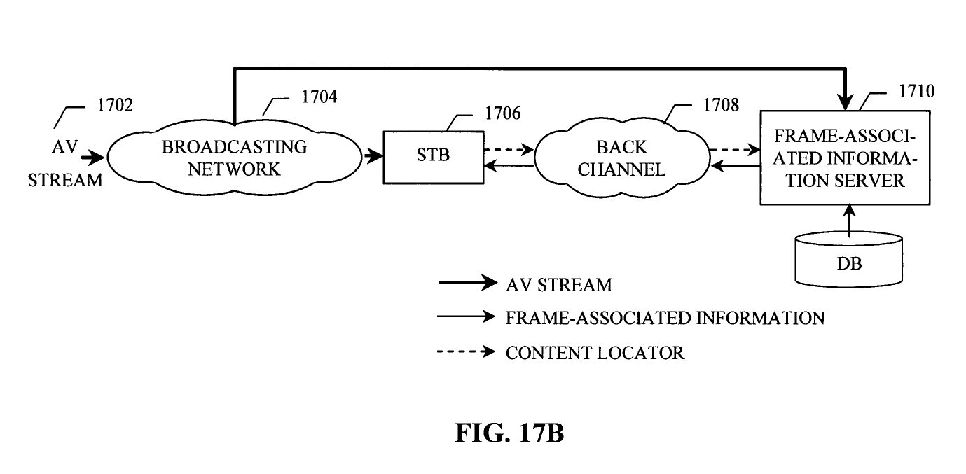

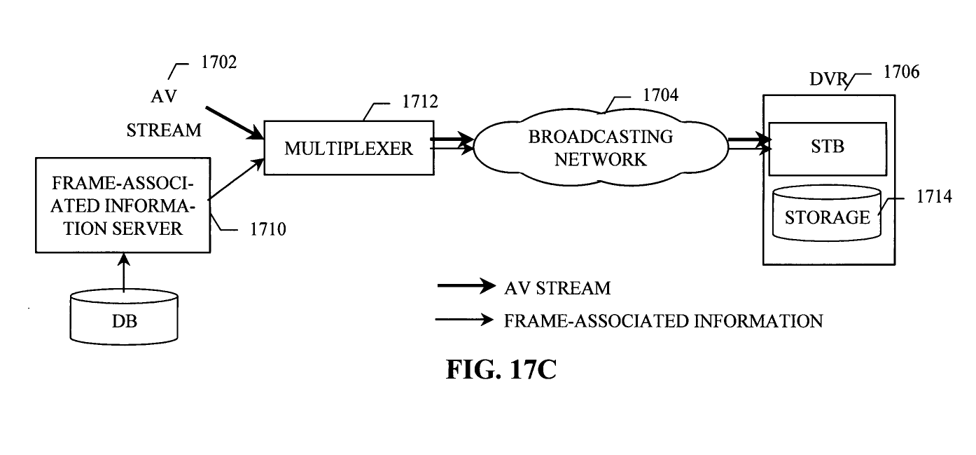

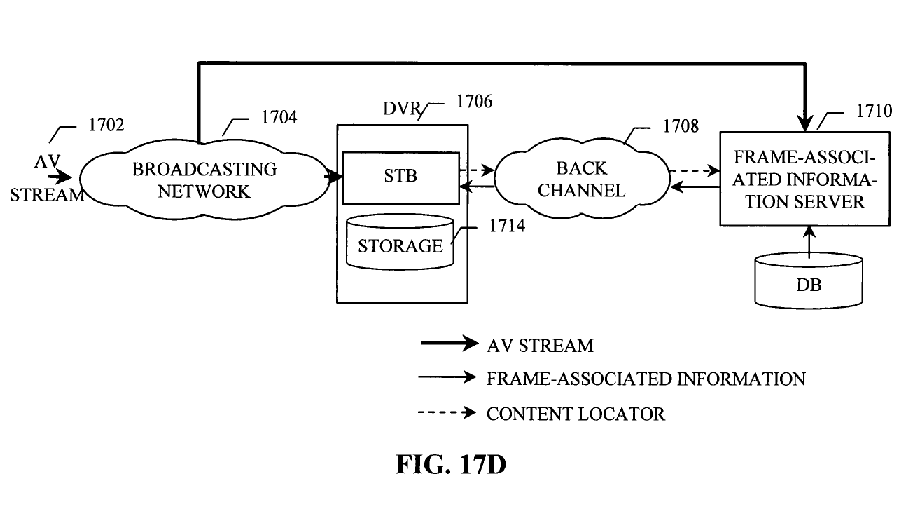

FIGS. 17A-D are diagrams of exemplary frame-associated information service schemes for providing the information relevant to frame(s) of AV programs when AV programs are delivered to STB or DVR through broadcasting network (or using streaming through any data network such the Internet). The similar schemes can be applied to provide the information relevant to the time when a program is viewed, whether it is currently on-aired or recorded. It is noted that the disclosed schemes for providing the information relevant to frame(s) can be also applied to AV programs stored in DVD, Blu-ray Disc (BD), High Definition—Digital Video Disc (HD-DVD) or alternative storage media, by using media time for the target frame(s), for example.

FIG. 17A is a diagram of an exemplary service scheme that frame-associated information is broadcast from the broadcaster, to STBs. It is herein noted in this disclosure that the same AV streams are available to both STBs 1706 or (DVRs) and the frame-associated information server 1710. The server 1701 could consist of a variety of modules including (real-time) indexer or generator of content-relevant information associated with the frames of the AV streams, and the storage or database (DB) for recording or storing (broadcast) streams as well as the content-relevant information. The frame-associated information server 1710 having frame-associated information of a current program sends the information to multiplexer 1712 which multiplexes the broadcast AV stream 1702 and the information. The multiplexed stream is transmitted to a STB 1706 through broadcasting network 1704. Since the STB client is assumed to have no recording capability, a broadcaster sends the frame-associated information of a currently broadcasting or target AV program which is generated prior to broadcasting or in real-time. The pre-generated frame-associated information is synchronized with the current frame(s) using a content locator whereas the real-time indexed or generated frame-associated information could have latency as in real-time closed-caption generation.

FIG. 17B is a diagram of an alternative service scheme that the frame-associated information is delivered to STBs from (third-party) information service provider. By sending the content locator to the frame-associated information server 1710 of the service provider through back channel 1708, a STB 1706 receives the frame-associated information automatically or by viewer's request from the server 1710 though back channel 1708, while the STB 1706 receives a current broadcasting stream 1702 through broadcasting network 1704.

FIG. 17C is a diagram of an alternative service scheme that the frame-associated information is broadcast from the broadcaster. The frame-associated information server 1710 having frame-associated information of broadcast AV programs sends the information to multiplexer 1712 which multiplexes the information and the broadcast AV stream 1702. A DVR 1706 or a STB having recording capability receives the multiplexed stream through broadcasting network 1704 and records the stream to storage. It is possible that the broadcaster sends frame-associated information of the current program as well as the past programs because a DVR has recording capability.

FIG. 17D is a diagram of an alternative preferred service scheme that the frame-associated information is obtained from the (third party) information provider. A DVR 1706 receives a broadcast stream 1702 through the broadcasting network 1704 and stores it to a local storage 1714. If a viewer requests the frame-associated information while he/she watches a live or recorded program, the DVR 1706 sends content locator for the target frame(s) to the frame-associated information server 1710 through back channel 1708. By using the content locator, the server 1710 searches its database for the frame-associated information and then returns the information associated with the target frame(s) to the DVR 1706 through the back channel 1708. It is noted herein that, by using content locator, the target frame(s) can be identified by the server 1710. Alternatively, the whole or part of content-relevant information associated with the target frame(s) delivered from the sever 1710 can be stored in the local storage 1714 and the list of the available content-relevant information can be presented to the viewer.

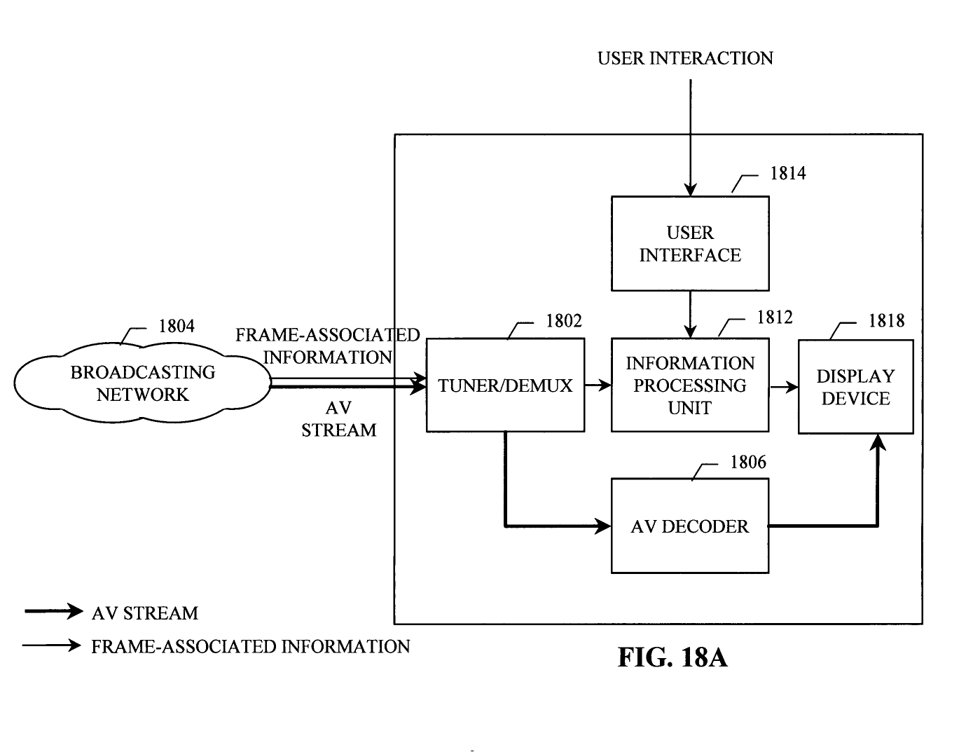

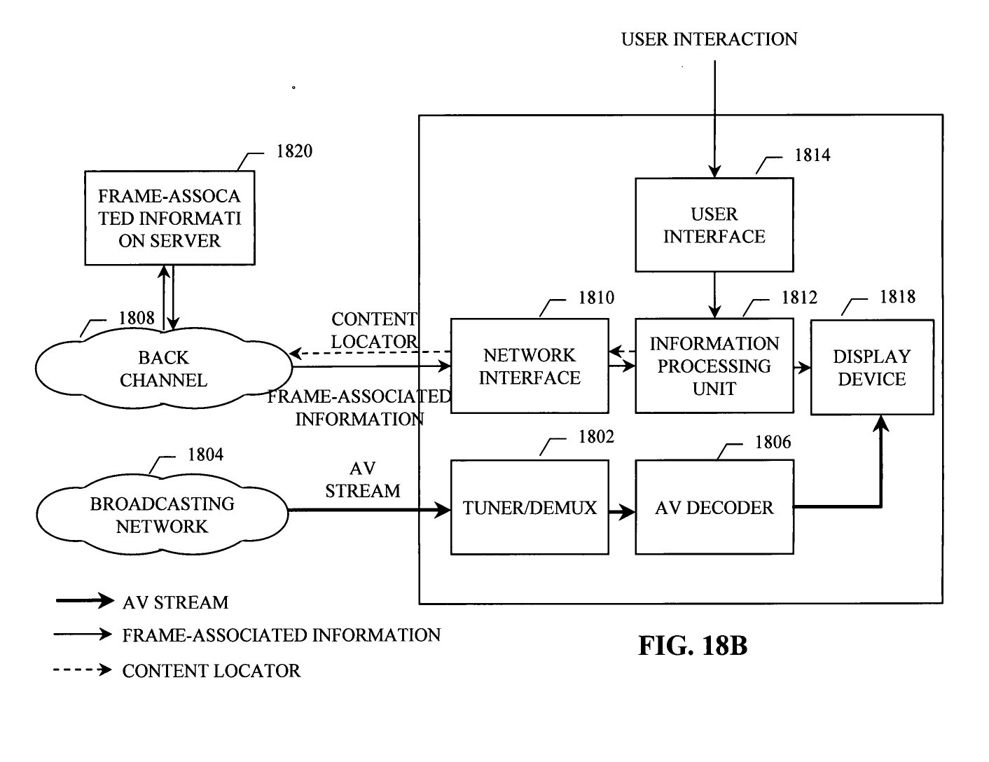

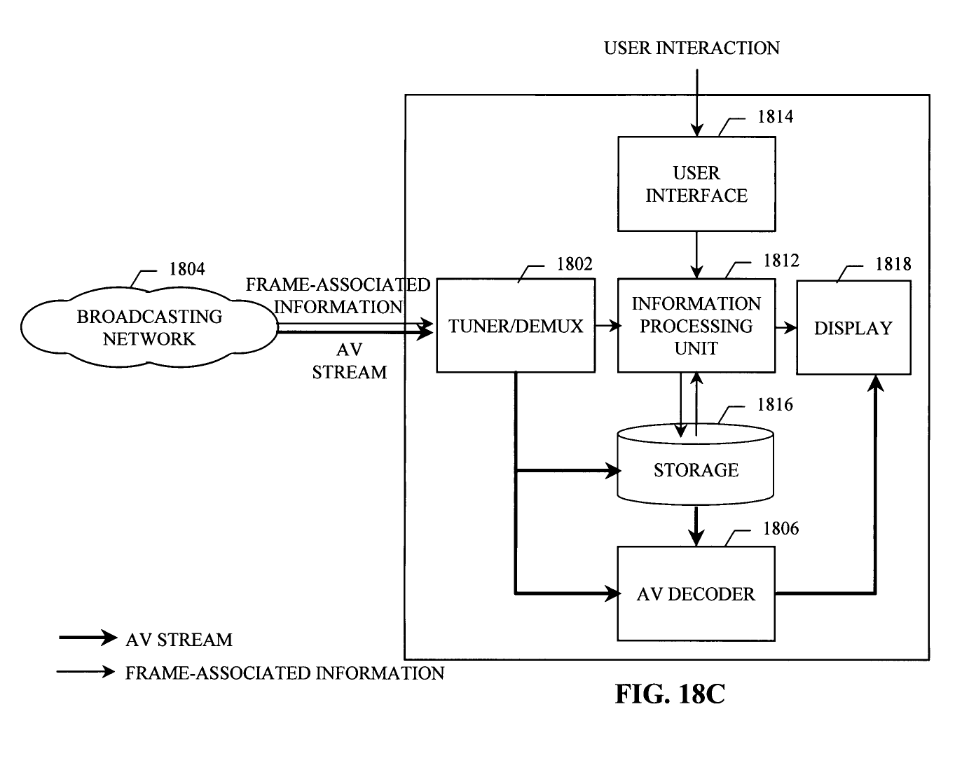

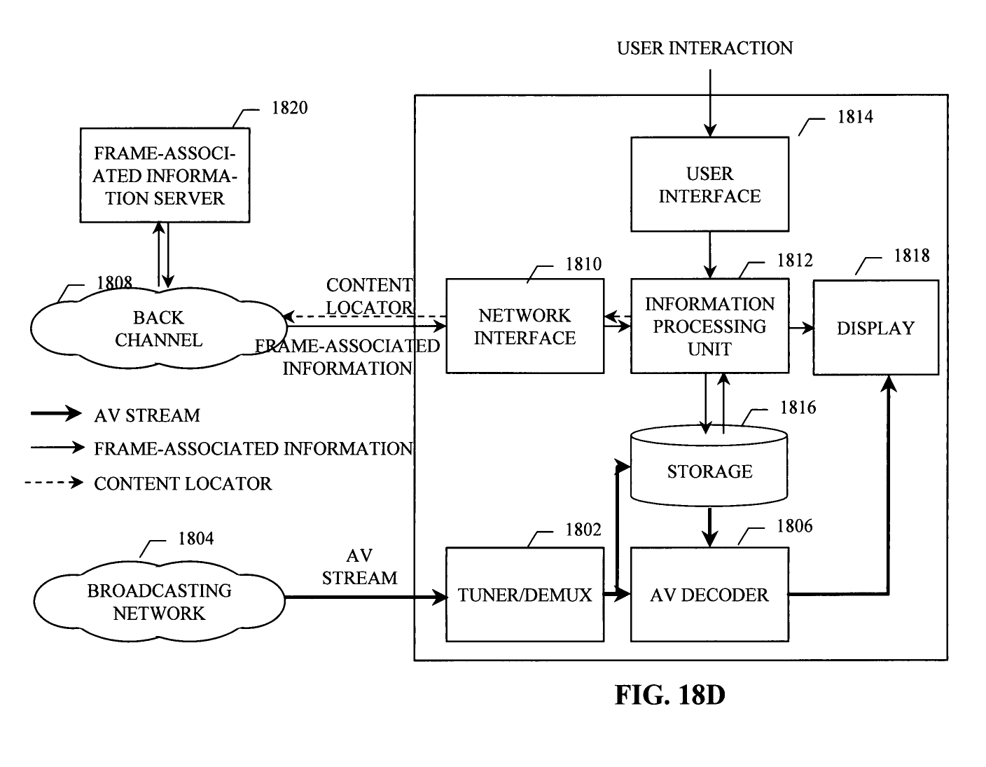

FIGS. 18A-D are block diagrams of describing the exemplary client STBs or DVRs in more details shown in FIGS. 17A-D for processing the information relevant to the target frame(s) of AV programs transmitted through broadcast network (or data network).

FIG. 18A is a block diagram of an exemplary client STB for processing the frame-associated information multiplexed into broadcast stream through broadcasting network. Through broadcasting network 1804, broadcast streams, such as in MPEG-2 TS, into which AV streams and their frame-associated information are transmitted to the STB. The tuner/demux 1802 receives and demodulates the broadcast signal for a channel selected by a STB user and then demultiplexes the broadcast stream into the AV streams and the frame-associated information. The AV stream is decoded by AV decoder 1806 and displayed on display device 1818. An information processing unit 1812 processes the frame-associated information from 1802 and displays an indicator such as icon on display device 1818 when the information relevant to the currently displayed frame(s) such as the name of an actress/actor or items (rings, earrings, cloths and so forth) is available. The information processing unit 1812 may be set in various ways to configure when an icon should be displayed. For example, the information processing unit 1812 may be set by viewers to show the indicator when current frame(s) contains viewers' pre-request information of a specific product (for example, “Always look for Toyota RAV4's and get me information”), or products related to user preferences obtained (stored in memory of the STB not shown in FIG. 18A) from past purchase habits and request types (for example, “You already have one of these each in red and blue and/or you may want to look at these shoes, since they are of the type you usually ask about). The information processing unit 1812 may also be set by viewers to recursively or repeatedly go to get the information (for example, “I am not ready to buy now. So, keep updating my information and ask me again”). The information processing unit 1812 may also be set to show an icon when currently displayed frame(s) contains products specified by information provider. If a viewer wants to see the detailed information on the current frame(s) when an indicator is displayed while watching the AV stream, the viewer can send the request to the information processing unit 1812 through a user interface 1814 and then the information processing unit 1812 displays the frame-associated information on display device 1818. Since the broadcaster may send the frame-associated information delayed due to real-time generation, the viewer may select the current frame and information processing unit 1812 can wait for delayed frame-associated information to be delivered and then display the frame-associated information on display device 1818.

FIG. 18B is a block diagram of an alternative STB for processing the frame-associated information from the frame-associated information service provider through back channel. An AV stream is transmitted from broadcasting network 1804. The tuner/demux 1802 receives and demodulates the broadcast signal for a channel selected by a STB user and then demultiplexes the broadcast stream into the AV stream. The AV stream is decoded by AV decoder 1806 and displayed on display device 1818. An information processing unit 1812 sends the content locator for the currently displayed target frame(s), as described previously such as a combination of channel number and system time marker or video bookmark, to the frame-associated information server 1820 through network interface 1810 and back channel 1808. The frame-associated information server 1820 searches its database and delivers the frame-associated information associated with the target frame(s) to the information processing unit 1812. The information processing unit 1812 displays an indicator on display device 1818 when information relevant to the current frame is available. The information processing unit 1812 may be set in various ways to configure when an indicator should be displayed. If a viewer wants to see detailed information of the current frame(s) while watching the AV stream, he/she sends his/her request to the information processing unit 1812 through a user interface 1816 and then the information processing unit 1812 displays it on display device 1818. Since the information provider can send the information delayed due to the real-time generation of frame-associated information, the viewer may select current frame and the information processing unit 1812 can wait for later provided information or search the frame-associated information server and display the information on display device 1812. Such search can be once, periodic, or occasional to obtain update information.

FIG. 18C is a block diagram of an alternative DVR for processing the frame-associated information multiplexed into broadcast stream through broadcasting network. Through broadcasting network 1804, broadcast streams, such as in MPEG-2 TS, into which AV streams and their frame-associated information are transmitted to the DVR. The tuner/demux 1802 receives and demodulates the broadcast signal for a channel selected by a DVR user and then demultiplexes the broadcast stream into the AV streams and the frame-associated information. The AV stream is stored in local storage 1816, such as hard disk, decoded by AV decoder 1806 and displayed on display device 1818. An information processing unit 1812 also stores the frame-associated information from 1802 into the local storage 1816. If a viewer wants the frame-associated information of the currently displayed frame(s) for the live broadcast program, the information processing unit 1812 retrieves the information. If the viewer wants the frame-associated information of the currently displayed frame(s) of a recorded program, he/she sends his/her request to a user interface 1814 and then the information processing unit 1812 retrieves the frame-associated information from the storage 1816 and displays it on display device 1818.

FIG. 18D is a block diagram of an alternative preferred client DVR for processing the frame-associated information from the frame-associated information service provider through back channel. An AV stream is transmitted from broadcasting network 1804. The tuner/demux 1802 receives and demodulates the broadcast signal for a channel selected by a DVR user and then demultiplexes the broadcast stream into the AV streams and the frame-associated information. The AV stream is recorded into local storage 1816, decoded by AV decoder 1806 and displayed on display device 1818. The information processing unit 1812 sends the content locator of the currently displayed frame(s) to frame-associated information server 1820 through network interface 1810 and back channel 1808. Then, the frame-associated information server 1820 retrieves and delivers frame-associated information associated with the target frame(s) to the information processing unit 1812. If the information relevant to current frame is available, the information processing unit 1812 displays an indicator on display device 1818. Alternatively, the whole or part of content-relevant information associated with the target frame(s) delivered from the sever 1820 can be stored in the local storage 1816 and be accessed later by the viewer. The information processing unit 1812 may be set in various ways to configure when an indicator should be displayed. If the viewer wants the frame-associated information of currently displayed frame(s) for the live broadcast program, the information processing unit 1812 retrieves the information as described in FIG. 18B. If the viewer wants the frame-associated information of the target frame(s) for the recorded program, he/she sends his/her request to a user interface 1814 and then the information processing unit 1812 retrieves the frame-associated information from the frame-associated information server through the back channel 1808, or alternatively from local storage 1816 if the stored information is available, and displays the frame-associated information on display device 1818.

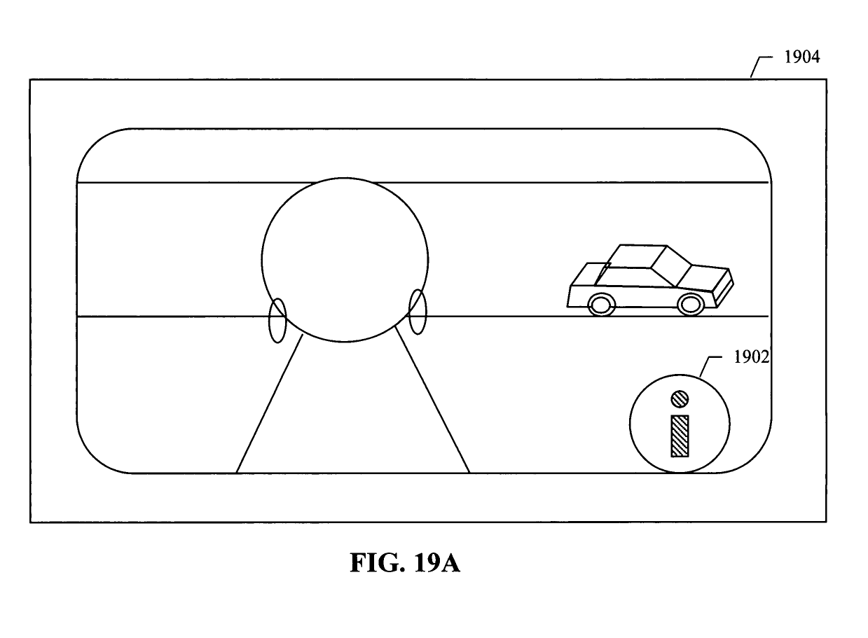

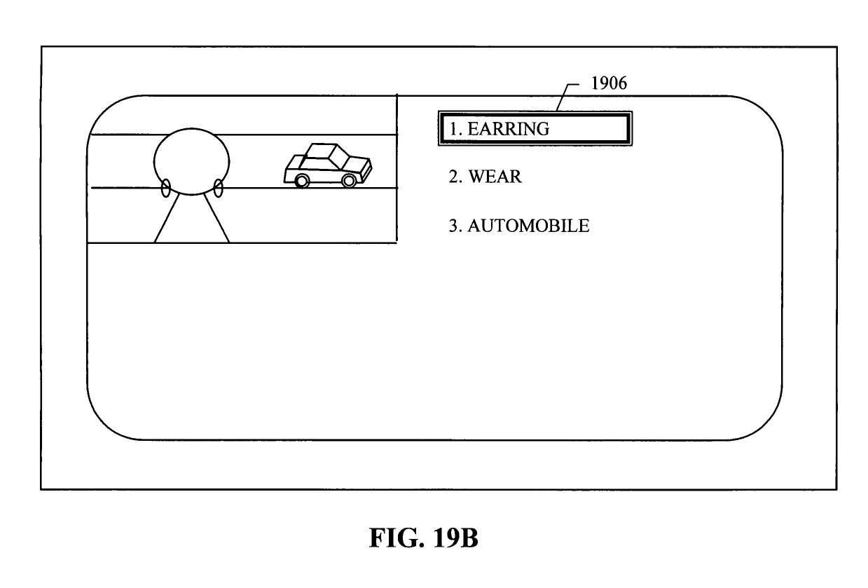

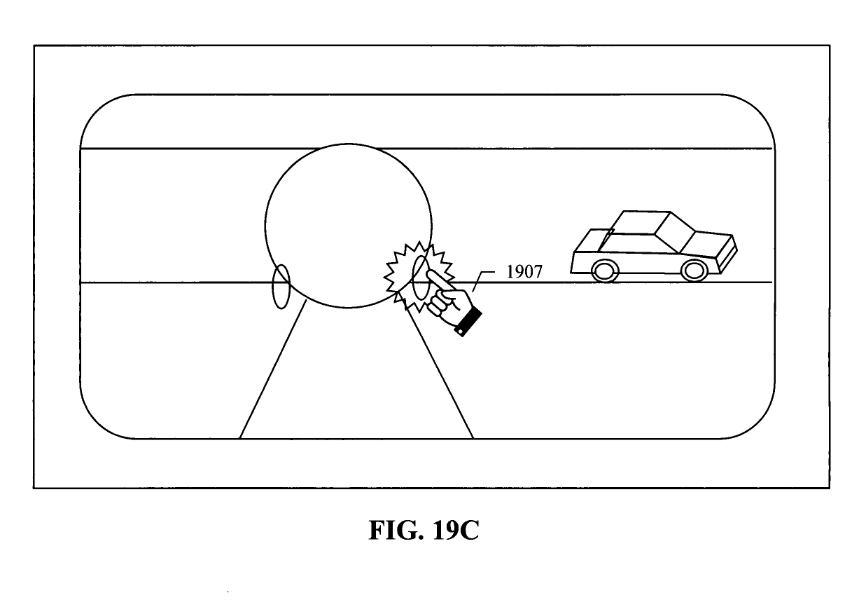

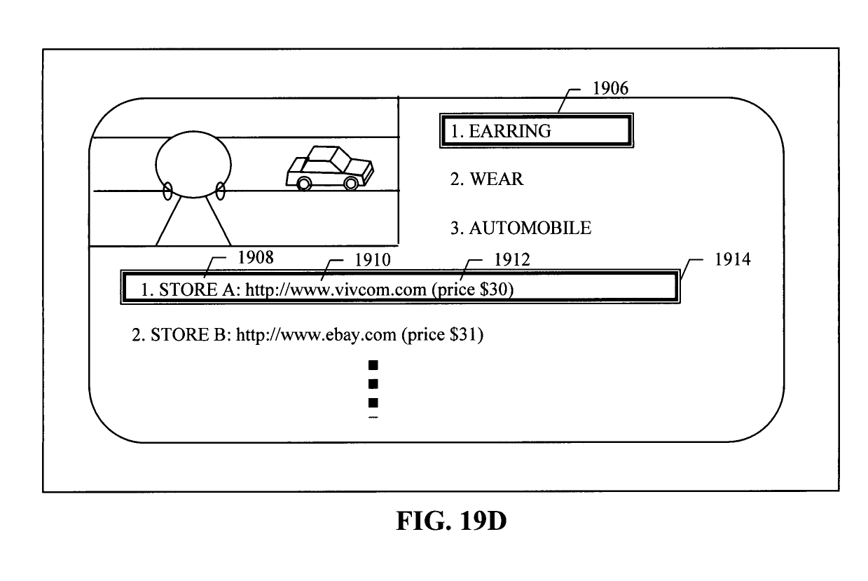

FIGS. 19A, 19B, 19C and 19D are exemplary GUIs for TV viewers. These GUIs are useful for TV viewers who want the frame-associated information. When the information associated with currently displayed frame(s) while viewers watching is available, an icon 1902 can be embedded, overlaid, or displayed in off-screen (for example, in letterbox black area), or transparently (for example, always a set part of the screen, as in the lower right 10%) on the display device 1904 shown in FIG. 19A. FIG. 19B is an exemplary GUI for showing the item selected by a viewer. If the viewer wants to retrieve the frame-associated information, they can view it using a user interface such as a dedicated button (on the remote). Then, the information processing unit 1812 in FIGS. 18A-D obtains the content locator of the current frame(s), retrieves the frame-associated information from broadcast stream, frame-associated information server, or storage. Then, the information processing unit may display or overlay the list of items in the frame-associated information, or pause video and switch to information page, or show it later. If viewers want to see the detailed descriptions of listed items, viewers may select item number by changing colors/patterns of the selected item on screen 1906, or by using numeric keypad on the remote, or by directly clicking an item desired using a pointing device such as mouse or touch screen to select the item of interest. FIG. 19C is another exemplary GUI for selecting viewer's interested item. Viewers may directly select an item 1907 to see detailed descriptions using a pointing device, such as touch screen, another cursor for mouse, voice control, or other designator. FIG. 19D illustrates an exemplary GUI for displaying detailed descriptions of the selected item 1906 such as store name 1908, Internet address 1910, price 1912, and others. If viewers select one of the detailed information with the highlighted cursor 1914, a new detailed information page such as web browser may be displayed. In terms of business model, the store selected by the highlighted cursor 1914 could be charged for each click to connect to a web page related to the store.

It will be apparent to those skilled in the art that various modifications and variation can be made to the techniques described in the present disclosure. Thus, it is intended that the present disclosure covers the modifications and variations of the techniques, provided that they come within the scope of the appended claims and their equivalents.

1. A method of presenting content-relevant information associated with one or more frames in an AV program comprising:
enabling retrieving information on content associated with the one or more frames.

2. The method of claim 1, wherein:
the information comprises names of actors or actresses who appear in a scene of a movie, or the names of players for sports game while watching.

3. The method of claim 1, further comprising:
representing and localizing a specific frame/time point in a recorded AV program/stream or live TV, thereby allowing viewers browse the content-relevant information within the frame (or segment) as well as to buy items associated with the frame (or segment).

4. The method of claim 1, wherein:
the content-relevant information is delivered by a third-party service provider through a back channel.

5. The method of claim 1, wherein:
the content-relevant information is presented in the form of a GUI on a display device.

6. The method of claim 5, wherein:
an icon is displayed in the display device when the content-relevant information associated with current frames is available.

7. The method of claim 6, further comprising:
a frame-associated information server receives a time point of a current frame through a back channel.

8. The method of claim 7, further comprising:
the server sends the frame information linked to the current time point over the back channel.

9. A method of receiving content-relevant information associated with an AV program comprising:
receiving an AV program; and
receiving content-relevant information separate from the AV program.

10. The method of claim 9, wherein:
the content-relevant information is retrieved from a database in a server.
